(19) United States
(12) Patent Application Publication
(10) Pub. No.: US 2013/0038490 A1
(43) Pub. Date: Feb. 14, 2013

(54) Method and Apparatus for Acquiring Local Position and Overlaying Information

(71) Applicant: Juan Carlos Garcia, Philadelphia, PA (US)

(72) Inventor: Juan Carlos Garcia, Philadelphia, PA (US)

(73) Assignee: Human Network Labs, Inc., Philadelphia, PA (US)

(21) Appl. No.: 13/420,302

(22) Filed: Mar. 14, 2012

Related U.S. Application Data
(63) Continuation of application No. 13/194,155, filed on Jul. 29, 2011, now abandoned.
Application No. 13/194,155 is a continuation of application No. 12/962,989, filed on Dec. 8, 2010, now abandoned.
Application No. 12/962,989 is a continuation of application No. 12/080,662, filed on Apr. 3, 2008, now abandoned.
(60) Provisional application No. 60/909,726, filed on Apr. 3, 2007.
(60) Provisional application No. 61/020,840, filed on Jan. 14, 2008.

(51) Int. Cl. G01S 5/02

(52) U.S. Cl. 342/451

(57) ABSTRACT

A method and system for determining relative position information among at least a subset of a plurality of devices and objects is disclosed. The relative position information is based on at least one of sensor data and respective information attributes corresponding to the plurality of devices and objects.

### CROSS-REFERENCE TO RELATED APPLICATIONS

This application is a continuation of U.S. patent application Ser. No. 12/080,662, filed Apr. 3, 2008, which claims priority to U.S. Provisional Patent Application No. 60/909,726, filed Apr. 3, 2007 and entitled “Sphere of Influence System and Methods,” and claims priority to U.S. Provisional Patent Application No. 61/020,840, filed Jan. 14, 2008 and entitled “Hierarchical Visualization Architecture Method for People or Objects,” all of which are hereby incorporated by reference in their entirety.

### FIELD OF THE INVENTION

The present invention relates generally to the field of positioning systems and, in particular, to the field of determining the relative position of objects and acquiring the object attributes without the use of satellite communications, cellular networks, or other infrastructure.

### BACKGROUND

Current positioning systems may include features and tools for determining location using Global Positioning Satellites (GPS), cellular networks, or using static infrastructure for reading Radio Frequency Identification Data (RFID). The majority of today's positioning systems use GPS technology and a wide area network integrating backend map server services. GPS requires a minimum of three medium earth orbit satellites to provide approximate latitude and longitude of a remote transceiver device.

However, current positioning systems do not provide a system or method for determining the relative position of objects and acquiring the object attributes without the use of satellite communications, cellular networks, or other infrastructure. Current positioning systems do not provide for receiving at a first device a plurality of sensor data for at least a second device, calculating a relative position characteristic of the second device based upon the plurality of sensor data, receiving at the first device data from the second device, and associating the received data with the relative position characteristic of the second device.

### SUMMARY OF INVENTION

Accordingly, the present invention is directed to a system and method for determining the position of a device that substantially obviates one or more problems due to limitations and disadvantages of the related art.

In an embodiment, the present invention provides a method, the method including the steps of receiving at a first device a plurality of sensor data for at least a second device, calculating a relative position characteristic of the second device based upon the plurality of sensor data, where the relative position characteristic includes a range between the first device and the second device, a vector of motion and a tilt angle, and an orientation defined by a local earth magnetic field or a heading; receiving at the first device data from the second device, and associating the received data with the relative position characteristic of the second device.

In another embodiment, the present invention provides a positioning system, the system including: a plurality of sensors for determining location, including at least one of a range sensor, an orientation sensor, and a movement sensor, in a first device; a second plurality of sensors for determining location, including at least one of a range sensor, an orientation sensor, and a movement sensor, in a second device in direct two-way communication with the first device; a memory for storing data received from said first or second plurality of sensors for determining location; and a processor in which the data received from the first or second plurality of sensors for determining location is analyzed to localize one of the first device or the second device.

In yet another embodiment, the present invention provides a positioning system, the system including, in a first device: a processor, memory, and a plurality of sensors; the memory storing one or more instructions for execution, where the instructions include: receiving data from the plurality of sensors, storing the received data which includes location information of a second device, and analyzing the received data to localize the second device.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of the specification, illustrate embodiments of the invention and together with the description serve to explain the principles of the invention. In the drawings:

FIG. 1 illustrates an exemplary high level processing block diagram in accordance with the present invention;

FIG. 2 illustrates an exemplary block diagram of the object-managed local information in accordance with the present invention;

FIG. 3 illustrates an exemplary block diagram of the object-managed remote information in accordance with the present invention;

FIG. 4 illustrates an exemplary block diagram of the mobile device-managed remote information in accordance with the present invention;

FIG. 5 illustrates an exemplary block diagram of the object-managed local and remote information in accordance with the present invention;

FIG. 6 illustrates an exemplary block diagram of the object-managed local information and mobile device-managed remote information in accordance with the present invention;

FIG. 7 illustrates an exemplary block diagram of both the object-managed local/remote information and mobile device managed remote information in accordance with the present invention;

FIG. 8 illustrates an exemplary block diagram of device components determining relative position and orientation in accordance with the present invention;

FIG. 9 illustrates an exemplary block diagram of a positioning process in accordance with the present invention;

FIG. 10 illustrates an exemplary perspective view of a 5-node network with 2 blockages between pairs of nodes in accordance with the present invention;

FIG. 11 shows an exemplary synthesizing sensor error compensation method in accordance with the present invention;

FIG. 12 illustrates an exemplary block diagram of a process flow positioning a 2-node network in accordance with the present invention;

FIG. 13 illustrates an exemplary walking pattern shown by a motion sensor in accordance with the present invention;

FIG. 14 illustrates an exemplary circle intersection positioning representation for two moving objects in accordance with the present invention;

FIG. 15 illustrates an exemplary trigonometric representation of a transformed positioning problem in accordance with the present invention;

FIG. 16 illustrates exemplary walking vectors computed by new and old circular perimeter intersections of two moving objects in accordance with the present invention;

FIG. 17 illustrates an exemplary block diagram of a positioning process flow of a multi-node network in accordance with the present invention;

FIG. 18 illustrates an exemplary setup of a pseudo coordinate system from the ranges of 5 nodes in accordance with the present invention;

FIG. 19 illustrates an exemplary comparison of a moving vector between a pseudo and real coordinate system in accordance with the present invention;

FIG. 20 illustrates an exemplary comparison of moving directions and elimination of a wrong topology in accordance with the present invention;

FIG. 21 illustrates an exemplary overview for processing different sensor types in accordance with the present invention;

FIG. 22 illustrates an exemplary block diagram of a process flow to determine and display friend relationships in accordance with the present invention;

FIG. 23 illustrates an exemplary diagram of directional routing when navigating through two perpendicular hallways in accordance with the present invention;

FIG. 24 illustrates an exemplary track file data schema in accordance with the present invention;

FIG. 25 illustrates an exemplary 2D view on a user display of a device in accordance with the present invention;

FIG. 26 illustrates an exemplary 3D view on a user display of a device in accordance with the present invention;

FIG. 27 illustrates an exemplary view of common friend relationships on a user interface of a device in accordance with the present invention;

FIG. 28 illustrates an exemplary view of relationships and a range display within an area of interest (“AOI”) of a device in accordance with the present invention;

FIG. 29 illustrates an exemplary user display of a mobile device where the display shows relative positions of nearby objects in accordance with the present invention;

FIG. 30 illustrates an exemplary user display of a mobile device where the display shows a new orientation of relative positions of nearby objects post-rotation in accordance with the present invention;

FIG. 31 illustrates an exemplary user display of a mobile device where the display shows a personal information profile and privacy settings in accordance with the present invention;

FIG. 32 illustrates an exemplary user display of a mobile device where the display shows a tagged object information profile and privacy settings in accordance with the present invention;

FIG. 33 illustrates an exemplary block diagram of an implementation of a positioning engine (e.g., a “PixieEngine”) in accordance with the present invention;

FIG. 34 illustrates an exemplary block diagram of an implementation of a positioning engine designed to integrate with existing devices over a Bluetooth wireless connection in accordance with the present invention;

FIG. 35 illustrates an exemplary view of communications between a mobile device and a positioning engine (e.g., a “PixieEngine”) in accordance with the present invention;

FIG. 36 illustrates an exemplary view of physically attaching a stick-on positioning device to an existing mobile device in accordance with the present invention;

FIG. 37 illustrates an exemplary front and back view of a mounted stick-on positioning device in accordance with the present invention;

FIG. 38 illustrates an exemplary view of communications between two positioning engines (e.g., “PixieEngines”) attached to mobile devices in accordance with the present invention;

FIG. 39 illustrates an exemplary embodiment of an implementation of a local peer-to-peer mesh network and a wide area network in accordance with the present invention;

FIG. 40 illustrates an exemplary information static positioning engine (e.g., a “Spotcast”) in accordance with the present invention;

FIG. 41 illustrates an exemplary set of information from a static positioning engine (e.g., a “Spotcast”) shown on the user display of a mobile device in accordance with the present invention;

FIG. 42 illustrates an exemplary ultra-light static positioning engine (e.g., a “Spotcast”) being compared in size with a quarter U.S. dollar in accordance with the present invention;

FIG. 43 illustrates an exemplary directional static positioning engine (e.g., a “Spotcast”) in accordance with the present invention;

FIG. 44 illustrates an exemplary set of directional information from a static positioning engine (e.g., a “Spotcast”) shown on the user display of a mobile device in accordance with the present invention;

FIG. 45 illustrates an exemplary fence static positioning engine (e.g., a “Spotcast”) in accordance with the present invention;

FIG. 46 illustrates exemplary red and black sides of a positioning engine (e.g., “PixieEngine”) in accordance with the present invention;

FIG. 47 illustrates exemplary categories and functions of red and black sides of a positioning engine (e.g., “PixieEngine”) in accordance with the present invention;

FIG. 48 illustrates an exemplary user display of a mobile device implementing match-making and sale/trade relationships within an area of interest (“AOI”) in accordance with the present invention;

FIG. 49 illustrates an exemplary static positioning engine (e.g., a “Spotcast”) attached to a movie poster inside a movie theater and providing streaming service to a mobile handset in accordance with the present invention;

FIG. 50 shows an exemplary embodiment of a static positioning engine (e.g., a “Spotcast”) on a traditional retail kiosk appliance in accordance with the present invention;

FIG. 51 illustrates an exemplary embodiment of using a static positioning engine (e.g., a “Spotcast”) to perform interactive purchasing in accordance with the present invention;

FIG. 52 illustrates an exemplary embodiment of a person with a device enabled with a positioning engine (e.g., a “PixieEngine”) walking by an active display advertisement in accordance with the present invention;

FIG. 53 illustrates an exemplary embodiment of a vector of movement of a person with a device enabled with a positioning engine (e.g., a “PixieEngine”) who is turned towards a display advertisement in accordance with the present invention;

FIG. 54 illustrates an exemplary user display of a mobile device showing local resources that may be utilized within an area of interest (“AOI”) in accordance with the present invention;

FIG. 55 illustrates an exemplary user display of a mobile device interacting with a static positioning engine (e.g., a “Spotcast”) either using a local network or the network service of the device in accordance with the present invention;

FIG. 56 illustrates an exemplary embodiment of the object-managed local/remote information and mobile device-managed local/remote information in accordance with the present invention;

FIG. 57 illustrates an exemplary embodiment of a headset display of a user generated icon overlaying an existing display in accordance with the present invention;

FIG. 58 illustrates an exemplary embodiment of a user gesturing “Hello” in the air and viewing a visualization on-screen in accordance with the present invention;

FIG. 59 illustrates an exemplary embodiment of a user display of a device showing a “Hello” gesture in accordance with the present invention;

FIG. 60 illustrates an exemplary embodiment of a headset display with an attached “Hello” gesture in accordance with the present invention;

FIG. 61 illustrates an exemplary embodiment of a highlighted view of a gestured “Hello” overlaying an existing display in accordance with the present invention;

FIG. 62 illustrates an exemplary user display of a device with a date/time temporal calendar mode in accordance with the present invention;

FIG. 63 illustrates an exemplary user display of a device with a sphere of influence (“SOI”) temporal calendar mode in accordance with the present invention;

FIG. 64 illustrates an exemplary embodiment of uploading a temporal calendar from a device to a server for additional storage in accordance with the present invention;

FIG. 65 illustrates an exemplary embodiment of a delayed interaction through the temporal calendar in accordance with the present invention;

FIG. 66 illustrates an exemplary embodiment of hierarchical visualization as applied in a crowded area in accordance with the present invention;

FIG. 67 illustrates an exemplary embodiment of hierarchical levels of a specific privileges package in accordance with the present invention;

FIG. 68 illustrates an exemplary embodiment of a rating display with different icons chosen by users in accordance with the present invention;

FIG. 69 illustrates an exemplary embodiment of a visually impaired person navigating through an airport facility in accordance with the present invention;

FIG. 70 illustrates an exemplary embodiment of a user display of a device showing graphically the deviation in degree from the current position to the intended path while traversing in accordance with the present invention;

FIG. 71 illustrates an exemplary embodiment of a user display of a device showing graphically the objects and events within an area of interest (“AOI”) while traversing in accordance with the present invention;

FIG. 72 illustrates an exemplary embodiment of a user display of a device showing a tracked child with an overlaying trail to show her position and to present a fence perimeter in accordance with the present invention;

FIG. 73 illustrates an exemplary embodiment of a user display of a device showing a tracked pet within a predefined perimeter in accordance with the present invention;

FIG. 74 illustrates an exemplary embodiment of objects obscuring the view of an installed static positioning engine (e.g., a “Spotcast”) in accordance with the present invention;

FIG. 75 illustrates an exemplary embodiment of objects obscuring two installed static positioning engines (e.g., a “Spotcast”) in accordance with the present invention;

FIG. 76 illustrates an exemplary embodiment of a display of a configuration of static positioning engines (e.g., a “Spotcast”) in order to provide reliable coverage around a building in accordance with the present invention;

FIG. 77 illustrates an exemplary embodiment of tracking the proximity of an object from the defined fence lines in accordance with the present invention;

FIG. 78 illustrates an exemplary embodiment of a rectangular overlay encompassing safe area inside in accordance with the present invention;

FIG. 79 illustrates an exemplary embodiment of a circular overlay encompassing a safe area inside in accordance with the present invention;

FIG. 80 illustrates an exemplary embodiment of a rectangular overlay within a safe area outside in accordance with the present invention;

FIG. 81 illustrates an exemplary embodiment of a multi-zone environment with unsafe zones within a safe zone in accordance with the present invention;

FIG. 82 illustrates an exemplary embodiment of a pet collar integrated with a positioning engine (e.g., “PixieEngine”) and alarm in accordance with the present invention;

FIG. 83 illustrates an exemplary embodiment of communication between a fence static positioning engine (e.g., a “Spotcast”) and a positioning engine (e.g., “PixieEngine”) on a pet collar, as well as a process flow for event behavior activation in accordance with the present invention;

FIG. 84 illustrates an exemplary embodiment of a user walking a fence line to define containment with multiple segments in accordance with the present invention;

FIG. 85 illustrates an exemplary embodiment of three different application user interfaces of mobile devices in accordance with the present invention;

FIG. 86 illustrates an exemplary embodiment of four scenarios of a dog in a safe zone that triggers different alarms in accordance with the present invention;

FIG. 87 illustrates an exemplary embodiment of two scenarios of a dog in an outside unsafe zone that triggers different alarms in accordance with the present invention;

FIG. 88 illustrates an exemplary embodiment of two scenarios of a dog in an inside unsafe zone that triggers different alarms in accordance with the present invention;

FIG. 89 illustrates an exemplary embodiment of a static positioning engine (e.g., a “Spotcast”) connected to the Internet to send a message to an appropriate remote party in accordance with the present invention;

FIG. 90 illustrates an exemplary embodiment of the creation and editing of a fence overlay geometry with a device such as a computer in accordance with the present invention;

FIG. 91 illustrates an exemplary embodiment of a user interface of a device where the interface includes a scenario for activating an icon that leads to: a highlighted profile display, a personal note attached to a user icon, and a Starbucks advertisement announcement in accordance with the present invention;

FIG. 92 illustrates an exemplary embodiment of a user interface of a device where the interface includes a highlighted profile display in accordance with the present invention;

FIG. 93 illustrates an exemplary embodiment of a user interface of a device where the interface includes a directional indicator of a distant baggage claim and an area advertisement/announcement in accordance with the present invention;

FIG. 94 illustrates an exemplary embodiment of a user interface of a device where the interface includes a closer display of a directional indicator in accordance with the present invention;

FIG. 95 illustrates an exemplary block diagram of a process flow for positioning a 3D network in accordance with the present invention;

FIG. 96 illustrates an exemplary initial triangle formed by a moving 3D network in accordance with the present invention;

FIG. 97 illustrates an exemplary initial plane formed in a 3D network by continuous observation of movement in accordance with the present invention;

FIG. 98 illustrates an exemplary second plane formed in a 3D network compared with FIG. 97 in accordance with the present invention;

FIG. 99 illustrates an exemplary third plane formed in a 3D network compared with FIGS. 97-98 to determine a horizontal position in accordance with the present invention;

FIG. 100 illustrates an exemplary functional height of excluded zones 1 or 2 in accordance with the present invention; and

FIG. 101 illustrates an exemplary view of an indoor static positioning engine (e.g., a “Spotcast”) configuration for excluded zone 3 and its functional height in accordance with the present invention.

Like reference numerals refer to corresponding parts throughout the drawings.

### DETAILED DESCRIPTION

Reference will now be made in detail to embodiments, examples of which are illustrated in the accompanying drawings. In the following detailed description, numerous specific details are set forth in order to provide a thorough understanding of the embodiments. However, it will be apparent to one of ordinary skill in the art that the embodiments may be practiced without these specific details. In other instances, well-known methods, procedures, components, and circuits have not been described in detail so as not to unnecessarily obscure aspects of the embodiments.

In some embodiments, described is a positioning reference-based system for determining relative positions when a second device is proximate to a first device. This includes determining when a second device is proximate to a wireless boundary encompassing and defined relative to the location of a first device. Certain embodiments of the present invention are particularly directed to a high-accuracy, low-cost positioning reference-based system that employs a peer-to-peer wireless network, which may operate without the use of infrastructure, fixed nodes, fixed tower triangulation, GPS or any other positioning reference system.

Some embodiments may be used in a variety of applications for determining the locations of an object/device/node, animal, or person relative to a designated area/location, or relative to the location of another object or person. An exemplary application includes determining estimated geographical coordinates of an object/device/node based on known geographical coordinates of a remote unit, an object/device/node, or a location of interest. Another exemplary application includes providing navigational assistance to travelers or those unfamiliar with an area. Yet another exemplary application includes determining if a child or pet strays too far away from a certain location or from a guardian or a pet owner, respectively. Yet another exemplary application includes accessing information through object hyperlinking in the real world and location-based communications and social networking Object hyperlinking is discussed in further detail below.

Some embodiments do not require any existing infrastructure, wide area network or service provider and allow end users to discover the precise location of whom and what are around them. This location information may be utilized, for example, for asset tracking, security or socializing. Further, some embodiments can be integrated into an existing mobile device so that end users can overlay information over other devices. In such embodiments, the end user can visualize and interact with other people or objects within a physical Area of Interest (AOI), or with virtual presence via a wireless network. The AOI corresponds to objects in the vicinity and hence have a higher importance due to their proximity. Moreover, the device can create relationships with objects that are known to an embodiment of the device but are not physically near the device, objects belonging to this category are said to be within the Circle of Influence (COI). These two combined domains are referred to herein as the Sphere of Influence (SOI).

In some embodiments, the positioning system includes an embedded radio frequency (RF) signal and positioning algorithm into an integrated chipset or accessory card (e.g., beacons) in mobile devices, or a tag attached to objects such as, for example, a car, keys, a briefcase, equipment, or children. Through an observation of the environment via a personal wireless area network, position acquisition may be accomplished indoors or outdoors. Position acquisition may be used as to physically separate beacons relative to a position, and may not necessarily yield specific or actual geographic location information. Thus, in some embodiments, the system may be liberated from acquiring a geographic location and centralized network support. For example, some embodiments provide for acquiring position information indoors within approximately a 50 m range (i.e., about 165 feet) and outdoors within approximately a 200 m range (i.e., about 670 feet). Some embodiments may provide greater ranges.

In some embodiments, icons may be shown on-screen (e.g., on a user display/interface) on the device, representing the location of other devices that may be linked to information, personal profiles or web sites (i.e., object hyperlinking), without the aid of pre-incorporated Internet/intranet services. Beacons may become “hot links” similar to an HTML link, which does not “broadcast” data but may provide it on-demand through a request sent to a listener module on a server and the receipt of a response to the request. The beacons may supply data if a user “clicks” or engages the beacon on a user display of the device. The beacon may retrieve the data through its Internet/intranet connection, by accessing a database locally, or by communicating with other devices.

In some embodiments, all events and information occurring within the prevue of the device are recorded temporarily in a calendar that can be later retrieved, searched, and browsed in its original chronological order. This allows an end user to extend social interactions on a prolonged timeline and not just to occurrences at certain locations.

In some embodiments, none of the following may be required: Internet access, a mobile phone service provider or any fixed infrastructure such as a building/communication tower, Wi-Fi, or GPS. There may be no access points reporting a mobile user location to a backend to send information. Further, beacons do not need to be arranged in any known locations to acquire positioning information.

Some embodiments may be easier to implement and are subject to lower manufacturing costs and incurred end user costs. Exemplary applications of an embodiment may include: tagging items and/or buildings, exploring surroundings (e.g., who and what are in proximity), outputting/sending alarms based on an object's proximity (e.g., near or far), sharing information from device-to-device (e.g., personal profile information), prolonging interactions via a temporal calendar, and providing premium-based services that are available to cater to specific consumers' needs (e.g., information overlay, including text, symbols and graphics) in the physical environment, and presenting graphical hierarchies that bring status recognition.

Some embodiments provide the ability to acquire position information of an object within a local real world space and attach attributes or links of information to an acquired position. The positioning component, for some embodiments, may acquire the relative position of a local object via wireless signaling without the assistance of external reference sources in the local real world space. Some embodiments of the invention may overlay information attributes or link information to the object or a location relative to that object.

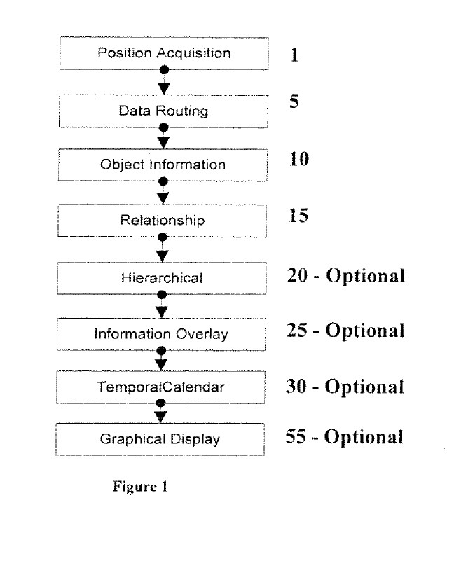

In some embodiments, the location of objects may be determined relative to each other without the assistance of external reference sources in the local real world space. Furthermore, some embodiments may display interactive information showing the location, relationships between objects, and links to other sources of information within a user device. The high-level process for some embodiments is illustrated in FIG. 1.

FIG. 1 illustrates an exemplary high level processing block diagram in accordance with the present invention. In FIG. 1, the process acquires local relative position (1) of other objects by detecting wireless signals indicating the presence of other RF beacons within its area of influence (AOI), further acquires positioning by integrating sensor data (e.g., range, vector of movement of each object, local object information, and device orientation). In some embodiments, local relative position acquisition is done by feeding sensor data (5) into one or more positioning and filtering algorithms, which may be initialized by the detection of other RF beacons. Each object may be assigned a relative coordinate within the AOI.

In some embodiments, a “track file” may be created and shared across objects to store and synchronize a list of the objects presented. A track file may include a list of information containing sensor data and computed relative locations of every node/device/object, which may be denoted with a timestamp. A track file may be shared among a local network. For example, in a 5 node scenario, the track file may include inter-node distances, orientation, moving displacement and the height of every node, as well as the computed relative locations of every node in a north-east coordinate system. Each of the 5 nodes may share the same track file. A track file may include information such as, for example, the object ID and object position as well as object angle, range, error, and error contour. Track files may be updated automatically when a new position is obtained or an information change is detected.

Each object may be assigned a unique identifier that may be used to reference object information attributes. Object information attributes may further link to other sources of data that may be embedded in the object or accessed via a remote gateway.

Although the current Internet provides the ability to link information to other Internet data objects, the current Internet does not extend beyond the virtual or electronic world and has no concept or ability to link information to physical objects. Some embodiments may provide object hyperlinking, which may allow real-world objects to be linked to information. Object hyperlinking as used herein may refer to the use of a device to send or receive data from a static position engine (e.g., a “Spotcast”), which may have a unique media access control (MAC) address and/or Internet protocol (IP) address; the static positioning engine may be connected to the Internet (WAN), a local area network (LAN), and one or more databases for storing/retrieving information. The terms device, object, and node may be used interchangeably herein depending on context.

Some embodiments of the present invention may allow a mobile device or other objects to determine the position of nearby objects and associated information to be linked together (10). Each object's hyperlink may assign or attach a reference link (often referred to as a uniform resource locator (URL)) into the object in the real world.

Object hyperlinking may link an object in the real world or physical space with information that may take the form text, data, web pages, applications, audio, video, or social information. Object hyperlinking may be implemented by numerous methods and combinations of methods to retrieve the referenced information.

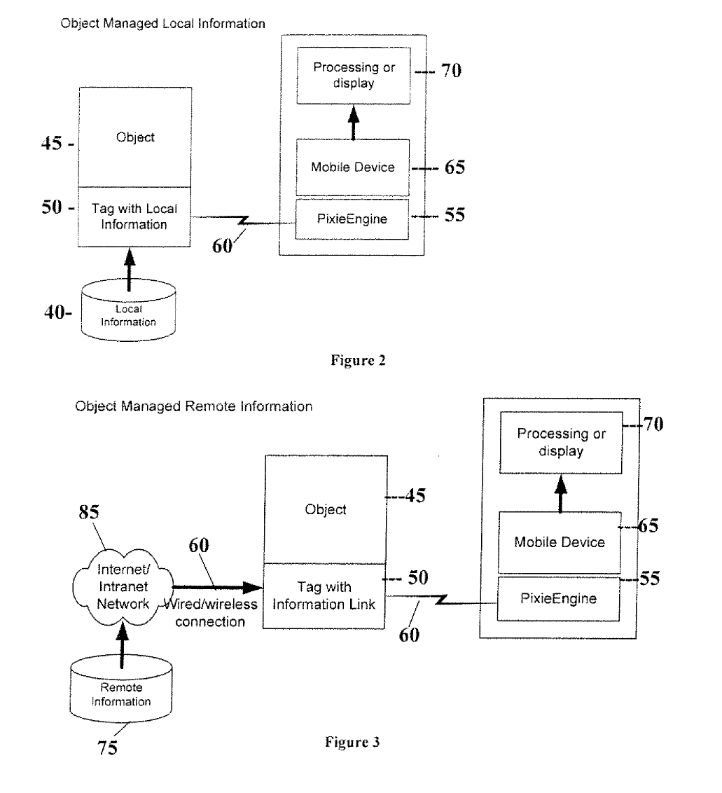

FIG. 2 illustrates an exemplary block diagram of the object-managed local information in accordance with the present invention. As FIG. 2 illustrates, an embodiment may implement object hyperlinking, where local information stored in local database 40 is associated with an object 45 via a tag 50. In some embodiments, local database 40 may be a storage medium such as, for example, read only memory (ROM), random access memory (RAM), magnetic storage medium, or an optical storage medium. The information associated with tag 50 may be communicated to a positioning system 55 through a communication link 60. A communication link 60 between a positioning system 55 and tag 50 may be established using any form of communication link including, for example, RF, optical, wired, or some other communication link. In some embodiments, the positioning system 55 may optionally be coupled with a mobile device 65. The positioning system 55 may be coupled with a mobile device through an RF link, an optical link, or a hardwire link. In some embodiments, positioning engine 55 may be coupled with a mobile device through a Bluetooth link. In addition, the mobile device may be coupled with a display 70.

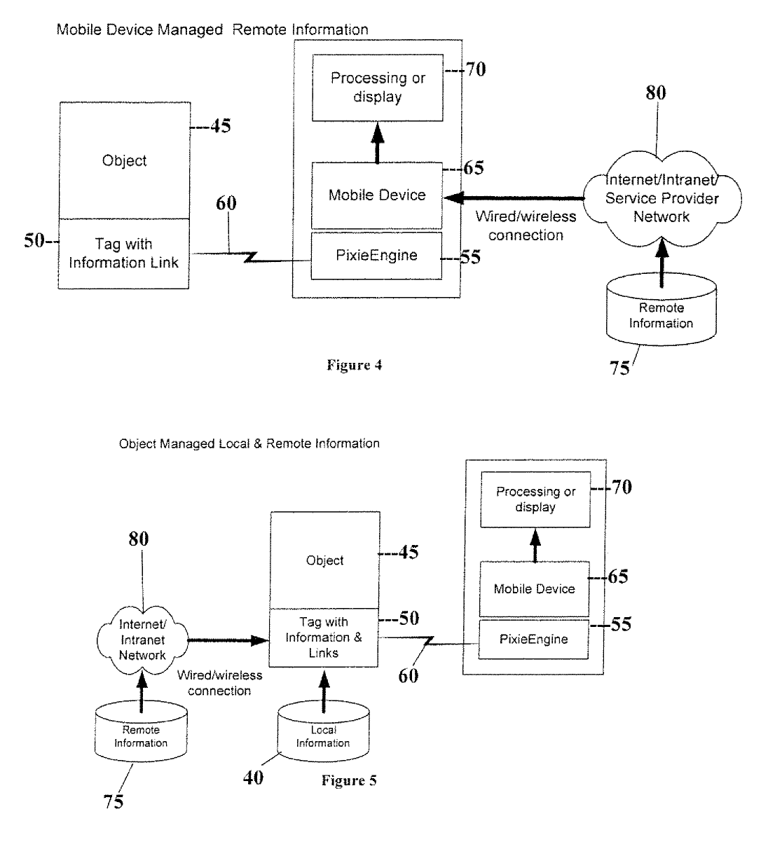

FIG. 3 illustrates an exemplary block diagram of the object-managed remote information in accordance with the present invention. As FIG. 3 illustrates, an embodiment may provide an alternative method to implement object hyperlinking where tag 50 communicates with a remote information database 75 via an intranet/Internet network 85. Remote information database 74 may be coupled with tag 50 through any communication link, as discussed above, to an Internet network, an intranet network, or other network. Moreover, the positioning system 55 may be coupled with a remote information database 75 as illustrated in FIG. 4. The positioning system 55 may be coupled with a remote information database 75 directly or through a mobile device 65, as illustrated in FIG. 4. Positioning system 55 may be coupled with a remote information database 75 through any communication link, as discussed above. In some embodiments, the remote information database 75 is coupled with tag 50 through a communication link through a network as discussed above. Moreover, tag 50 may be coupled with any number of information databases. FIG. 5 illustrates an embodiment where tag 50 is coupled with a remote database 75 and a local database 40, as discussed above. Furthermore, both positioning engine 55 and tag 50 may be coupled with any number of information databases.

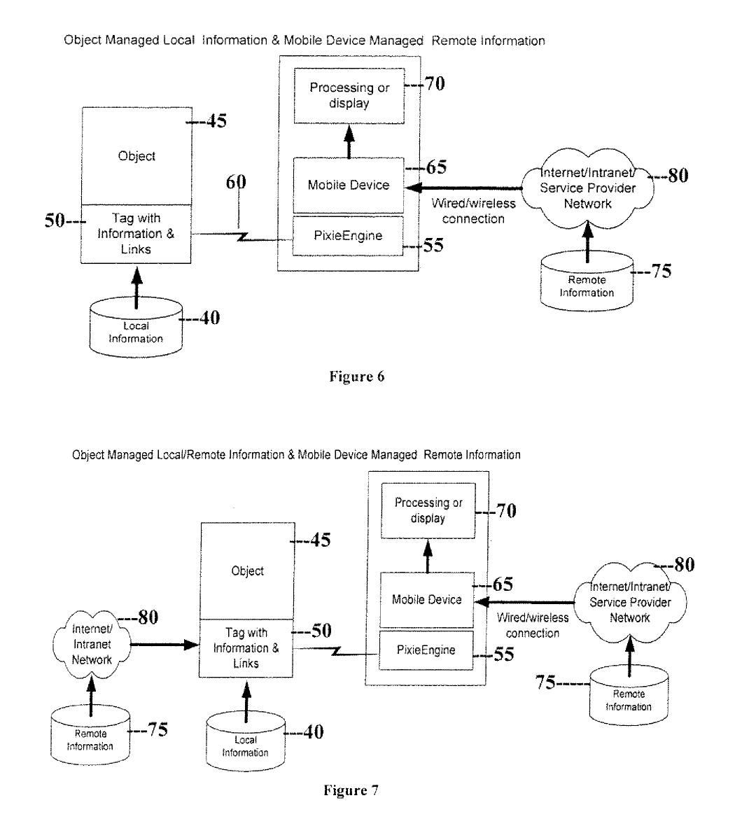

FIG. 6 illustrates an exemplary block diagram of the object-managed local information and mobile device-managed remote information in accordance with the present invention. FIG. 7 illustrates an exemplary block diagram of both the object-managed local/remote information and mobile device managed remote information in accordance with the present invention. FIGS. 6 and 7 illustrate alternative embodiments with configurations of how a positioning engine 55 and a tag 50 may be coupled with information databases, similar to those discussed above.

In some embodiments, each object contains object attributes and information that may be used in searching and matching objects meeting specified criteria. Searching and matching of object information and hyperlinks, provides a methodology to determine relationships between local and virtual objects (15). These relationships between objects “connect” the objects based on the matched information attribute. For example, if the objects represent people, then the relationship may be defined as social connections or matches of personal or social profiles. Further, if a suitable communication gateway is found, relationships may be created with objects that include those outside the AOI. Such relationships may be assigned hierarchical values such that objects may be filtered to display relationships of a certain hierarchy status (20).

By default, in some embodiments, the physical location of information contained within an object is spatially referenced to the physical location of the object generating the RF signaling. Information, however, may also be spatially placed at a location away from the actual location of the given object, thus, creating a relative location based on its own position. In other words, an object may be associated with information directly related to that object or associated with information related to another object at a different location. This allows information to be placed or overlaid at a location that is associated with that location or a location different from the physical object location. Additionally, a single object may be able to project multiple and different types of information at different spatial positions around its physical space.

In some embodiments, an object may have the ability to capture all object activities and relationships it obtains. The data may be date-time stamped into a time-line as a calendar (i.e., a “temporal calendar”), which may be used for later searching and retrieval (30). This capability allows for the reconstruction of physical events within a given time.

By utilizing a user device, all data may be further graphically represented on a display (35). A display may create interactive graphical representations of objects, object information, relationships and information overlay. The display may further allow for objects to be oriented according to the physical scene matching the real world object location, from referenced position of the device.

Determining Position of a Local Object:

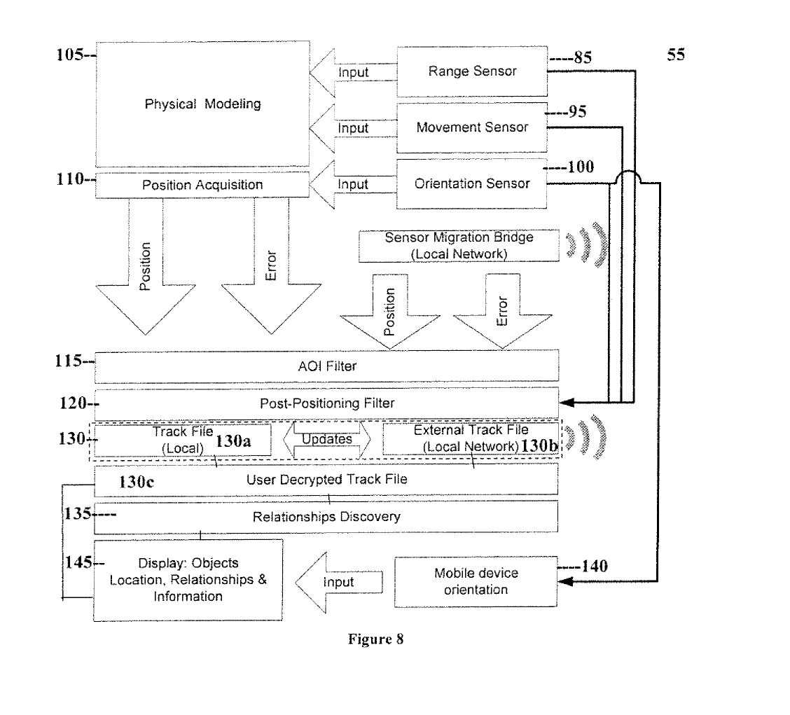

FIG. 8 illustrates an exemplary block diagram of device components determining relative position and orientation in accordance with the present invention. The device components utilized for some embodiments of the invention may provide accurate information of the relative location of an object and correctly orient the information on a mobile device.

In some embodiments, a positioning engine 55 acquires local object positions by utilizing one or more sources of input data. Sources of input data may include, for example, a range sensor 85 for determining the range between objects, a movement sensor 95 for determining a movement vector, and an orientation sensor 100 for determining a local orientation. The range sensor 85 may provide the range between itself and other objects. The movement sensor 95 may include an acceleration sensor that provides the ability to compute a vector of motion and the object tilt angle. The orientation sensor 100 may include a magnetic sensor that provides the local earth magnetic field or compass direction.

These sensors are coupled to a physical modeling component 105 and position acquisition component 110. The sensor data is fused together by a position acquisition component 110 based on the sensor input and input from the physical modeling component 105. The position acquisition component 110 returns the relative position and associated error of local objects to an AOI filter component 115 coupled therewith. Moreover, the AOI filter component 115 may be also coupled with a sensor migration bridge component 116, which provides position and error information to the AOI filter component 115 based on information external to a positioning engine 55. The AOI filter component 115 may be further coupled with a post-processing filter component 120.

The relative position may be filtered to smooth the dynamic qualities of the object by the AOI filter component 115 and post-positioning filter component 120. The position may be stored into a track file component 130 coupled with a relationship discovery component 135. The track file component 130 may compare the information received from the post-positioning filter module 115 to track files received from other objects in the vicinity, through the sensor migration bridge component 116. The output from the post-positioning filter component 120 may be used to create a final track file with the best available information. This information may be stored in the track file component 130.

In some embodiments, a track file component may include a local track file component 130a, an external track file component 130b, and a user decrypted track file component 130c. A local track file component 130a may store position information of the local mobile device. Alternatively, an external track file component may store position information related to other mobile devices or objects. In some embodiments, information stored in the local track file component 130a may be encrypted. Furthermore, in some embodiments, a local track file component 130a and an external track file component 130b are coupled and may pass position information between the components.

In some embodiments, to access encrypted information stored in the track file component 130, the track file object location encryption key may be compared to a user's decryption key. The objects that the key may decode may be moved to a user object list. The list may represent the objects that the user may be able to see, as well as the corresponding location.

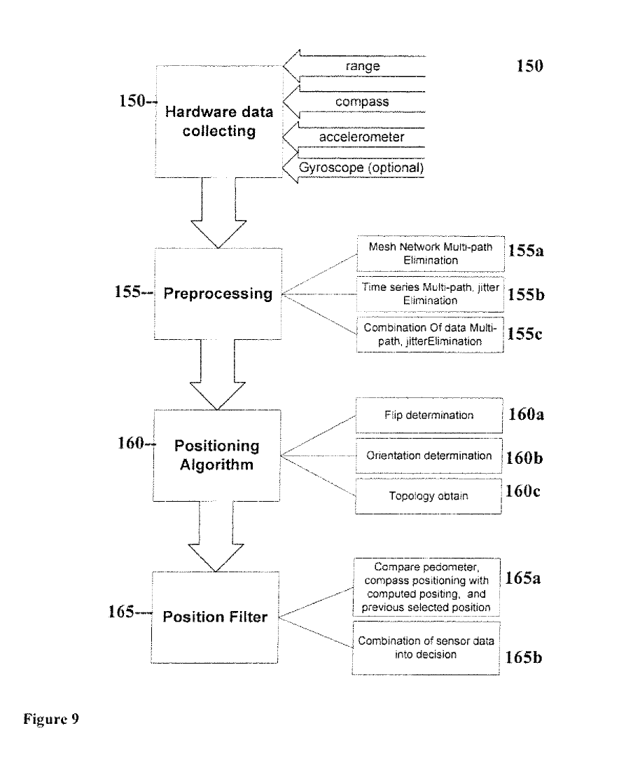

FIG. 9 illustrates a relationship discovery component 135 that may include a relationship filter, which may determine the relationship between the object and other objects in the user track file. The relationship discovery component 135 may be coupled with the track file component 130. The relationship discovery component 135 may use the information stored in the track file component 120 to compare and determine relationships.

The object location, relationship and information may be visualized on user devices with a graphical display. Display component 145 is coupled with track file component 130, relationship discovery component 135, and orientation sensor 100. For some embodiments, the orientation sensor includes a magnetic sensor that provides information to display component 145. This information can be used to rotate the display to match the user device orientation to its physical world view. Furthermore, the information received from track file component 130 and relationship discovery component 135 is used by display component display information related relative position of objects, relationships between those objects, and other related information.

Acquiring a Position:

Positioning operations of the positioning acquisition component 110 are illustrated in FIG. 9. At step 150, sensor data may be collected via hardware data collection from each available sensor. In some embodiments, the sensor data may be collected from one or more sensors including, for example, a range sensor, an accelerometer, a gyroscope, and a magnetic sensor. Step 150 may include determining walking vectors of each node and ranges between each pair. At step 155, the raw data may be preprocessed to achieve a higher precision. Step 155 may include one or more of a mesh network multi-path elimination (150a), a time series multi-path, jitter elimination (155b), or a combination of data multi-path and jitter elimination (155c). After completing step 155, the output of preprocessing may be then, at step 160, sent to a positioning algorithm for acquiring a relative position. At step 160, the positioning algorithm may perform one or more of a flip determination (160a) (that is, to determine a new direction of a node based on any change in original direction), an orientation determination (160b), and a topology determination (160c). At step 165, the acquired relative positions may be then filtered (165) via a mathematical method to achieve a final coherent and consistent position solution. The position filter step (165) may include comparing pedometer and compass positioning with a computed position and a previously selected position (165a). Moreover, at step 165, the combination of sensor data may be further used to determine position information (165b). The implementation of the algorithm for acquiring a position may apply to 3D network configurations (that is, where height may also be considered in determining position), which may receive data from the implementation of the algorithm for acquiring position in a 2D network configuration (discussed explicitly below).

Preprocessing

In some embodiments preprocessing operations including one or more of the following: a network optimization method to eliminate multi-path range data; time series multi-path, jitter elimination, which acquires a series of sensor data and eliminates obvious jitters within this time range; and a combination of the foregoing.

Network Optimization

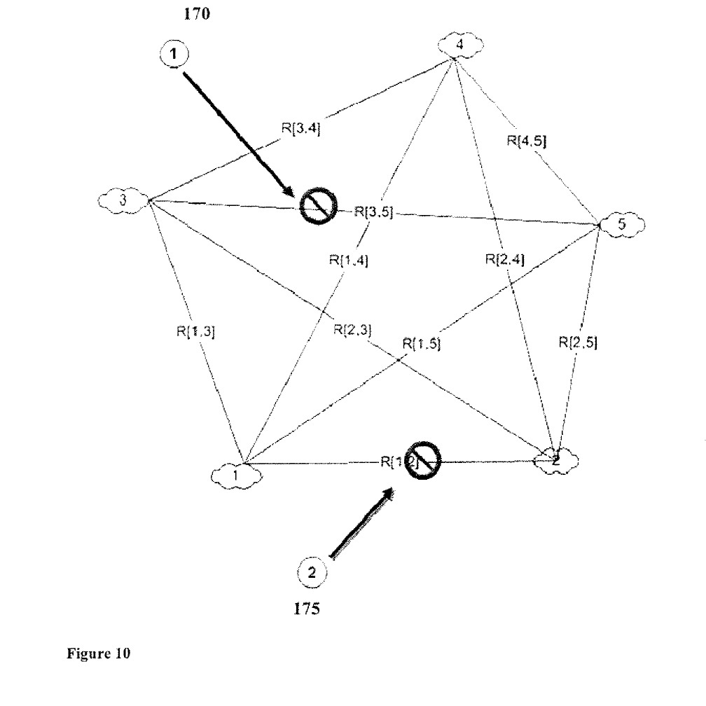

FIG. 10 illustrates an exemplary perspective view of a 5-node network with 2 blockages between pairs of nodes in accordance with the present invention. FIG. 10 illustrates a 5-node network of which 2 of the objects' range data has been corrupted by multi-path due to blockages 170 and 175 between a corresponding two nodes. A node may be a beacon, object, tag 50, or positioning engine 55 that is transmitting a reference signal. Using mathematical analyses of the network, a single solution of the correct topology may be achieved depending on corruption level, data consistency, and configuration shape. This method may be called Network Optimization.

Time series multi-path, jitter elimination:

TABLE 1
Range Jitter Elimination Based on Time Series Data

| | Range12 | Range13 | Range23 |
|---|---|---|---|
| Time | (m) | (m) | (m) |
| 1 | 10.4 | 16.9 | 12 |
| 2 | 10.4 | 16.9 | 12 |
| 3 | 10.1 | 16.9 | 12.1 |
| 4 | 10.3 | 16.9 | 12.1 |
| 5 | 10.9 | 16.9 | 12.1 |
| 6 | 10.7 | 16.4 | 12 |
| 7 | 10.3 | 16.3 | 12.1 |
| 8 | 7.2 | 16.4 | 12.1 |

Table 1 illustrates a series of range data recorded by an embodiment of a positioning system. Data that is obviously inconsistent with previous recordings are subject to be removed.

Combination of data multi-path, jitter elimination:

TABLE 2
Combination Range and Compass Data to Eliminate Jitter

| | Range12 | Compass1 |
|---|---|---|
| Time | (m) | (degrees) |
| 1 | 7.5 | 54 |
| 2 | 7.8 | 54 |
| 3 | 7.6 | 55 |
| 4 | 8.1 | 55 |
| 5 | 8.3 | 54 |
| 6 | 9 | 55 |
| 7 | 8.5 | 55 |
| 8 | 8.1 | 55 |
| 9 | 7.5 | 55 |
| 10 | 7.4 | 54 |
| 11 | 7.3 | 27 |
| 12 | 7.3 | 26 |
| 13 | 7.2 | 54 |

Table 2 shows a recording of both range and compass data in two different columns, where the consistency of each column serves to imply the other and helps to eliminate jitters that are not as obvious as in Time Series Data.

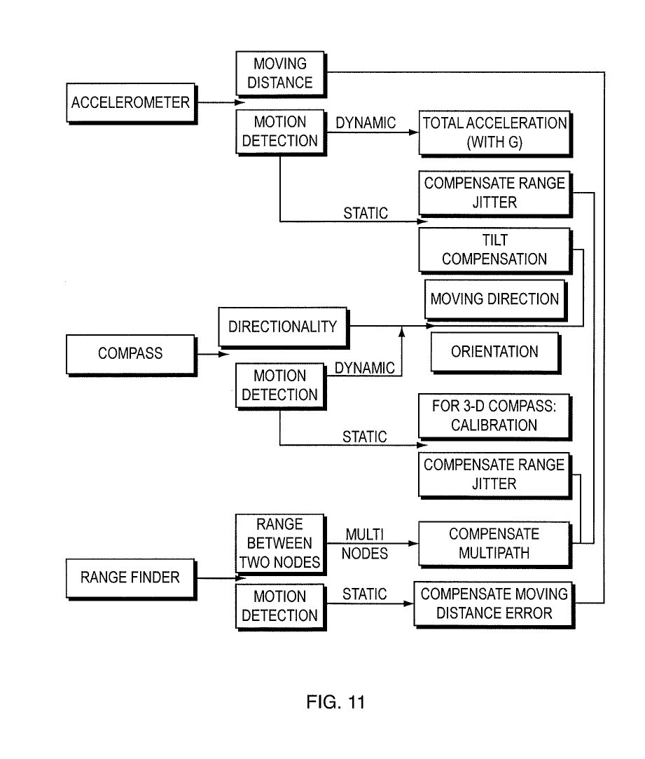

In general, as shown in FIG. 11, a motion sensor may be used to compensate tilt for precise magnetic orientation acquisition, as well as eliminate range jitter either through raw motion data or computed walking distances. Similarly, a compass sensor may also be used for the same operations. Consistent range data may also be reversibly applied to compensate for direction or walking distances calculations, which may lower the probability of data corruption as a whole.

2D Positioning Algorithm

To exemplary scenarios will be discussed to illustrate 2D network configurations (although the algorithm may also apply to a 3 nodes scenario). The first exemplary scenario is when there are only two nodes present in the network, whereas the second exemplary scenario is when there are multiple nodes (preferably no less than 4) available.

The Two Nodes Scenario

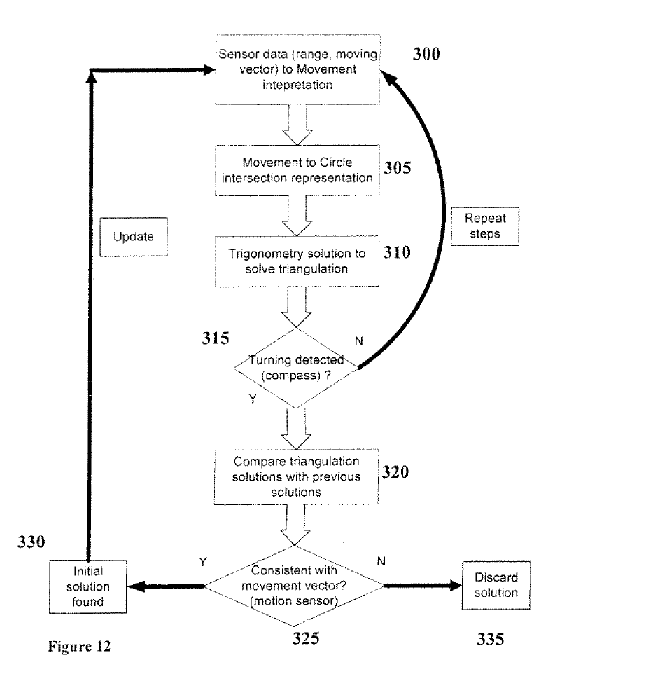

FIG. 12 illustrates an exemplary block diagram of a process flow positioning a 2-node network in accordance with the present invention.

Sensor Data to Movement Interpretation (300)

In general, the larger the network, the more information that may be available per node. Thus, a two nodes scenario possesses the least amount of data per node and insufficient range data may be compensated for. A movement interpretation may be defined as a moving distance and a heading of each object as it pertains to the network. In some embodiments, a magnetometer may be used to obtain such data. Several algorithms, discussed below, may provide moving distances of the device's user within a time range.

Acceleration and the Double Integration Method

Under circumstances when acceleration is large enough to distinguish from sensory noise background (e.g., travel in an automobile), an acceleration and double integration method is used to compute traveling distances. In some embodiments, an acceleration and double integration method (e.g., integration with respect to time) is applied in inertial navigation systems using data from, preferably, two or more orthogonal accelerometers. Single integration of the obtained data may calculate velocity from acceleration as the user moves, whereas double integration may calculate the position. The results of the integration may then be added to the starting position so as to obtain current location. The position errors increase with the square of time due to the double integration.

The Step Count (Pedometer) Method

This method may be invoked for runners, foot traveler or pedestrian use of the present invention, where acceleration measurement may be vulnerable to sensory noise and a “step” pattern may be explicit. FIG. 13 illustrates an exemplary walking pattern shown by a motion sensor in accordance with the present invention. The pattern is based on acceleration sensor data according to an embodiment. A step count method may count the number of physical steps interpreted from a pattern such as, for example, that of FIG. 13. Such a method is commonly regarded as a pedometer. The pattern of an acceleration signal may have a profile that repeats at each step. In some embodiments, the acceleration profile includes, in succession, a positive phase where a positive-acceleration peak occurs due to contact and the consequent impact of the foot with the ground, and a negative phase where negative acceleration peak occurs due to a rebound; the negative acceleration peak may have an absolute value smaller than that of the positive acceleration peak. The detection of a step may be based upon the comparison of the value of the acceleration signal with a reference threshold having a pre-set value for the detection of acceleration peaks. Step counting may then be conducted and a measurement of the total distance traveled may be updated by multiplying an estimated human step length.

Movement to Circle Intersection Representation (305)

FIG. 14 illustrates an exemplary circle intersection positioning representation for two moving objects in accordance with the present invention. In FIG. 14, Origin-1 400 is where a first object 401 rests initially. The bottom circle 410 represents the possible locations of a second object 415 determined by range, before an initial position is computed. When the second object 415 moves, its new position may be represented by a new circle 410a because the direction, which may be obtained from a compass, and the distance, which may be obtained from a pedometer, may be represented as a moving vector 420. On the positioning representation we may simply move the first circle 415 according to the same distance and the same direction as that of the second object 415.

Further, the first object 401 may also move to another position that may be represented by certain coordinates, which may be also obtained by a traveling vector. After the first object moves, the range between the two objects, which is shown as the largest circle 425. The intersections of the two circles 430 after moving should be the possible solutions of the relative position of the second object 415.

a Trigonometric Solution to Solving Triangulation (Circle Intersection) (310)

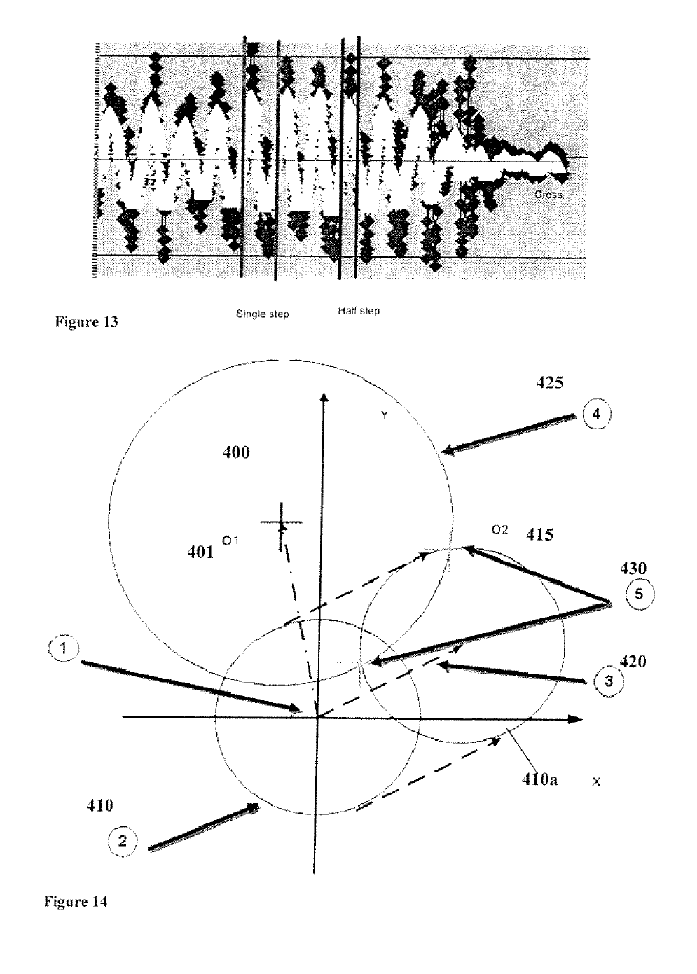

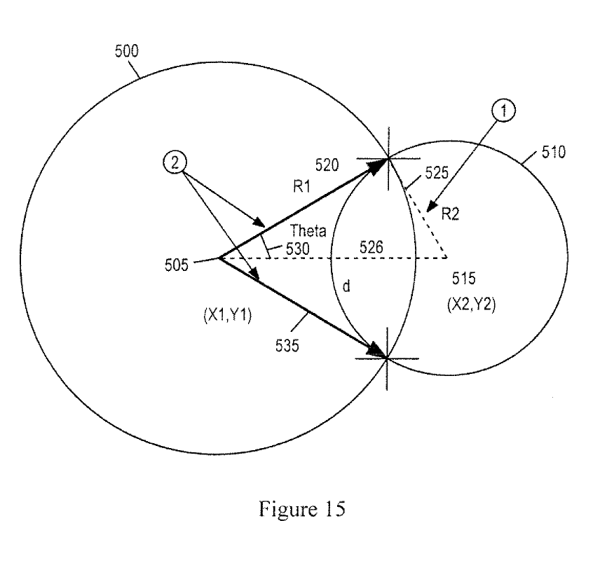

FIG. 15 illustrates an exemplary trigonometric representation of a transformed positioning problem in accordance with the present invention. Positioning may pose a problem with obtaining the intersection of a first circle 500 and a second circle 510. The first circle 500 may be defined by a first center 505 and a first radius 520. Similarly the second circle 510 may be defined by a second center 515 and a second radius 525. Trigonometry may be used to determine the intersection of the two circles 500, 510 by solving for the distance (d) between the first center 505 and the second center 515. Moreover, trigonometry may be used to solve for the angle theta 530 in the triangle 526. Solving for the angle theta may give the positioning system sufficient data to define two vectors 520 and 535. Using vector addition, two possible sets of coordinates can be obtained, for example, as follows.

Theta=aos((R1̂2+R2̂2−d̂2)/(2*R1*R2))

### Coordinate Set 1:

X=X1+R1*cos(theta)

Y=Y1+R1*sin(theta)

Coordinate Set 2:

X=X1+R1*cos(−theta)

Y=Y1+R1*sin(−theta)

The above mathematics technique illustrates the use of triangulation, which may be used for determining position.

Turn Detection (315)

A turn may be defined as a change in the heading of movement, visualized by a non-noise level change during continuous observation of magnetometer data. In the case where the detection occurs, which indicates the occurrence of a turn, a determination of position is conducted as described in the next section; otherwise, the algorithm for turn detection returns to the initial condition of looking for a new circle intersection.

Comparing Triangulation Solutions with Previous Solutions (320)

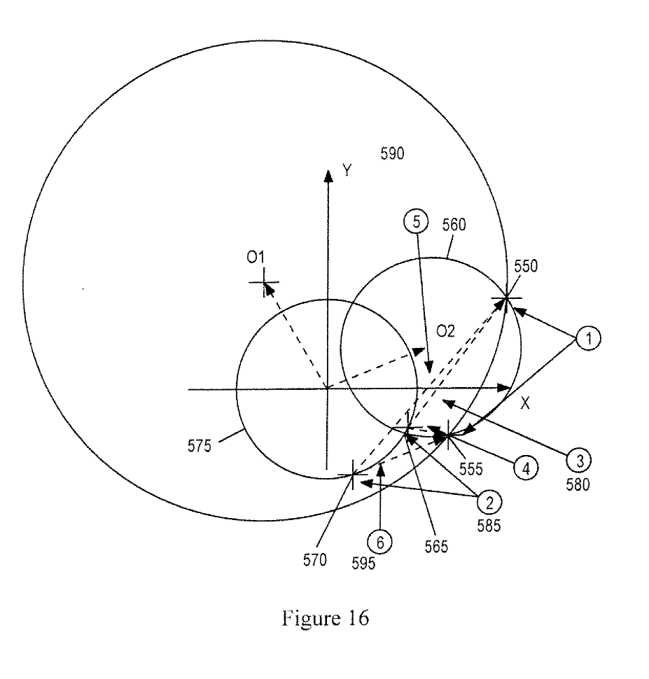

FIG. 16 illustrates exemplary walking vectors computed by new and old circular perimeter intersections of two moving objects in accordance with the present invention. When a turn is detected, a comparison may be done on new intersection solutions with prior ones. A consistent moving vector with sensor data may be chosen. The new circle intersection may be marked by a first cross 550 and a second cross 555 on the top circle 560 and compared with a prior triangulated relative position indicated by a third cross 565 and a fourth cross 570, on the bottom circle 575. The following moving vectors can be deduced:

### Previous Triangulated Coordinates:

(Xprev 1, Yprev 1)
(Xprev 2, Yprev 2)

### New Triangulated Coordinates:

(Xnew 1, Ynew 1)
(Xnew 2, Ynew 2)

### Deduced Moving Vectors:

Vector1, shown as 580: (Xprev 1−Xnew 1, Yprev 1−Ynew 1)
Vector2, shown as 585: (Xprev 1−Xnew 2, Yprev 1−Ynew 2)
Vector3, shown as 590: (Xprev 2−Xnew 1, Yprev 2−Ynew 1)
Vector4, shown as 595: (Xprev 2−Xnew 2, Yprev 2−Ynew 2)

After comparing the above vectors with the moving vectors obtained in the initial step, the vector chose is the one that is consistent with the moving vector, i.e., Vector4 595. Thus, the positioning system determines the current relative position as (Xnew 2, Ynew 2). For some embodiments, the foregoing operations may be repeated at regular intervals to obtain a higher precision in an intersection solution. In some embodiments, the operations may be repeated 1 to 60 times per minute. In other embodiments, the operations may be repeated more often.

Determining Position in a Multiple Nodes Scenario (e.g., 5-Nodes)

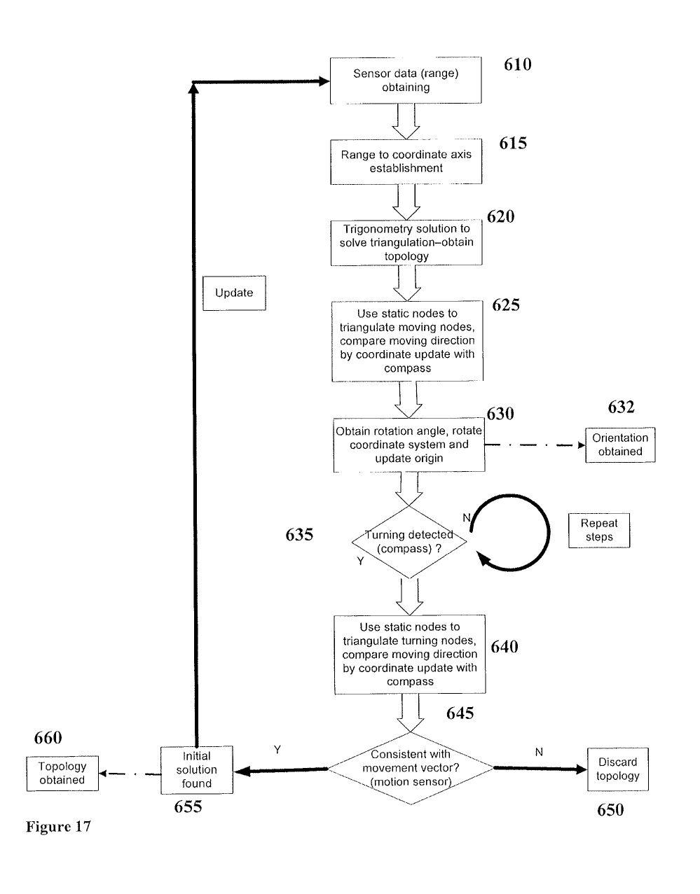

FIG. 17 illustrates an exemplary block diagram of a positioning process flow of a multi-node network in accordance with some embodiments of the present invention. Each of the process flow steps are described below.

1. Obtaining Range Sensor Data (Step 610)

Unlike the two nodes scenario, multiple node networks normally enjoy relatively sufficient range data to secure acquisition of topology. However, occurrences of error may be considerable when multi-path issues are present and insufficient range data are available. In such a scenario, where no useful output is produced, some embodiments of the positioning system automatically switch to a two-node operation to configure each other node, as described above.

2. Range to Pseudo-Coordinate Axis Establishment (Step 615)

FIG. 18 illustrates an exemplary setup of a pseudo coordinate system from the ranges of 5 nodes in accordance with the present invention. For embodiments using a range to pseudo coordinate axis establishment technique, the 5 nodes are ordered, starting with an observer as node 1 (origin). Other nodes are randomly assigned a number if the range between node 1 and that node is greater than some distance from node 1. In some embodiments, the range between node 1 and that node may be, for example, greater than 3m. Persons next to node 1 are not preferred anchor points. The nodes may be assigned a pseudo set of coordinates. In some embodiments, the nodes may be assigned a pseudo set of coordinates on an x, y axis. Pseudo coordinates, as referred to here, are defined as a temporal coordinate system enabling computation before the real coordinate can be found.

3. A Trigonometric Solution to Solving Triangulation by Obtaining Topology (Step 620)

In some embodiments, circle-to-circle intersection may be used to determine the location of a node according to a trigonometric solution to solving triangulation by obtaining topology. In some embodiments, after configuring a coordinate system, a node (or device/object) with a positioning engine may be chosen randomly, where the node may satisfy a range between a first node, a second node, and a third node, both greater than a certain distance. In some embodiments, the distance may be, for example, 3m. Circle intersections based on the range radius of the first node and the second node may be obtained (as discussed above) for determining two possible pseudo coordinates for the third node. Then, a random selection of one of the possible pseudo coordinates may be made, knowing that at least one of the two possible psuedo coordinates may correspond to the coordinates of the third node.

In some embodiments, two intersecting circles (e.g., with radii corresponding to a range away from node 4) may be formed by node 1 and node 4, and node 2 and node 4, where node 3 may be used as a “tier broker” (i.e., a “tier broker” is a node that may be used to choose between two possible coordinates of another node by, for example, obtaining the distance from the “tier broker” to the other node). One of the two possible pseudo coordinates, corresponding to the coordinates of the two intersecting circles, may be chosen at random for node 4; one of the pseudo coordinates may be chosen such that it has a closer distance to node 3, based on sensor data. These steps may be repeated with alternative circle intersections to attempt to obtain the coordinates of node 4. In some embodiments, an average of these coordinates may be returned as a final coordinate of node 4.

In some embodiments, for a fifth node, the previous steps may be repeated to attempt to complete a possible topology construction. Further, in some embodiments, a symmetric topology may be constructed by flipping the completed topology over the px axis, as illustrated in FIG. 18.

4. Compare Moving Direction by Coordinate Update with Compass (Step 625)

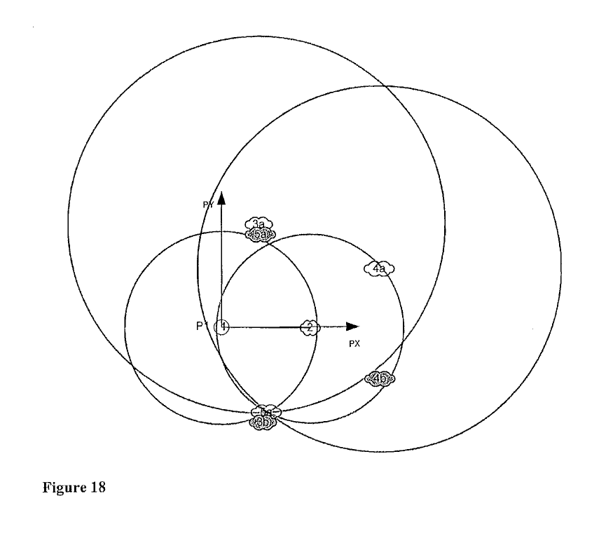

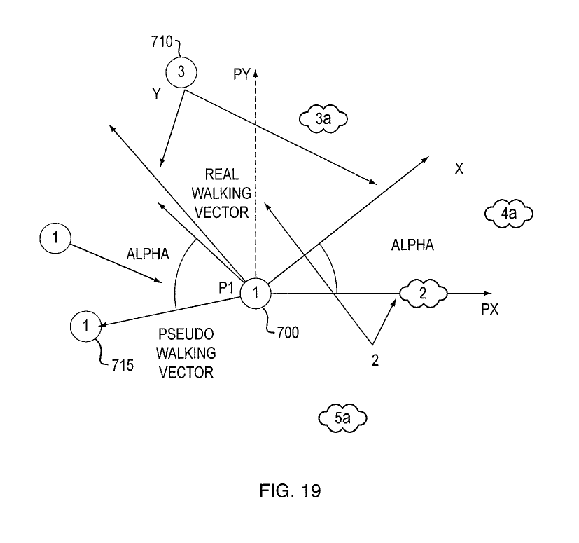

FIG. 19 illustrates an exemplary comparison of a moving vector between a pseudo and real coordinate system in accordance with the present invention. In FIG. 19, with topology “a”, after node 1 moves from a first position 700 to a second position 715, new coordinates may be obtained for node 1 by the intersection of other static nodes in a pseudo coordinate system a: new triangulated coordinates (X1,Y1), deducing the moving heading, angle 1, of node 1 in such a coordinate system may be calculated by:

angle 1=a tan 2(Y1,X1).

After calculating for angle 1, a comparison with a real walking direction may be provided by a compass heading, angle 2, then a rotation angle may be obtained of a pseudo coordinate system, alpha:

alpha=angle 2−angle 1.

5. Rotate Coordinate System: Obtaining Orientation (Step 630)

The entire coordinate system may be rotated by alpha to match the real orientation with “north,” hence we obtain the real coordinate system 710.

For all coordinates, rotating by an angle alpha may cause an object with a polar representation such as a range=R and azimuth=theta, to have a new polar representation of a range=R and azimuth=theta−alpha.

The origin may be updated to be at current position of node 1 (715) by subtracting its triangulated coordinates from the entire topology: for each object present with a Cartesian representation (X, Y), an updated representation may be calculated as (X−X1, Y−Y1).

6. Turn Detection (Step 635)

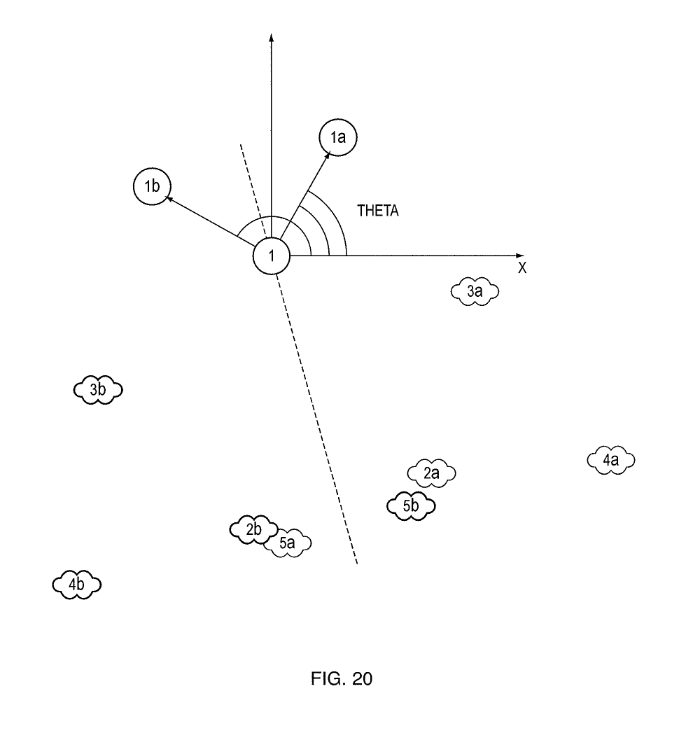

FIG. 20 illustrates an exemplary comparison of moving directions and the elimination of a wrong topology in accordance with the present invention. FIG. 20 lists the two possible topologies in the obtained real coordinate system (notice that all coordinates have not yet been determined because of flipping ambiguity, i.e., determining orientation). The turning of a moving object may be necessary to mitigate said flipping ambiguity by creating discrepant, deduced moving headings. In some embodiments, detection of turning should come from both visualization of a magnetometer heading change and a triangulation coordinate-deduced heading change, to raise the level of detection accuracy.

A new triangulated coordinate for node 1 is (X1new, Y1new), and the deduced heading of node 1 is:

Heading (new)=a tan 2(Y1new,X1new);

as compared with the previously recorded heading of:

Heading (previous)=a tan 2(Y1prev,X1prev);

Hence:

Heading (change)=Heading (new)−Heading (previous).

If the Heading (change) exceeds a preset threshold, the second condition in said turning detection is satisfied. Where the detection occurs, which indicates the occurrence of a turn, a determination of topology may be conducted (e.g., as described in the next section), otherwise the algorithm may repeat until such detection is achieved.

7. Obtaining Topology: Comparing the Triangulation Deduced Moving Heading with a Magnetometer Heading (Step 640)

If a turn of node 1 is detected, the heading of node 1 may be calculated as Heading (new)=a tan 2 (Y1new, X1new). This may be deduced by triangulation in topology “a” only.

By applying reflection symmetry using topology “b,” the new coordinates of node 1 will be:

(X1new b=cos(2*beta)*X1new+sin(2*beta)*Y1new,Y1new b=sin(2*beta)*X1new−cos(2*beta)*Y1new).

Beta may be an angle between the new coordinates of node 1 in topology “a” and an x-axis, as shown in FIG. 20.

The azimuth of two possible coordinates of node 1 may be compared, and the coordinate that is closer to a compass heading (e.g., theta) may be chosen, providing the corresponding topology.

Finally, the original may be updated and triangulation may be repeated with the obtained topology, for updating.

3-Dimensional Position Augmentation

3-Dimensional (3D) position augmentation is designed for applications that require an estimation of height, as may be needed when requiring information overlay placement at a height of 1 meter above the ground. This additional dimension acquisition provides a height dimension and may be used to display and to orient objects accordingly. The process leverages an existing 2D positioning algorithm and adds height when available to nodes, additional height information or larger collections of sensor data.

In the following discussion, two methods are discussed which reconstruct the 3D mesh network with the absence of any access points, where each method operates under certain constraints and may be feasible for designated applications.

The Method of Pre-programmed Height

In some embodiments, the method of pre-programmed height combines a mechanism of both access point localization and 2D positioning. Static positioning engines, tags, beacons, or other objects emitting a position signal (collectively referred to herein as a “Spotcast” or “Spotcasts”) and deployed at certain height may acquire such information through either automatic computation or manual input of height as a positional characteristic of the Spotcast. Through communication and information relay, the entire network shares the knowledge of the different height that each Spotcast possesses. From this information a positioning engine, such as a Spotcast, may determine an associated horizontal plane where it resides.

With said preprogrammed height characteristics as a known factor of the network, computing the rest of the topology may be performed using the combination of 2D and 3D geometry. The complete network configuration may be acquired and updated thereafter, utilizing the known 3D geometry. The method demonstrates the viability for use with applications rich with static positioning engines such as Spotcasts. Compared with the access point approach, this method may save intensive computation and analysis in having to acquire the precise locations of anchor points, liberates users from a rigid infrastructure base, and operates without the need of having assigned anchor points.

The location accuracy of an additional dimension may be relatively lower as compared with an access point localization method. Nevertheless, for many day-to-day applications where a lower level of accuracy of 1 meter in height is sufficient in operation, the method is an appropriate approach to function.

Movement-Based 3D Geometrical Positioning

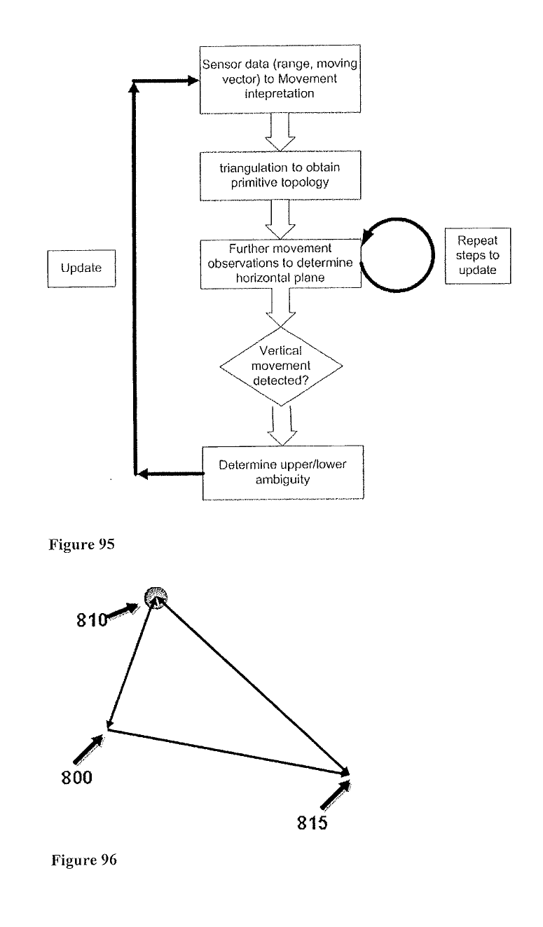

Another form of 3D network reconstruction is through a larger collection of information to gain simulated anchor points to perform positioning. FIG. 95 illustrates an exemplary block diagram of a process flow for positioning a 3D network in accordance with the present invention. The exemplary process includes using sensor data to perform movement interpretation, using triangulation to obtain a primitive topology, and analyzing further movement observations to determine a horizontal plane. The analysis of further movement may be repeated for an update, as illustrated in FIG. 95. The exemplary embodiment also includes detecting vertical movement and determining upper/lower ambiguity. After this step, the process returns to using sensor data for interpreting movement. Rather than relying on an end user to build dimensional characteristic, the position-related signatures can be obtained by observing the dynamic characteristics of the network under movement for some period of time. FIGS. 96-99 illustrate the detailed process of this approach, which composes a 2D geometrical plane of which 3D positioning is used for reconstruction.

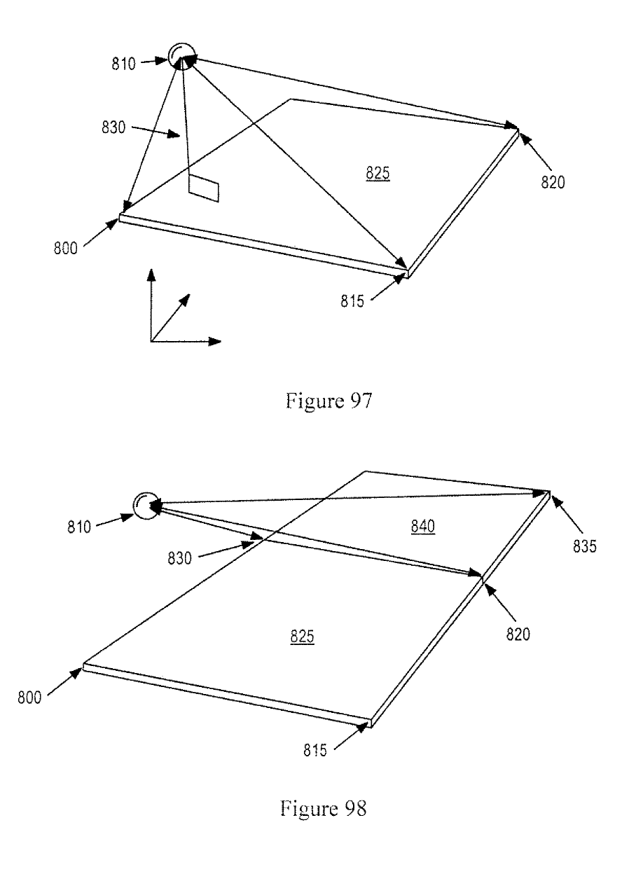

FIG. 96 illustrates an exemplary initial triangle formed by a moving 3D network in accordance with the present invention. In some embodiments, two nodes 1(800) and 4 (810) are present, of which node 4 (810) possesses a higher position than node 1(800). After node 1(800) moves to new location 2 (815), a triangle can be formed by: moving distance of node 1(800), ranges between node 1(800) and node 4 (810) through measurements before and after moving. As 2 (815) continues moving to 3 (820), a plane is constructed by the series of measurement, shown as gray plane 825 in FIG. 97. Providing said plane is horizontal, the height of node 4 (810) would be derived as a perpendicular distance to said horizontal plane of reference shown by 5 (830).

However, due to ignorance of the vertical movement of node 1(810), determining the horizontal plane may be subject to further confirmation. FIG. 98 illustrates the continuous route of node 1(810) from spot 3 (820), to 5 (830), and then to 6 (835), when a new plane (840) is constructed to compare. The ambiguity of the horizontal at this stage still exists if height discrepancy is observed in returned two planes. Specifically, if two planes are not both horizontal, then their independently referenced height of node 4 (810) may be of distinguishable differences.

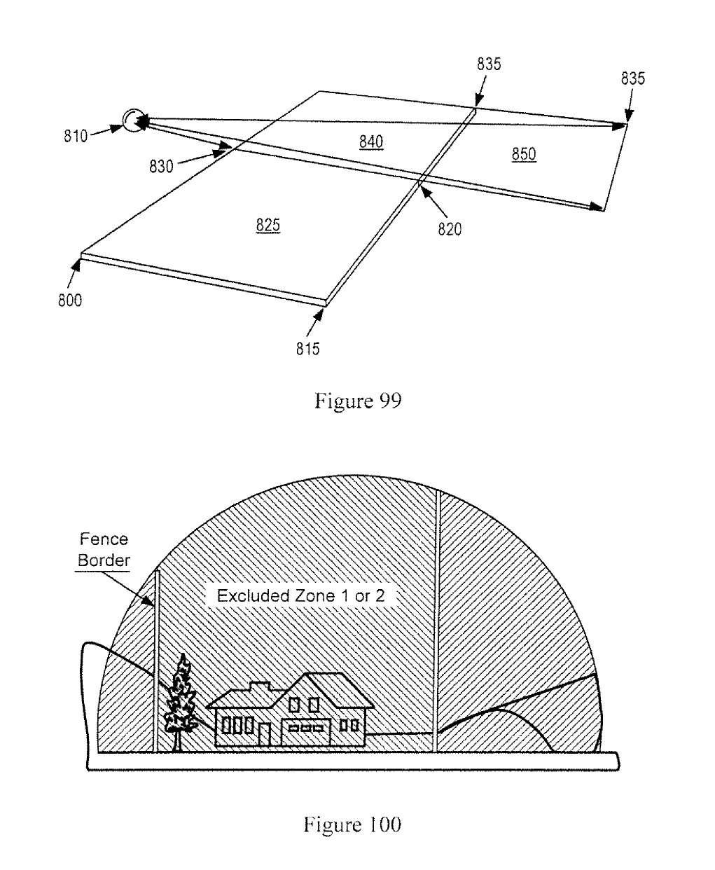

This ambiguity may be mitigated, for some embodiments, through an extended observation of movement, as shown in FIG. 99. As node 1(810) trips from 6 (835) to 7 (845), forming a third plane (850), compared with two previously constructed planes, consistency in the referenced height of node 4 (810) serves to validate the horizontal, as well as a consequent height associated with the configuration.

For 3D networks with more than 2 static positioning engines (e.g., Spotcast) nodes, the same technique may be applied replacing each traveling spot (e.g., such as ID2, ID3, ID4, ID5, ID6, ID7) with static positioning engine nodes present in the network. With such larger networks, the process of obtaining and comparing planes may be correspondingly shortened.

Unlike the pre-programmed height method, the implementation of this method does not demand an abundance of static positioning engines (e.g., Spotcasts), attributing applicability to broader areas with mobility.

Sensor Migration Bridge

In some embodiments, there is a migration bridge or backwards compatibility to operate with mobile devices or objects that implement partial technological sensor solutions. In order to share known information, the migration bridge may utilize a local wireless network protocol (e.g., Wi-Fi). Through a local network, devices may be able to share known information with each other to augment any known data points. This may provide range, localization enhancement, and error reduction between devices.

In some embodiments, existing mobile devices may use a signal to compute range data. The signal may be a Bluetooth signal. The signaling may provide enough information to give a reasonably accurate range that can be further enhanced through other devices participating in the local network. However, without dead-reckoning technology, Bluetooth devices may not be able to provide angle and range.

In some embodiments, existing mobile devices with GPS capability may calculate a range and angle from GPS data. To increase resolution granularity, GPS data will be augmented by a range calculation based on the Bluetooth range. GPS or Bluetooth may not calculate device orientation. Although orientation may be computed while a device is in motion, this is not applicable when the device is stationary. These devices will lock the display orientation and not rotate the display information.

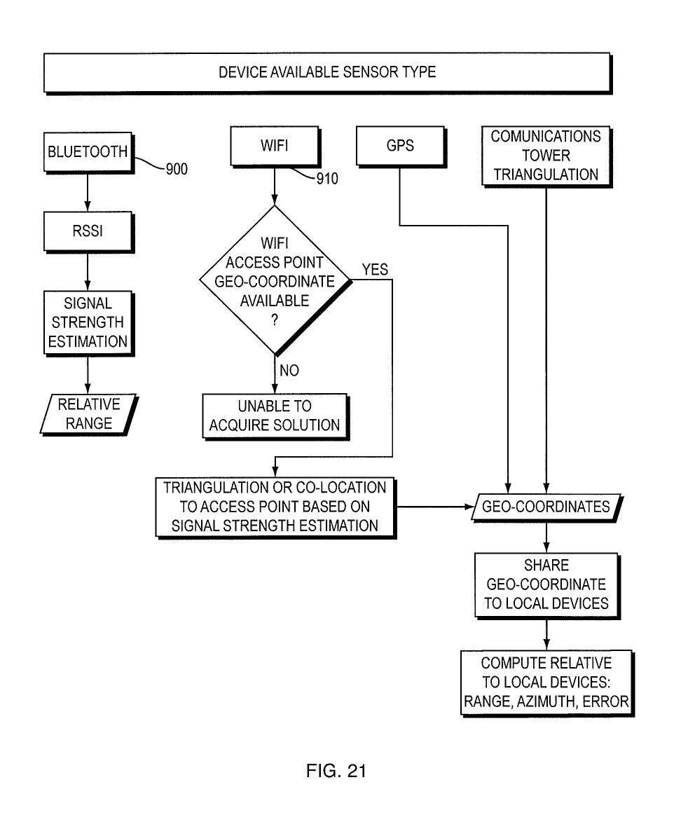

FIG. 21 illustrates an exemplary overview for processing different sensor types in accordance with the present invention. Devices that include Bluetooth 900 can only achieve an estimated relative range from other devices based on a Bluetooth signal strength estimate. FIG. 21 also illustrates that, in certain embodiments, devices with Wi-Fi 910 can access public databases of geo-coordinates for publicly available Wi-Fi access points. Given 1 or 2 access points available within range, a given device can be collocated around the access point at an estimated range and given a geo-coordinate based on a closest access point with the strongest signal strength. Given 3 or more access points available within range a triangulation can be established based on the signal strength to each access points and a geo-coordinate determined. FIG. 21 further illustrates that given that a geo-coordinate is found, these coordinates are shared across the local devices via a local wireless network, a relative coordinate system may be calculated, and the required relative data range and azimuth may be determined. An error area may be also computed to determine the possible error associated with the range and azimuth.

The relative coordinate conversion between two devices with geo-coordinates (X1, Y1) and (X2, Y2) is as follows:

Range=SQRT((X1−X2)̂2+(Y1−Y2)̂2)

Azimuth=A Tan 2((Y2−Y1),(X2−X1))

Area of Interest (AOI) Filter

In some embodiments, information that is outside an area of interest (AOI) is filtered. The information may be received due to an increased range calculation via sharing of track information between devices using the local area network. Given that a relative range may be available between devices, the AOI Filter may remove objects which are farther than a defined maximum range.

Post-Positioning Filter

In some embodiments, after relative positions are acquired by a positioning algorithm, solutions may be sent to filters for better estimation. Several methodologies may be available for utilization, such as recursive estimation of the state of a dynamic system from incomplete and/or noisy data points (e.g., Bayesian Filter), and the same techniques used in preprocessing for jitter elimination.

Track Files

In some embodiments, track files may be utilized in order to keep a list of local objects. A track file may contain the object ID, angle, range, error, error contour, and associated information. Local track files may be sent or received from other local objects and merged using augmented data from other objects. The final merged track may decrease position errors.

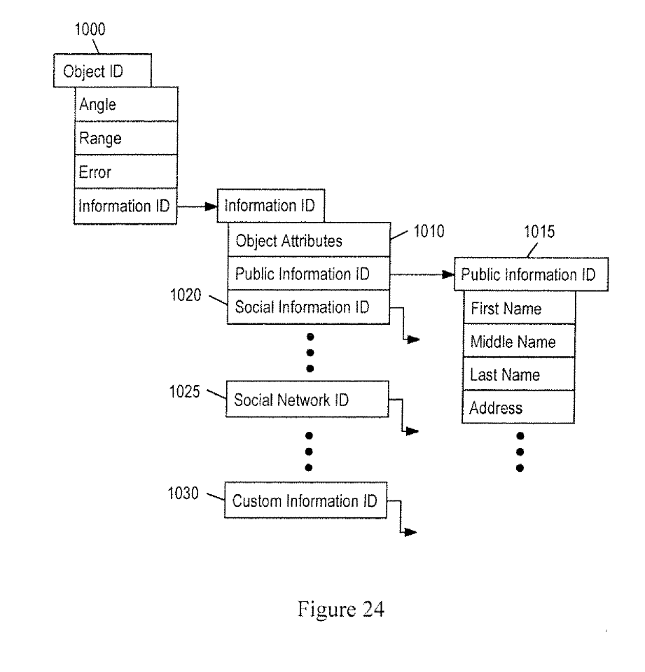

FIG. 24 illustrates an exemplary track file data schema in accordance with the present invention. Each ObjectID 1000 may represent a unique object or “track” in the sphere of influence (SOI) and its associated location information. Each ObjectID 1000 may be linked to its information, which may include: object attribute characteristics 1010, public information 1015, different social information 1020, a social network 1025, and a custom defined information types 1030.

External Track Files

In some embodiments, there may be an option to merge other mobile device/object track files to, for example, augment an own data set or decrease position error.

User-Decrypted Track Files

The track file location contains a decryption key that determines if the object can view or act upon location information. If an object key matches the existing location key of the object, then the object location may be decrypted and passed into a user-readable, final track file. The merged track file establishes the final track files of objects to be displayed. The track file with augmented positions may allow objects with limited sensor capabilities to view and manage the location of other objects with enhanced sensor capabilities. FIG. 24 illustrates an exemplary track file data schema, where each ObjectID 1000 represents a unique object or “track” in the sphere of influence (SOI) and its associated location information. The ObjectID 1000 record is visible, however, the information ID's 1010 are each encrypted with their unique key. In order to access the information, the data is first decrypted.

The Architecture

In some embodiments, a system and/or method allows a device to have the capability of locating and visualizing a relative position between objects within a range, without infrastructure or some other geographical reference information (e.g., GPS, cellular tower, etc.). Each device/object may create a physical model of its environment to acquire a local reference system of objects in its environment. In general, the system and/or method is achieved by incorporating a mathematical physics modeling algorithm that utilizes inputs such as a range between objects, an object movement vector, a local orientation, and a data feedback loop with other remote objects. The data feedback loop shares location information between objects to improve and complement other object data and sensors.

Physical Signaling

In some embodiments, the device may require a method to transmit data and estimate a range between objects. Such an embodiment uses a radio frequency (RF) transceiver to provide signaling and information between devices. Two standard methods may be used for range computation between objects: Received Signal Strength (RSS) and/or Time of Flight (ToF). For RSS, the power level from the RF transmission may be utilized to provide a signal strength that may be correlated to a range for the specific transmitter specifications. Range via ToF may utilize a data protocol or signal to establish the timing to calculate the transmission time. To increase accuracy, multiple signals may be sent back and forth between objects to accumulate a larger time of flight value and averaged by the number of trips. Some embodiments of the invention combine both methods into a dual approach, providing additional sensor and environmental characterization between the objects.

Some embodiments of the invention utilize a narrow band transmitter operating at 2.4 Ghz. Other embodiments may use other frequency band or standards such as, for example, Ultra Wide Band (UWB) transmission method or ultrasound to determine range between nodes.

Local Orientation

The device may include a method to create local orientation so that all local objects are synchronized to a similar referenced point. In some embodiments, a three-axis magnetic sensor is utilized that may sense the Earth's magnetic field. Through the utilization of the tilt sensor, object tilt compensation may be performed in order to provide accurate readings and accurately determine the Earth's magnetic field.

The magnetic declination may be the angle between true north and the sensor magnetic field reading. The magnetic declination may vary at different locations on the Earth and at different passages of time. The declination may vary as much as 30 degrees across the United States. Within a 100 KM area, however, the magnetic declination variation may be negligible for certain embodiments to operate locally.

Tilt Sensor

Some embodiments of the invention may use a method to compute the tilt of the device relative to the Earth. On such embodiment utilizes a three axis MEMS accelerometer in order to determine tilt.

Movement Vector

When the object moves, the device requires a method to determine the relative distanced moved. This value provides a reference notion of the distance traveled over ground. Some embodiments utilize a pedometer function or a physics model for displacement as a double integration of acceleration with respect to time. Examples of these two methods have been described in detail above.

Data Feedback Loop

The device requires a method to transmit and receive data in order to share and update with other local objects' sensor data, location, and information. Some embodiments may utilize a narrow band transceiver in 2.4 GHz. Additional embodiments may include other bands or methods to transmit data between devices.

As each object acquires object positions, they may be stored in local track files. The track file contains the object ID, angle, range, error, error contour and associated information, according to some embodiments. Each neighboring object shares its local track file in order to merge the data into an augmented data set. Thus, the final merged track file may decrease position errors and augment other objects with limited or less accurate sensors.

Positioning Engine Configuration

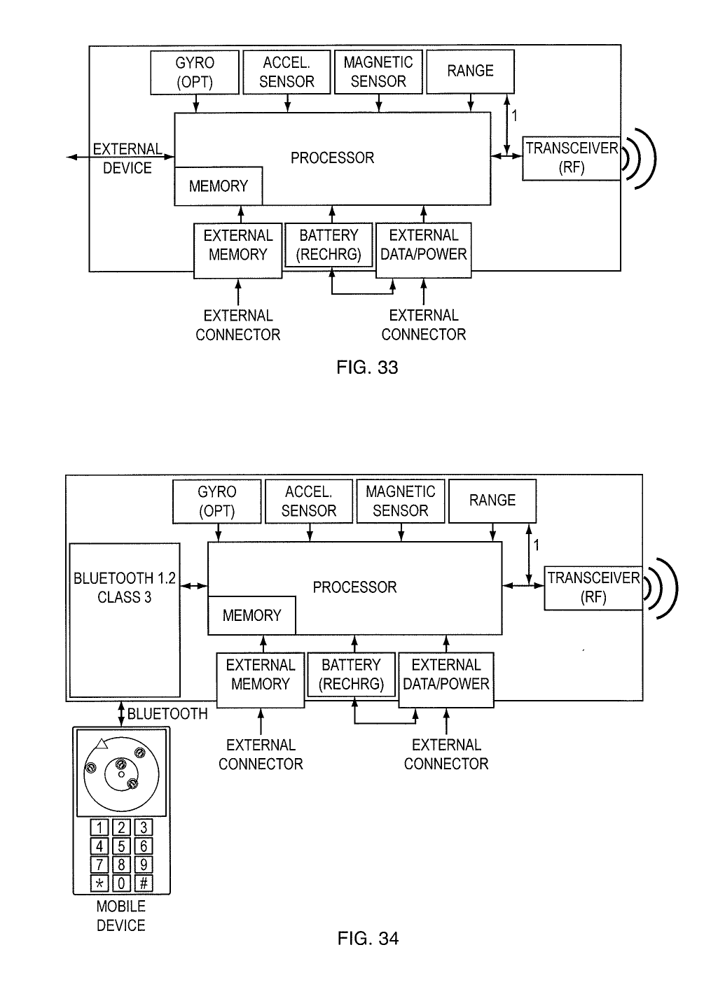

According to certain embodiments, a positioning engine (e.g., a “PixieEngine” developed and implemented by Human Network Labs, Inc.) may be used. The positioning engine may be implemented as part of an integrated circuit (IC) board and may be further integrated with other components via physical or wireless connections. FIG. 33 illustrates an exemplary block diagram of an implementation of a positioning engine (e.g., a “PixieEngine”) in accordance with the present invention. Some embodiments of the positioning engine may include a gyroscope, an acceleration sensor, a range sensor, a magnetic sensor, a memory, an external memory connector, a battery, an external battery/data connector, an interface to an external device, and a transceiver all coupled with a processor. The positioning engine may implement a power transmission adjustment level based on a range and RSS between objects (as illustrated in FIG. 33).

Some embodiments integrate the technology with existing devices over standardized communication channels. Such an embodiment may use a Bluetooth wireless connection.

FIG. 34 illustrates an exemplary block diagram of an implementation of a positioning engine designed to integrate with existing devices over a Bluetooth wireless connection in accordance with the present invention. In addition to the description of FIG. 33, the exemplary embodiment of FIG. 34 includes a Bluetooth interface coupled to the processor for communications with a device.

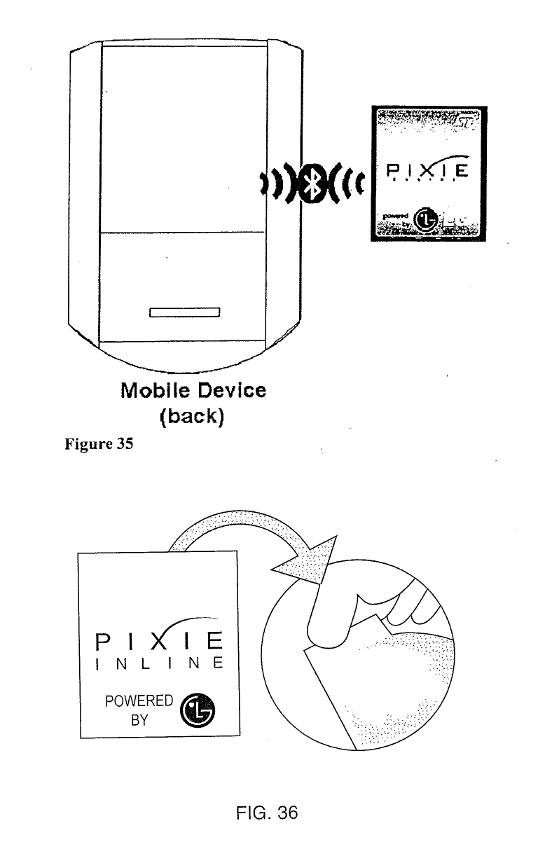

FIG. 35 illustrates an exemplary view of communications between a mobile device and a positioning engine (e.g., a “PixieEngine”) in accordance with the present invention.

FIG. 38 illustrates an exemplary view of communications between two positioning engines (e.g., “PixieEngines”) attached to mobile devices in accordance with the present invention.

Positioning Engine Encryption

To provide privacy and security protection, some embodiments of the invention further allow for operation in a fully encrypted mode between objects, as well as internally. The implementation allows information to be shared with external devices that are listed in the user-decrypted track file. Thus, data stored within the integrated component may be maintained as encrypted until decryption key requests are met and matched.

Local Network

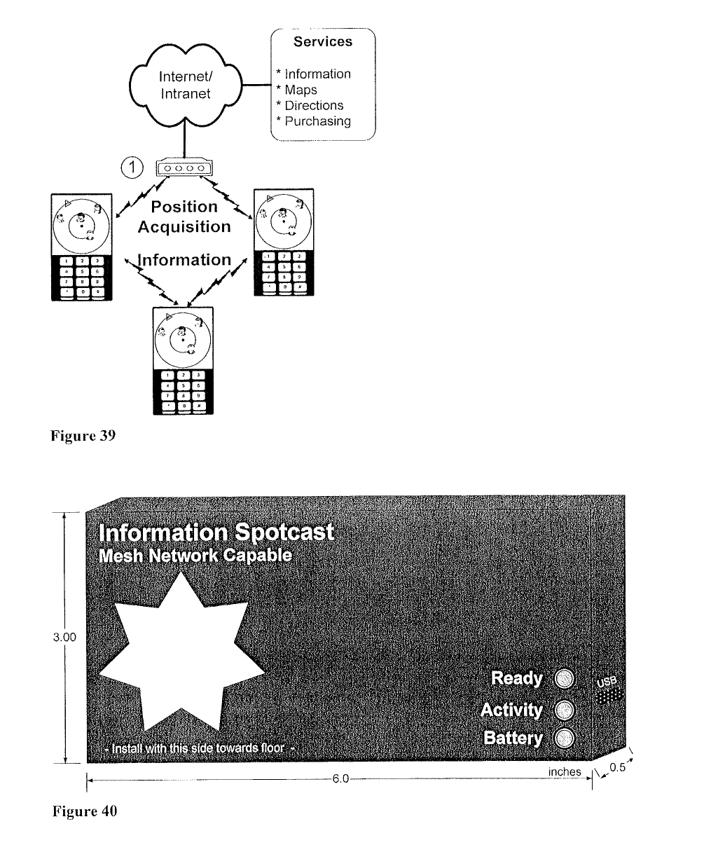

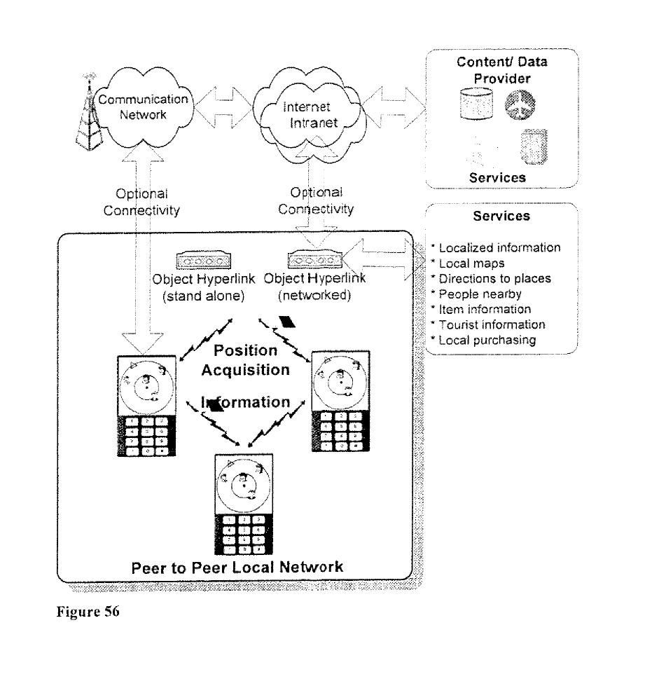

Some embodiments of the invention may implement a local peer-to-peer mesh network that is utilized to send location and object information. The local network may allow for data to be routed to each peer object as well as objects not directly accessible via an intermediary object. The network may allow for continuous connection and reconfiguration by finding alternate routes from object-to-object as objects' physical connectivity may be broken or the path may be blocked. The mesh network may operate if it is fully or partly connected to objects in its network. Examples of such a network are illustrated in FIG. 39 and FIG. 56. FIG. 39 illustrates an embodiment of a mesh network that demonstrates how information such as, for example, services and position acquisition information may be distributed through the network of objects in a peer-to-peer mesh network. FIG. 56 illustrates an exemplary embodiment of the object-managed local/remote information and mobile device-managed local/remote information in accordance with the present invention.

A Wide Area Network Capability

In some embodiments, a local peer-to-peer mesh network may allow objects to act as gateways to resources located outside the local objects. Connectivity may be to a local information resource or remote via a wide area network. Information between objects may be exchanged locally with individual objects capable of requesting information from data outside the local network as illustrated in FIGS. 39 and 56.

Form Factors According to Some Embodiments of the Invention

In some embodiments, the functionality and services of the positioning engine may be implemented via two types of static positioning engines: a “Stick-on” and/or a “Spotcast.” In some embodiments, the Stick-on form factor may allow easier integration into an existing mobile device. A Stick-on is a form factor that may be attached a device. Alternatively, a positioning engine may be integrated directly into a device using hardware, software, or any combination thereof. A static positioning engine (e.g., “Spotcast”) may be for standalone usage and may offer additional services that may not be as appropriate in a mobile device such as, for example, object hyperlinking, a data gateway, and object directionality. Finally, a miniature Spotcast (e.g., an “Ultra-light Spotcast”) may provide a miniature form factor that may be attached to existing products or an animal/child to provide information or location.

### Certain Stick-On Embodiments

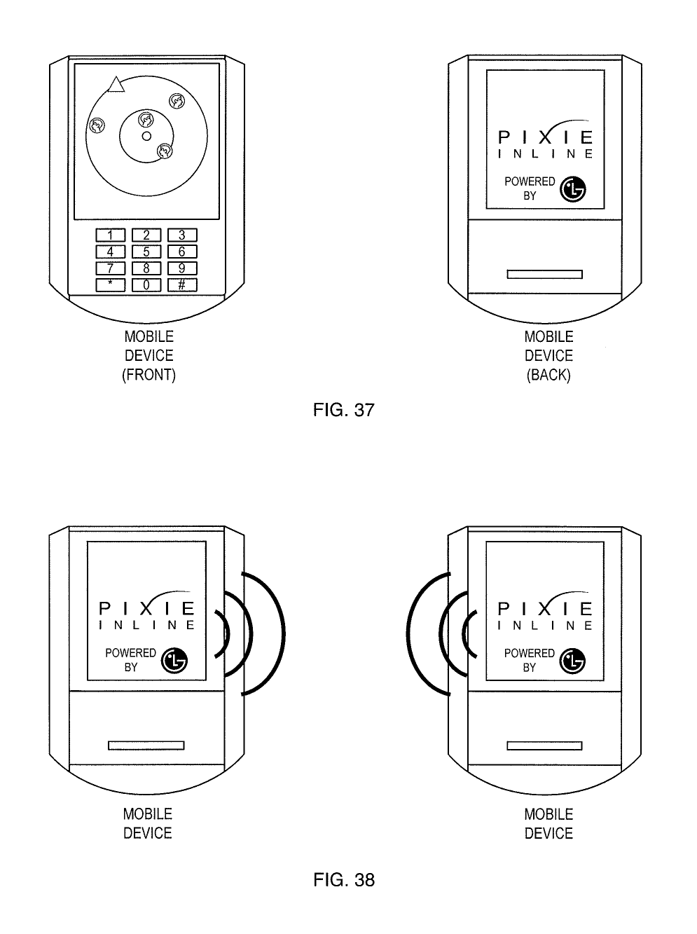

In some embodiments, a physical form factor may be used to allow for the technology to be attached or to adhere to existing mobile devices as shown in FIGS. 36 and 37. FIG. 36 illustrates an exemplary view of physically attaching a stick-on positioning device to an existing mobile device in accordance with the present invention. FIG. 37 illustrates an exemplary front and back view of a mounted stick-on positioning device in accordance with the present invention. The Stick-on may provide for the unique marketing methodology of viral marketing, where another party may utilize a Stick-on for functionality and marketing. As illustrated in FIG. 37, a Stick-on may be mounted physically on a mobile device (e.g., such as those made by Apple®), or any other compatible device. Certain Stick-on embodiments may provide both innovation functionality and a unique viral marketing methodology implemented via a hardware solution.

### Spotcast Embodiments

Some Spotcast embodiments may provide the architectural components necessary to implement object hyperlinking Such embodiments may be integrated into a device that may be deployed and attached to static objects in different scenarios; in such cases, a battery or wired power source may be used as illustrated in FIG. 33. A Spotcast may provide the object hyperlinking connectivity illustrated in FIGS. 2-7.

### Information Spotcast Embodiments

A basic device that implements at least some of the embodiments is a “Spotcast.”

FIG. 40 illustrates an exemplary information static positioning engine (e.g., a “Spotcast”) in accordance with the present invention. A Spotcast may create the object hyperlink and the information may be stored in the device or another source of local or remote information via a link.

FIG. 41 illustrates an exemplary set of information from a static positioning engine (e.g., a “Spotcast”) shown on the user display of a mobile device in accordance with the present invention. A Spotcast may be installed where information may be made available to users of a mobile device capable of receiving information from a static positioning engine. In FIG. 41, a Spotcast is installed at each of locations 1, 2 and 3. Location 1 links to information on the first restaurant (e.g., KFC®), location 2 links to information on the second restaurant (e.g., Starbucks®), and location 3 links to information on the third restaurant (e.g., Burger King®). The user may view the information/scene through the display of the mobile device. The graphical icons shown to the user may correspond to the physical location of the installed Spotcasts relative to the user (e.g., illustrated as “me”).

### Ultra-light Spotcast Embodiments

In some embodiments, an ultra-light Spotcast may be used. Although the ultra-light Spotcast is equivalent in functionality to a Spotcast, it may have a limited battery life and may be suitable for attachment to other products intended for quick deployment, where the other products are used as a delivery platform. FIG. 42 illustrates an exemplary ultra-light static positioning engine (e.g., a “Spotcast”) being compared in size with a quarter U.S. dollar in accordance with the present invention. In some embodiments, an ultra-light Spotcast may be attached to a movie poster. When the movie poster is deployed, the Spotcast may automatically be deployed. An ultra-light Spotcast may also be utilized to tag a vulnerable or high value asset such as, for example, a child, a pet, a briefcase, and car keys in order to provide a capability for tracking such assets.

### Certain Directional Spotcast Embodiments

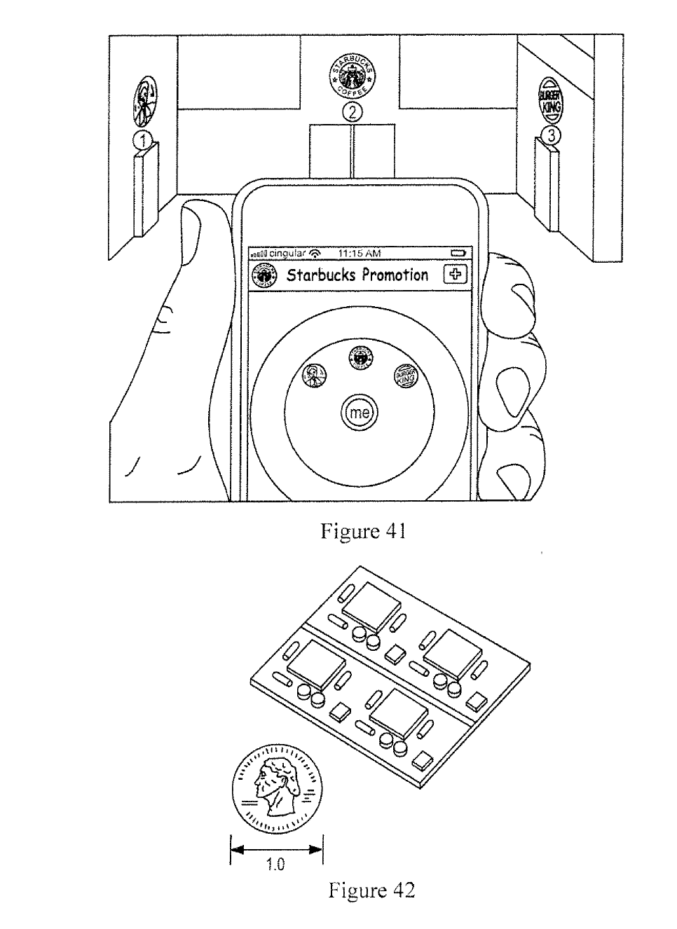

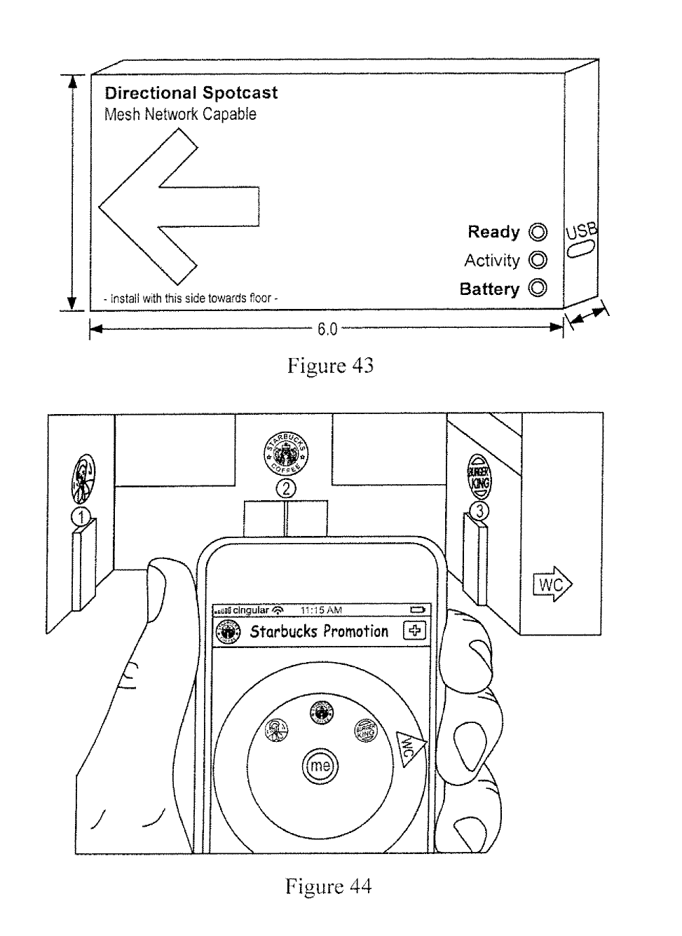

FIG. 43 illustrates an exemplary directional static positioning engine (e.g., a “Spotcast”) in accordance with the present invention. Some embodiments of the present invention may provide direction information to objects in the area; the direction information may be used to guide or show the user the intended direction/location. The basic device may allow its physical deployment by either utilizing a battery or wired power source, as illustrated in FIG. 43. The device may store a reference direction to other objects in the area.

FIG. 44 illustrates an exemplary set of directional information from a static positioning engine (e.g., a “Spotcast”) shown on the user display of a mobile device in accordance with the present invention. An example of an embodiment of a Directional Spotcast is provided in FIG. 44. The scenario below shows bathrooms “WC” located towards the right of the user. A Directional Spotcast is installed to provide a compass direction of the actual bathroom Spotcast.

### Certain Fence Spotcast Embodiments

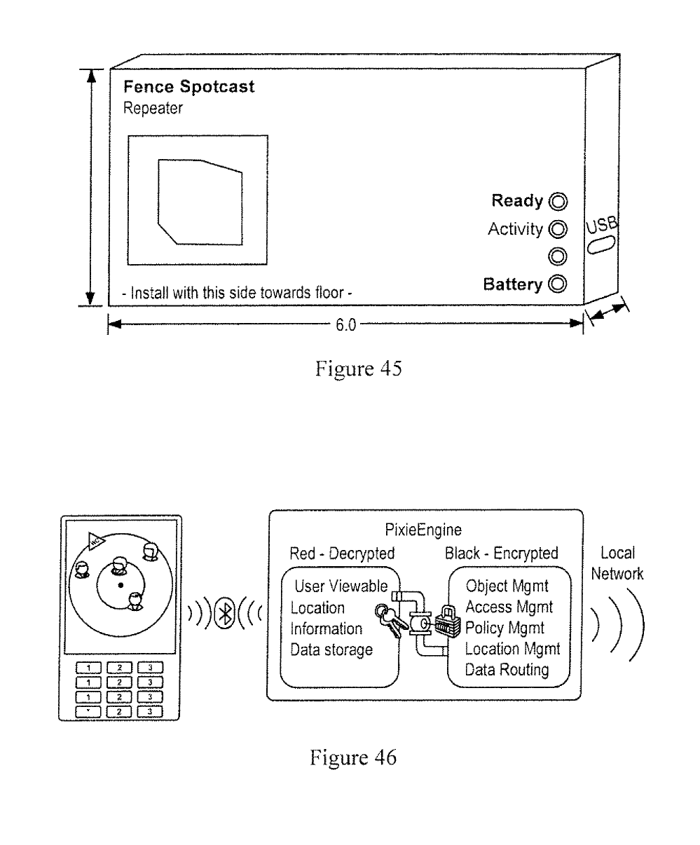

Certain embodiments can store fence boundary information to objects in the area which may be used to alert other objects of zone categories. FIG. 45 illustrates an exemplary fence static positioning engine (e.g., a “Spotcast”) in accordance with the present invention. The basic device allows the Spotcast to be physically deployed either utilizing battery or wired power source as shown in FIG. 45. The device can store reference geometry to other areas creating safe zones.

### Certain Device Spotcast Embodiments

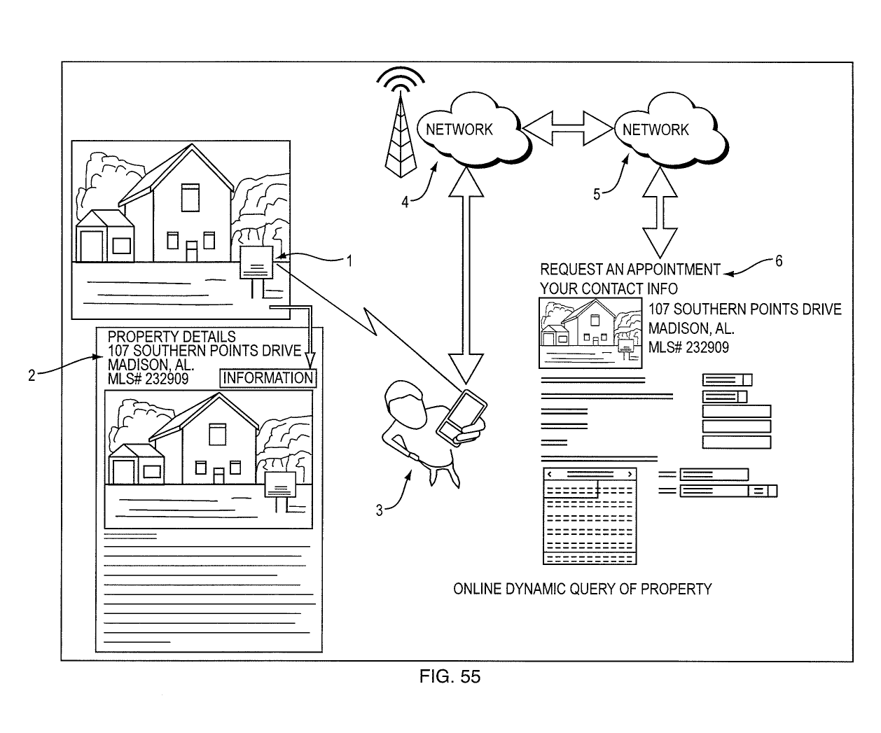

Some embodiments may integrate information between objects and existing devices such as, for example, printers or overhead projects in the area. Some embodiments may allow for the interaction between devices, including activating and controlling devices. FIG. 55 illustrates an exemplary user display of a mobile device interacting with a static positioning engine (e.g., a “Spotcast”) either using a local network or the network service of the device in accordance with the present invention. As shown in FIG. 55, in some embodiments, a user mobile device may interact with a static Spotcast either from a local network or by utilizing the Internet services of the device. A Spotcast on a sign, for example, may trigger property details to be downloaded to a user device via a network connection.

Positioning Engine Process Functional Blocks

In some embodiments, the architecture of the positioning engine may be implemented in two parts: (1) a client application that may operate in a mobile device, and (2) an embedded solution.

Client Application in a Mobile Device

In some embodiments, a client application may provide the means to visualize and interact with objects that are accessible by the user. The application may operate entirely in the user device. The client application may operate in a wide range of user devices from the low-end to the high-end multimedia-rich devices. In addition, benefit may be derived from the infrastructure-free characteristic of the embodiments of the present invention such that it operate anywhere in the world, even when wireless services are not available.

FIG. 85 illustrates an exemplary embodiment of three different application user interfaces of mobile devices in accordance with the present invention. In some embodiments, the positioning system may be applied to several mobile devices, where each of them shows the reconfigurable user interface. The interface may utilize the same location architecture but may be customized for specific applications such as, for example, social networking, military use, and child tracking

Embedded Solution

FIG. 46 illustrates exemplary red and black sides of a positioning engine (e.g., “PixieEngines”) in accordance with the present invention. In some embodiments, an embedded solution may implement location acquisition, security, searching, and data routing outside the user's access or client application. This provides a privacy separation between user accessible data and other data that is not intended to be accessed by the user. The embedded solution may be internally divided into two sides: a “black side” that contains encrypted data and a “red side” that contains decrypted data. The red/black approach provides a careful segregation between red and black data (discussed below).

Black Side—Encrypted Data

In some embodiments, black side data may contain encrypted information or ciphertext (e.g., “black” data) that may contain non-sensitive information. The user/client application may have no access to the black side unless a user key for decrypting the data matches and is allowed to pass the key filter. This may allow certain embodiments to manage and operate the black side while keeping encrypted data and resources outside unauthorized user access. The black side data may include management features for hardware resources needed for positioning and communications, as well as algorithms for data manipulation, as shown in FIG. 46.

Red Side—Decrypted Data

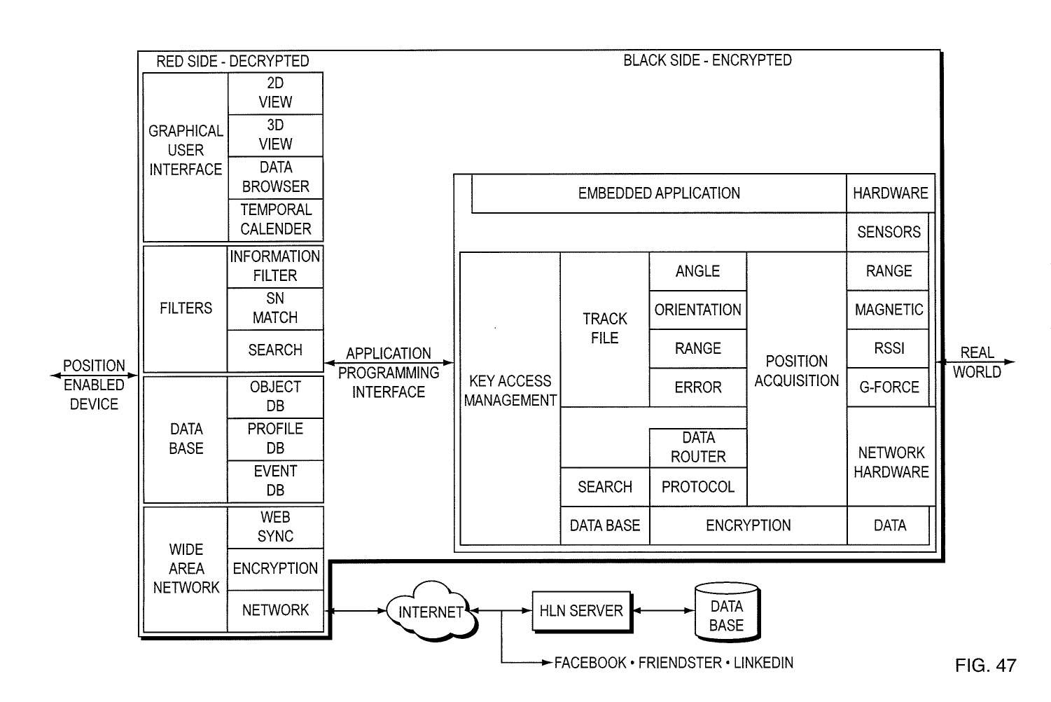

In some embodiments, data that contains sensitive plaintext information (e.g., “red” data) may be operated on the red side. The red side may allow for data searches to be executed occur within the data fields, as these fields are now in plaintext format. A user device may access the red side via a command protocol between the client application and a positioning engine (e.g., a “PixieEngine”). The command allows for the transmission of accessible object information into the user device. The different functions are illustrated in FIG. 47.

FIG. 47 illustrates exemplary categories and functions of red and black sides of a positioning engine (e.g., “PixieEngine”) in accordance with the present invention. In FIG. 47, the decrypted side includes graphical user interface, filters, a database, and a wide area network. The graphic user interface in embodiment includes a 2D view, a 3D view, a data browser, and a temporal calendar. The filter in the interface shown may include an information filter, SN match, and search. The database may include object database, profile database, and event database. The wide area network may include web sync, encryption, and network, which may interface with a network such as the internet. The decrypted-side modules interface with the encrypted side, in the FIG. 47 embodiment. The FIG. 47 embodiment includes on the encrypted side and embedded application, hardware sensors, and network hardware. The embedded application may include modules for managing: key access, track files, angles, orientation, ranges, errors, position acquisition, data routing, protocols, searching, databases, and encryption. The hardware sensors may include: range, magnetic, RSSI, and G-force. Furthermore, the embodiment may also include a data module in the network hardware. The hardware and network hardware modules interface with the real world as illustrated in FIG. 47.

User Key

In some embodiments, to convert the encrypted information (e.g., “black”) into readable data or plain text, the user may supply a valid key for decoding.

Directions to Points of Interest

In some embodiments, in addition to providing location information, the user display on a device configured with a positioning engine may show general or specific turn-by-turn directions to points of interest. The user display may graphically display unique directional-icons that provide a reference direction to a point of interest, which the user may customize or that may be available by default. The icons may appear on the display as orientated towards the direction of the point of interest. In addition to the direction shown towards the point of interest, the user's orientation may be used to show a vector to the point of interest. The actual location of a directional-icon may not be as important as what it may be referring to by its direction. In some embodiments, directional-icons may be shown via the user display on the outside line in the COI with an arrow indicating the direction. Directional-icons may be programmed through a direction routing table that indicates the compass direction the user should navigate towards from the user's current location.

FIG. 23 illustrates an exemplary diagram of directional routing when navigating through two perpendicular hallways in accordance with the present invention. FIG. 23 shows objects located in two perpendicular hallways (1201) such, for example, in a typical airport. The objects A1 (1200), A2 (1210), A3 (1220), B1 (1225), B2 (1230), C1 (1240) and C3 (1235) may be configured as direction information is computed relative to the Earth's magnetic field north. In some embodiments, the objects may be static positioning engines (e.g., “Spotcasts”) with directional routing built-in. In the exemplary configuration shown, object A1 (1200) has a directional route indicating that sections “B” (1225, 1230) or “C” (1235, 1240) are located a direction east relative to itself. Similarly, object B1 (1225) has a directional route indicating that sections “A” (1200, 1210, 1220) or “C” (1235, 1240) are located a direction south relative to itself.

In the exemplary embodiment of FIG. 23, a directional object (1245) may be inserted in the middle to provide a directional gateway associated with a turn. The directional object (1245) may indicate that section “A” (1200, 1210, 1220) is west relative to the directional object (1245), “B” (1225, 1230) is north relative to the directional object (1245), and “C” (1235, 1240) is south relative to the directional object (1245). In some embodiments, the range between objects may be automatically computed for any given direction based on information available to each object and a directional routing table. For example, the range between A1 (1200) and C1 (1240) may be computed by referring to a directional routing and summing the available ranges such as, for example, R1+R2+R3+R4+R5, as illustrated in FIG. 23. Directional routing may be computed programmatically as well in certain scenarios; programmatic determinations may not take into account a particular physical limitation established in the real world such as, for example, a non-working elevator or an obstruction in the path between one or more objects or directional objects.

Sending an Alert to Remote Devices

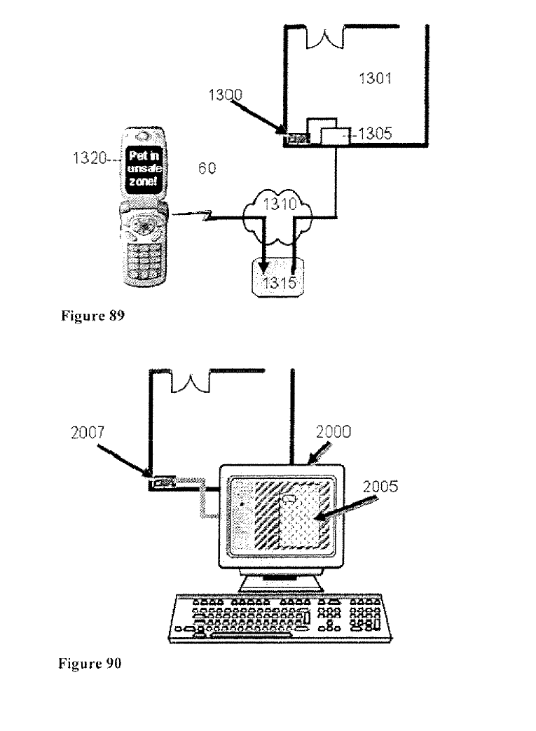

FIG. 89 illustrates an exemplary embodiment of a static positioning engine (e.g., a “Spotcast”) connected to the Internet to send a message to an appropriate remote party in accordance with the present invention. When an object creates an event, an object may be configured to send an alert or message to a remote device. In the exemplary embodiment illustrated in FIG. 89, a positioning system such as a static positioning engine (e.g., a “Spotcast”) (1300) is installed in a building room (1301), where the static positioning engine (1300) is connected to a computer or Internet gateway (1305) that provides it with an Internet connection (1310). The static positioning engine may send a message to a gateway server (1315) that transmits the message over a communications link (60) to the appropriate remote party, a user/mobile device (1320), or any other parties capable of receiving the message.

Relationship Discovery

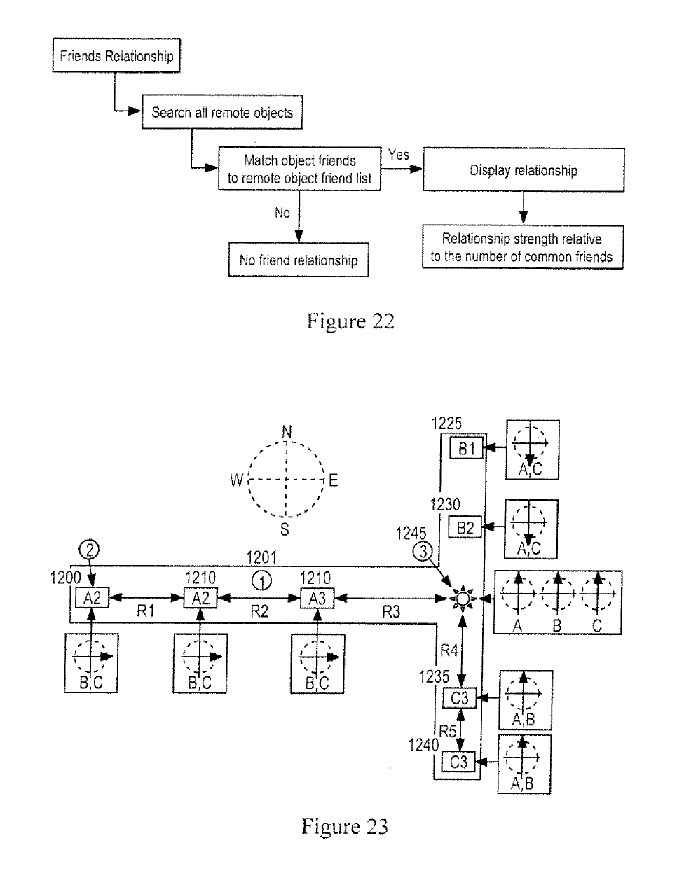

FIG. 22 illustrates an exemplary block diagram of a process flow to determine and display friend relationships in accordance with the present invention. Each object may contain a link to information, which may in the aggregate create a source of information attributes. Object relationships may be determined passively by evaluating objects and associating objects with similar and matching attributes as having relationships, or determined actively by creating supply/demand attributes. Each relationship may be analyzed for a relationship strength value that may indicate the quality of the relationship, or may be analyzed for how close (e.g., “good”/“bad”) the relationship may be between two objects. In some embodiments, for objects linked to a personal profile, a passive relationship may be determined by identifying other personal profiles may be from, for example, the same city. In supply/demand relationships each object may provide a list of information that it may have available and a list of items it may be seeking. In some embodiments, for objects with a graphical display, the user may view relationships as lines drawn between objects on the user display. A relationship discovery application may be loaded onto the object as an application/software plug-in that may meet the specific need of the user based on the available data. For example, a friendship relationship discovery application may be able to search the objects in the AOI and match each remote object's friends with the friends of the user whose device is executing the application; thus, the application may provide a visual representation of common friends, as shown in the exemplary embodiment of FIG. 22. In some embodiments, the relationship strength value may be shown on the user display as a function of the number of common friends, for example, as follows:

TABLE 3
Relationship Strength Value and Visual Representation
Based on Number of Friends

| Number of | Relationship | Visual Representation/ |
|---|---|---|
| Friends | Strength Value | Display |
| 1-2 | Weak | Thin thickness line |
| 3-5 | Medium | Medium thickness line |
| 5+ | Strong | Strong thickness line. |

In some embodiments, a process may search all remote objects and match each object's friends to a remote object friend list that it populates. For every match that the process may determine, the process may also determine a relationship and relationship strength for common friends. Alternatively, if the process does not determine any matches, then the process may not determine any relationships or relationship strengths, and none may be displayed on the user device. The relationship discovery application may be as numerous as the social needs and data sets available. For example, when the devices/objects of the present invention are used in, for example, a medical conference scenario, specific medically-related data and applications may be loaded onto the device/object to create unique relationships specific to the medical user group. In some embodiments, the relationships shown on the user device may be those of doctors who have a common specialty or work in similar fields.

User Display

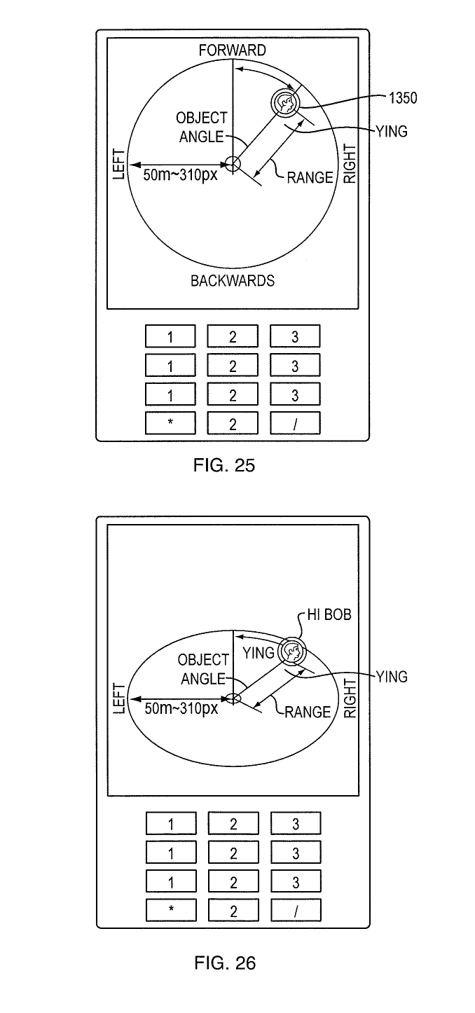

FIG. 25 illustrates an exemplary 2D view on a user display of a device in accordance with the present invention. In some embodiments, the user display may graphically illustrate device locations, relationships, and other information. The display may show a graphical representation of the other devices within the AOI of a user's device, or other devices that may be linked virtually. In addition, the user interface may show other information and relationships between devices within the range of the user's physical area, as well as those that may not be present physically but may have a virtual connection. The location of other devices in the AOI may be shown relative the user device. The graphical user display may be oriented to match the user device's actual physical orientation; for example, the top of the user display may correspond to the user's “forward-looking” direction. Devices that may lie ahead of the user may be represented on the user display according to each of their corresponding locations, which may mirror their actual physical position.

As illustrated in the exemplary embodiment of FIG. 25, an icon 1350 may be used to denote another device with social profile information. The icon 1350 (e.g., labeled “Ying”) is shown on the display to be a distance/range away from the user, and also at an angle (e.g., theta) relative to the user. Further, the user display may vary according to the user's intended use; in some embodiments, the orientation may be configured to provide a view from an above perspective (e.g., a 2D view) or a forward-looking perspective (e.g., a 3D view). The 2D view may show user of the device in the center of the display (e.g., the center may grahpically represent the user as “me”). Other devices in the user's AOI may be shown on the user display according to each of their corresponding positions and may be, for example, shown from an above perspective. For example, if the user is holding the device pointing in the north direction and another device is 30m away and at 45 degrees ahead relative to the user's device, the other device may be shown on the user's display as such, as illustrated in the FIG. 26.

FIG. 26 illustrates an exemplary 3D view on a user display of a device in accordance with the present invention. As illustrated in the exemplary embodiment, the user display may provide a 3D view as a projection of a 2D view, with a 45 degree tilt angle. In some embodiments, the projection may be done using a mathematical transformation where the display located at coordinates (X, Y) is moved to new coordinates calculated as (X, 0.7*Y). Some embodiments may provide the ability to consider and show the height of devices in the plane shown on the user device. The height may be estimated using a computational method applied the user plane and the device's height placement relative to the user's plane, or via hard coding. For example, the height of a box may be hard coded as 1 m above the floor.

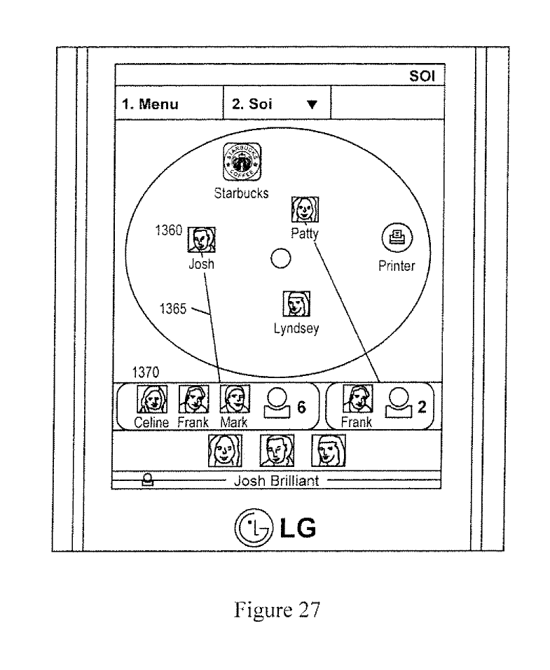

FIG. 27 illustrates an exemplary view of common friend relationships on a user interface of a device in accordance with the present invention. Relationships that may exist between devices may be determined and shown graphically by, for example, representing the relationship between devices as a line connecting the devices on the user display. FIG. 27, for example, illustrates the common friends between the user of the device shown and a friend/other device user, “Josh” (1360). The relationship may be shown graphically as a line (1365) between the friend, “Josh” (1360); a group of individuals (1370) matching the relationship may also be shown. In some embodiments, in addition to the basic information of devices, which may be illustrated on the user display by text or icons, users may also be able to obtain additional information by interacting with a device. For example, a user that selects a device on the display may receive pages of information pertinent to that device.

In some embodiments, the user display/interface (e.g., graphics) may be implemented, for example, using a light client application coded in Java/J2ME and that may reside in a mobile device. The mobile device may be, for example, a phone or media player.

In some embodiments, the 2D display may use a circle to represent the top viewing area for the objects/devices local to the user's device. The radius of the circle and, accordingly, the coverage range, may be configured/programmed and may support zooming (e.g., in/out) in quadrant or area views.

Range Only Objects

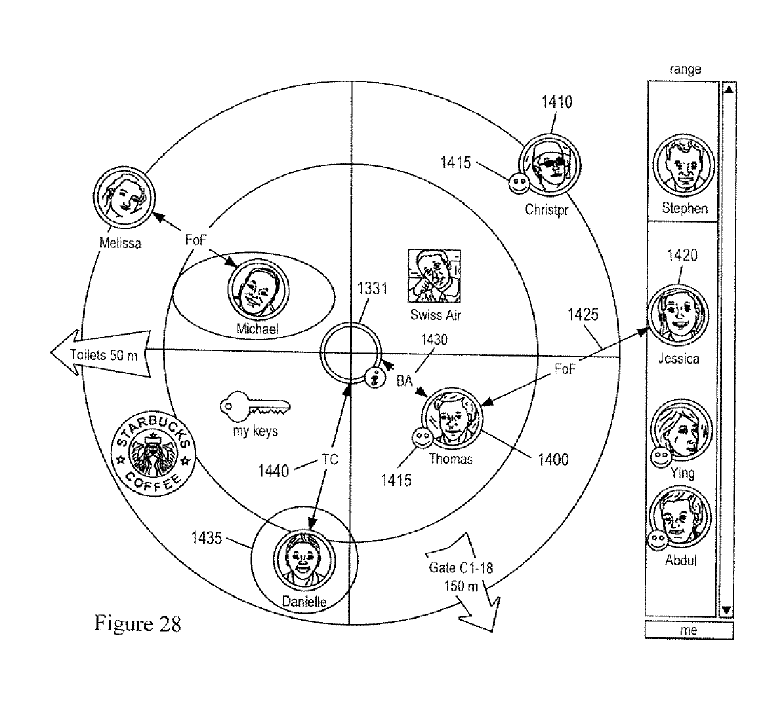

FIG. 28 illustrates an exemplary view of relationships and a range display within an area of interest (“AOI”) of a device in accordance with the present invention. In some embodiments, a range bar may graphically show the range away from a device 1420 that cannot be fully localized relative to the user device due to, for example, inadequate sensors or poor sensor data. Such devices may be referred to as “range only” objects and may be shown as a circle within the COI or horizontally/vertically along the user display with a corresponding range, as shown in FIG. 28.

Display of Object Error

In some embodiments, when integrating and interfacing with other location systems with larger location errors such as, for example, GPS, an error profile shadow may be shown to indicate the possible locations of the object. The display may show the location error of each device using a shadow under the icon. This allows for different technologies with larger errors such as, for example, GPS, to be able to participate with sensors that provide higher location resolution. The shape of the error may provide an indication of the possible locations of icon-referenced objects/individuals.

Graphical Representation of Objects

In some embodiments, each object may modify its own graphical representation (e.g., icon) as it may appear on user displays and may personalize the graphical representation with photographs, drawings, company logos or other media.

Object Gender and Type

In some embodiments, the user display may show a gender associated with a device by, for example, a background color or a graphic linked to a device's icon on the display. For example, blue may denote the male gender, pink may denote the female gender, and gray may denote that no gender is selected.

Object Group Attachments

In some embodiments, the display may show attachments to other social groups. Attachments may be displayed as a small graphic attached to the main object icon. As shown in the exemplary embodiment of FIG. 28, “Thomas” (1400) and “Christpr” (1410) both indicate an attachment to the Friendster® social networking group (1415). In some embodiments, attachments may be displayed using a relevant icon such as, for example, the Friendster® graphical icon (e.g., [symbol] ).

Mobile Device Orientation

FIG. 29 illustrates an exemplary user display of a mobile device where the display shows relative positions of nearby objects in accordance with the present invention. In some embodiments, the display of the device may be rotated according to the direction indicated by a magnetic sensor in order to match the display with the user's physical view relative to the device's position. In the exemplary embodiment of FIG. 29, a room is shown with two objects (1450, 1455) and a user device (65), where each object is illustrated on the display of the device according to its approximate relative position to the device. For example, a “chair” (1460) may provide a reference point (e.g., “anchor”) for showing the effects of rotation of the device on the display. The device's location may be represented on the display by a centered circle (1465) on the device's display. Objects may be shown around the centered circle (1465), indicating their relative position. In the user display, Object 1 (1470) is positioned in a northwest direction relative to the user (1465) and Object 2 (1475) is positioned in an east direction relative to the user.

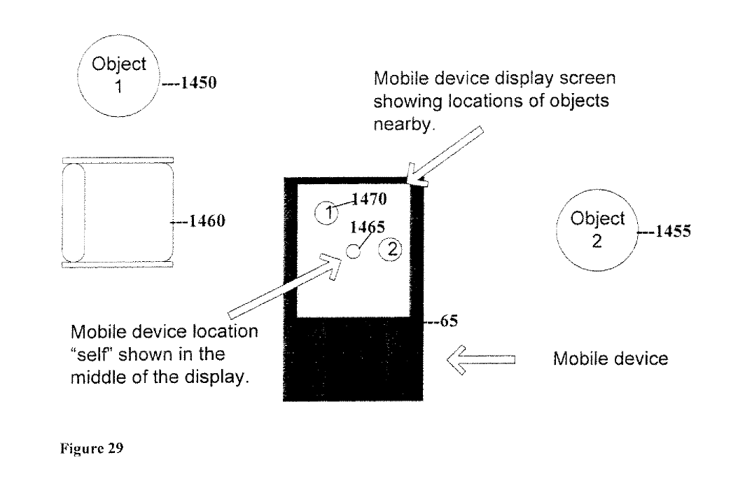

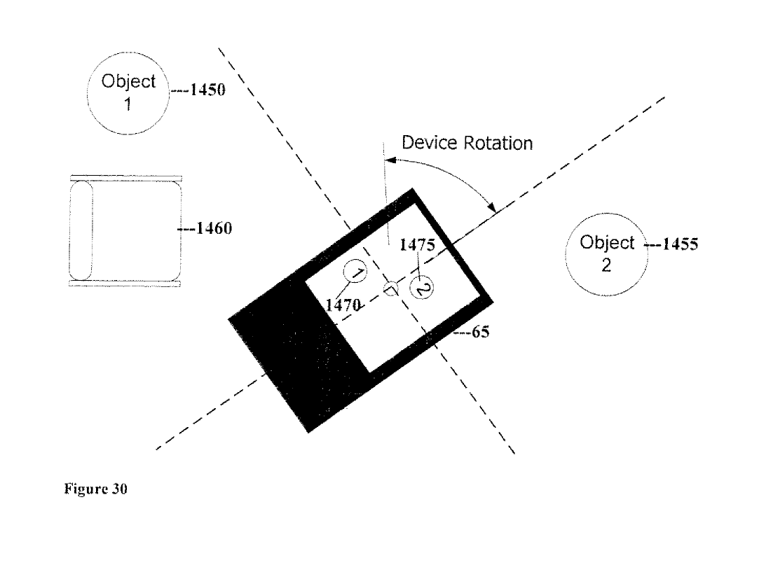

FIG. 30 illustrates an exemplary user display of a mobile device where the display shows a new orientation of relative positions of nearby objects post-rotation in accordance with the present invention. In the exemplary embodiment of FIG. 30, the mobile device 65 is rotated and changes orientation. The device's 65 sensors gather data based on the rotation and provide the data to the positioning engine (e.g., “PixieEngine”) such that the user display may be updated based on the rotation. The position computation may be performed with respect to the “North” direction and may be returned by the magnetic sensor compass, which in the exemplary embodiment is assumed to not be the orientation of device. The rotation equation may be presented as follows. Assuming the device's initial orientation creates an angle “alpha” with the “North” direction, the positioning algorithm may find and return polar coordinates such that:
the range=R, and azimuth=theta;
   the displayed polar coordinates of the device should be:
range=R, azimuth=theta−alpha.

In some embodiments, displaying these coordinates may match the relative position of the device in the physical world. The user display may then be oriented correctly and objects may be shown at the correct relative orientation and position from the user's device. FIG. 30 illustrates the device's rotation and the new locations of the objects in the device's display. The display may mimic the position of the objects in the physical world.

Profile Display

1. Personal Information Profile

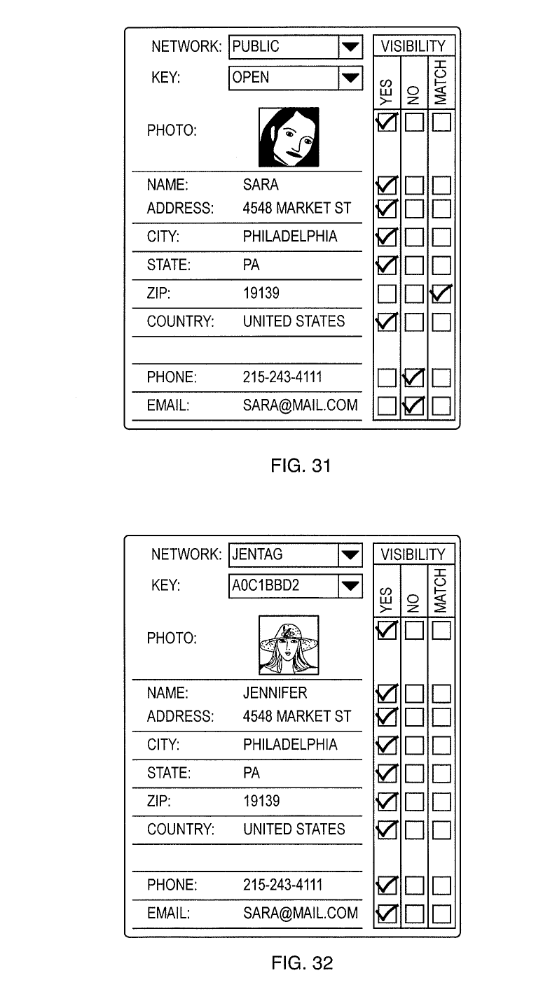

FIG. 31 illustrates an exemplary user display of a mobile device where the display shows a personal information profile and privacy settings in accordance with the present invention. In the exemplary embodiment of FIG. 31, the user display contains user information that may be input manually or aggregated from existing social networks. The user may specify security access levels for the information. In some embodiments, devices may share information between each other in accordance with the access level of the profile.

2. Tag Information Profile

FIG. 32 illustrates an exemplary user display of a mobile device where the display shows a tagged object information profile and privacy settings in accordance with the present invention. An information tag may function like the disclosed positioning engine 55 (e.g., “PixieEngine”) but may not be associated with a display; an information tag may contain object information. In some embodiments, an information tag may be programmed with information related to a child, a pet, or other information. In some embodiments, an information tag may be used as a tracking or identification device. Further, an information tag may have security access levels that may be configured such that information and positional privacy is assured.

Relationships

1. Object Relationships

FIG. 28 illustrates an exemplary view of relationships and a range display within an area of interest (“AOI”) of a device in accordance with the present invention. In some embodiments, the positioning engine may determine relationships between local objects and virtual objects. Local objects may be those objects/devices/nodes that are within the range of the user device with the positioning engine (e.g., “PixieEngine”). Virtual or remote objects may be those objects/device/nodes that are not within the range of the user device with the positioning engine (e.g., “PixieEngine”), but may be accessible through a static positioning engine that is connected to a communications network such as, for example, a WAN (e.g., the Internet) or a LAN. A client application on the user display may show relationships between objects via graphical representation. In some embodiments, the relationships may be shown when objects are not physically present or within the range of the user device (i.e., objects are remote to the user). For example, in FIG. 28, a relationship from the user device to “Jessica” 1420 is shown via a line although “Jessica” 1420 is not physically present or within the range of the user device. The exemplary relationships illustrated in FIG. 28 may the result of the positioning engine creating relationships and associations between objects and the user, where the relationships may be stored in memory or a database. In some embodiments, the relationships may be shown through different graphical representations such as, for example, a line connecting two objects with a common relationship. In some embodiments, relationships may be shown between objects that may be using different location technologies such as, for example, object using the positioning engine for relative location, objects using GPS, or objects using range technologies.

2. Social Relationships

Some embodiments of the invention may allow for any relationship to be visualized in the user display. The relationships may include, for example, the following types:
Friends
Friends of Friends
Business relationships
Similar interest
Common backgrounds, schools or cities

In the exemplary embodiment of FIG. 28, although “Jessica” 1420 may not be local to the user device 1331, the icon associated with “Jessica” 1420 may be automatically placed in its location because “Thomas” 1400 is in the AOI of the user device and both “Thomas” 1400 and the user are common friends with “Jessica” 1420. The relationship between “Thomas” 1400 and “Jessica” 1420 may be shown using a line 1425 indicating that “Thomas” 1400 is a friend of a friend (FoF) to “Jessica” 1420. In addition, “Thomas” 1400 may also be a business acquaintance (BA) of the user and a line 1430 with the indication “BA” may be drawn showing the relationship 1430 between the user device 1331 and “Thomas” 1400.

In the exemplary embodiment of FIG. 28, the relationship 1440 between “Danielle” 1435 and the user 1331 indicates that “Danielle” 1435 is not in the end user database as a friend or acquaintance, but that “Danielle” 1435 has been within the AOI at another time; such information may stored be in a temporal calendar (TC). The color of the line indicating the relationship 1440 may represent how often “Danielle” 1435 has been within the user's AOI at another time. In some embodiments, a line colored as “red” may indicate that “Danielle” 1435 has been in the user's AOI many times. Such an indication may inform the user of the device of how often the user has been near “Danielle” 1435.

3. Match-Making Relationships

FIG. 28 illustrates a relationship between the user 1331 and other people within the AOI based on a database intended for matchmaking. In the exemplary embodiment, based on “Melissa's” profile, matching green bars may be shown on the user display on the top of “Melissa's” picture icon. Match bars may be used to indicate a match percentage between the user's 1331 profile and others within the SOI. Profiles of others may be categorized into criteria segments such as, for example, basics (e.g., gender, age, height, weight, address, etc), personal interests (e.g., music, TV shows, sports, cooking, etc), and professional profile (e.g., education, occupation, company, position, etc). Matching bars may be illustrated based on the match percentage that may be computed according to the information in each of these segments in comparison to the user's similar criteria segments.

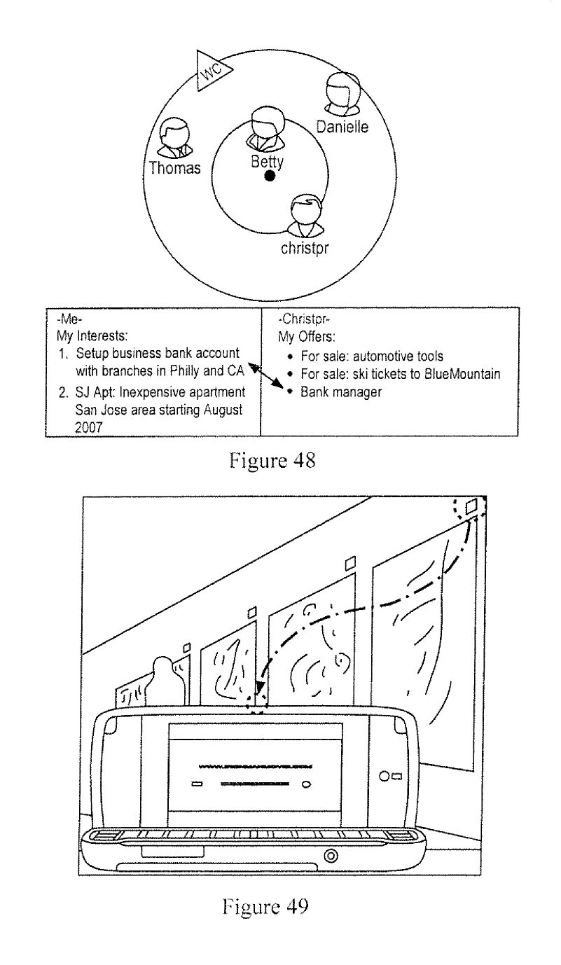

FIG. 48 illustrates an exemplary user display of a mobile device implementing match-making and sale/trade relationships within an area of interest (“AOI”) in accordance with the present invention. In the exemplary embodiment, match-making relationships may be displayed according to the user's interest in setting up a business bank account with branches in Philly and CA, which may be stored in a database and then associated with the profile of Christpr, who may be, for example, a bank manager. In some embodiments a line may be drawn on the user display and labeled as “bank” in order to indicate to the user of the device that a match may exist for the user's interest, as illustrated in FIG. 48.

4. Sale/Trade Relationships

In some embodiments, relationships may be used to identify or engage in a sale, a purchase, a bid, or barter on a localized basis. For example, in the exemplary embodiment of FIG. 28, matching links between the user, “Christpr” 1410, and “Danielle” 1435, may be created when the user device determines that either “Christpr” 1410 or “Danielle” 1435 provide a service, information, or item that matches that user's designated demand or supply. Through this feature, the user 1331 may identify his/her demand or supply (e.g., products/services) using his/her profile (not shown). In some embodiments, the user device (e.g., an application) may search and identify such potential relationships when the user's demand or supply matches at least of one those of another user within the AOI. In some embodiments, potential relationships may be shown on the user display via a link between the user and the potential match. FIG. 48 illustrates an exemplary embodiment where a user's interests are matched with offers or supply resources of another. In some embodiments, to minimize potential seller abuse of this feature, access to the user's supply or demand list may not be permitted by default. In other words, potential sellers may not be able to pre-qualify the user (e.g., potential buyer) by accessing his/her demand or supply list before the user provides access to the potential seller.

5. Relationship Strength

In some embodiments, the client application may show the strength of the relationship between the user of the user device and one or more other users; the strength of the relationship may correlate to the match level of the relationship. The relationship strength may be shown as a function of a given parameter such as, for example, the number of common friends as shown above in Table 3.

Information Linking and Routing

In some embodiments, information attributes or links may be attached to acquired positions of objects, locations or individuals within the AOI or present remotely, which may enable searching, filtering and interacting with objects, locations or individuals. As a gateway, bridging positioning and information access, exemplary embodiments may present operations that serve to enhance communication, social interaction, information access, commercialization, and object tracking and identification.

Object Behavior

1. General Object (Device) Behaviors and Interactions

In some embodiments, object (device) behavior may be generalized to those devices that may receive or send data to other objects. Objects may receive data from other objects or send data to other objects at the sender's request. For example, a data file may be dropped into an object, where the data file may contain, for example, music, a video, or a document. The receiving device may then execute its programmed behavior for that data file (e.g., playing the music/video or opening the document). By selecting an object, the requesting object may obtain the data sources the object has to send. This may be a personal profile for an object representing an individual, an image file for an object representing a camera, or a document for an object representing a poster in the wall. These concepts provide the ability to submit data or attach data to a given object.

2. Activating Object Behaviors

In some embodiments, a user may request an object to perform specific behaviors as defined by the object category of behaviors, as well as behaviors that may be added or downloaded to the object. By selecting an object or group of objects the user may be provided a list of available actions or behaviors that may be performed. The user may then select a specific behavior and submit it to the selected object or objects. By default, a given set of behaviors may be available for each object, and new behaviors may be downloaded to the object if access permissions allow the object to accept new behaviors.

3. Device Object Visual Behaviors

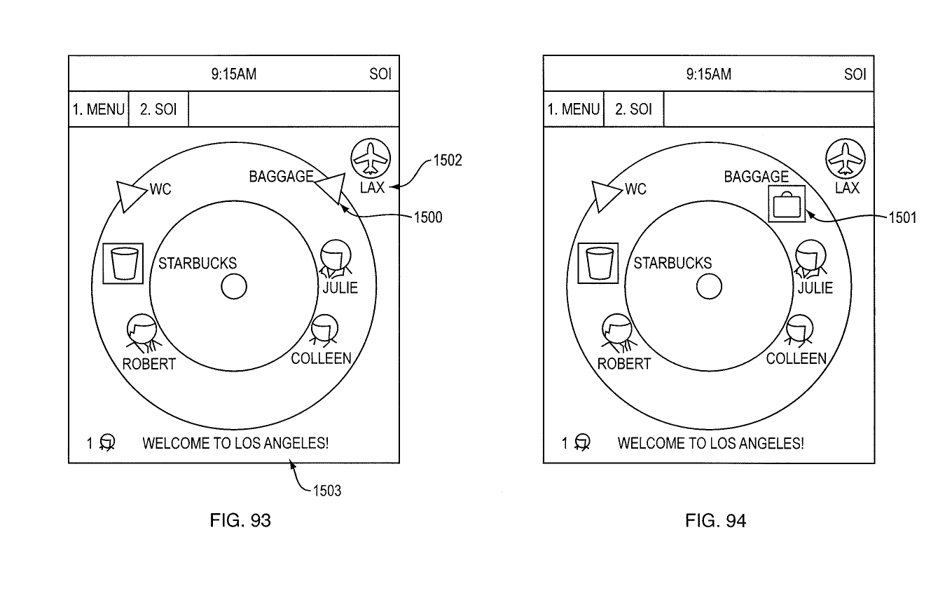

FIG. 93 illustrates an exemplary embodiment of a user interface of a device where the interface includes a directional indicator of a distant baggage claim and an area advertisement/announcement in accordance with the present invention. In some embodiments, the objects' visual appearance may be modified based on specific object behaviors as viewed on the user display. An object may change appearance based on how it relates to the viewing object. For example, as illustrated in FIG. 93, when an object is too far from the viewing area, an object may change its appearance to a directional indicator 1500. As the object nears the viewing object and enters the range of view, the object may change to a different graphical representation (1501) as shown in FIG. 94. FIG. 94 illustrates an exemplary embodiment of a user interface of a device where the interface includes a closer display of a directional indicator in accordance with the present invention.

Social Interaction

In some embodiments, the user device may implement a feature for linking socially-related information to objects displayed as icons on the user display, where the objects represent individuals or objects of social interest according to some embodiments.

1. User interface

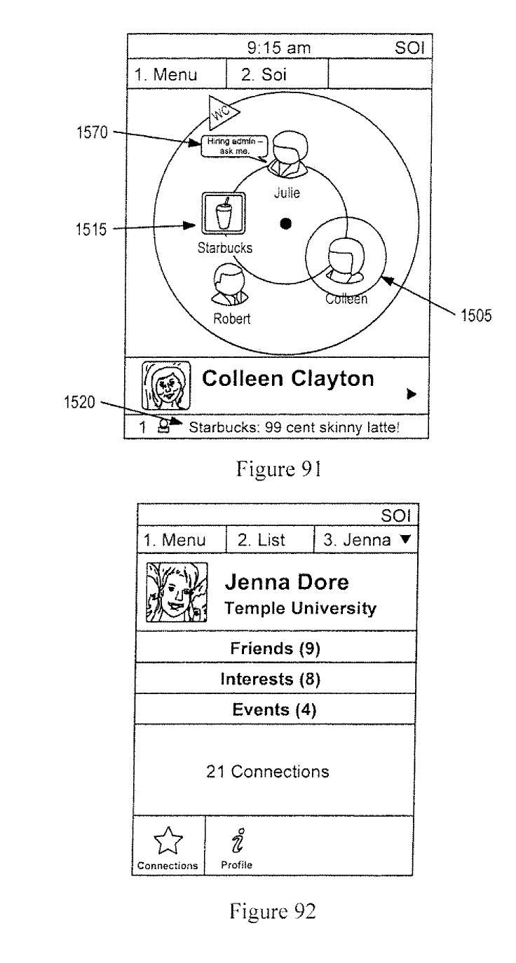

In some embodiments, the SOI display and profile information, as discussed above with reference to FIGS. 27-29, may be initialized by the user activating a specific icon enabled by said information linking operations. FIG. 91 illustrates an exemplary embodiment of a user interface of a device where the interface includes a scenario for activating an icon that leads to: a highlighted profile display, a personal note attached to a user icon, and a Starbucks advertisement announcement in accordance with the present invention. In the exemplary embodiment, the user may activate an icon named “Jenna Dore” (1505), leading to a highlighted profile display of an icon, which is illustrated in FIG. 92. FIG. 92 illustrates an exemplary embodiment of a user interface of a device where the interface includes a highlighted profile display in accordance with the present invention. The profile, for the embodiment shown in FIG. 92, may include the name with a description of “Jenna Dore” (1505). Moreover, there may be a list of relationship information such as the number of friends in common, the number and interests in common, and the number of events in common.

2. Connectivity to Profile Information

In some embodiments, social profiles may be self-generated and integrated, aggregated, or synchronized from end users' social networks. The data may be downloaded and synchronized to the mobile device periodically, becoming the local internal profile and local social profile. Key profile information may be kept locally for sharing, matching and visualization purposes, and the full social profile details (e.g., original data fields) may not be unless internet service is available. In some embodiments, the accessibility of items in the profile abides by each user's privacy policy and the general hierarchy protocol.

3. Social Object Behaviors

In some embodiments, there may be numerous social object behaviors that can be selected on any given object such as, for example: messages, hugs, nudges, or passing other virtual items that may allow users to interact socially with each other. For example, a message may ask the question: “interested in coffee?” The message may be sent to a selected object. Social Object Behaviors may be sent in real time or at a later time through a temporal calendar feature (discussed herein).

Information Service

1. Navigation

In some embodiments, a static positioning engine 55 (e.g. “Spotcast”) may provide information to assist end users with their desired navigation operations (e.g., non-commercial related objectives). For example, such operation may include navigating inside a shopping mall, an airport, or an amusement park, discussed above with relation to the directional Spotcast.

2. Public Object Announcement

In some embodiments, as illustrated in FIG. 91, a personal note of “Katie” may be attached to her associated icon (1510), serving as a way to broadcast information to local users. Such a capability may be utilized for any object in the environment to provide a publicly viewable announcement.

3. Area Advertisement Announcement

In some embodiments, an object may provide a public announcement for informing other objects within its area. For example, applications may be implemented for information-intensive service providers, such as airports, train/bus stations, and stock exchanges. The contents of the announcements may be, respectively, related to flight changes/delays/arrivals, transportation schedules, and stock quotes. As illustrated in FIG. 93, an area advertisement (1503) may also be represented by a graphic (1502) on the top corner of the user display to provide information on the area surrounding the user's location. Although the object may not have a specific location, the object may provide information with the same capability as other objects with a specific location. These objects may be commercial or owned by a facility for which the information is being displayed. The object's information announcement may be given to the user, as shown in FIG. 93. Advertisements may be general or targeted specifically at users based on whether the user is publicly available or opts for receiving information.

4. Object Commercial Announcement

In some embodiments, objects may broadcast information provided and controlled by a service provider or commercial entity that desires to reach potential customers. The broadcast information may usually include events, information, advertising, and purchasing offered by the service provider or commercial entity. As illustrated in FIG. 91, the commercial object identified as Starbucks® (1515) has broadcast an advertisement announcement in the announcement display section (1520). Announcement area information may show information of general interest to the user as well as commercial advertisements as defined by commercial relationships with said companies. Advertisement announcements may be general in nature or may target specific users based on whether the user is publicly available or opts for receiving information.

Based on service types and interactivity, announcement may be categorized into the following:

A. Events, information, and advertising

Examples of announcements related to events, information, and advertising may include streaming movie previews/advertisements, visual restaurant menus, retail coupons/offers, product advertising, etc. In some embodiments, a static positioning engine 55 (e.g., “Spotcast”) may be attached to a movie poster inside a movie theater and may provide a user device within range with streaming media related to the movie advertised on the movie poster.

B. Purchasing, Bidding, Bartering

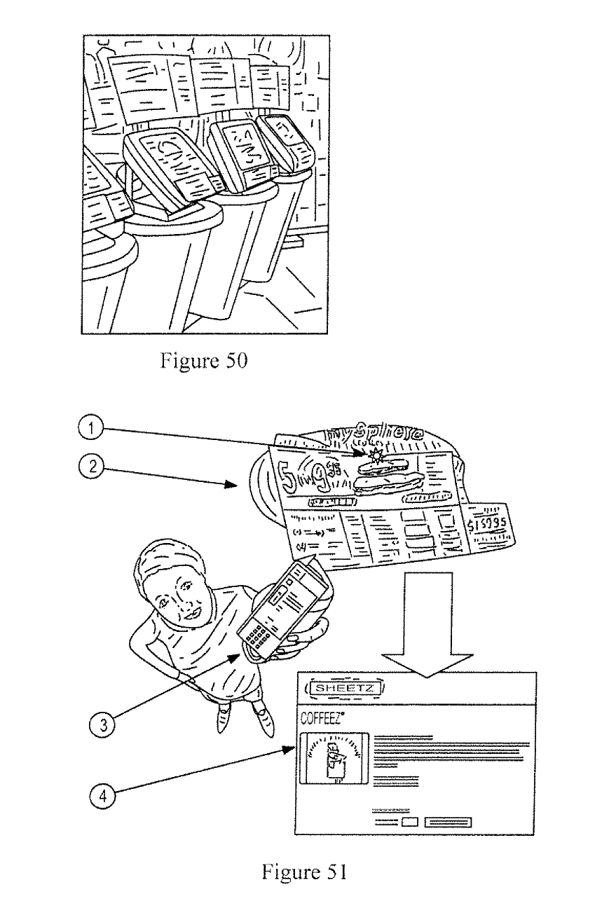

FIG. 51 illustrates an exemplary embodiment of using a static positioning engine (e.g., a “Spotcast”) to perform interactive purchasing in accordance with the present invention. In some embodiments, object linking may provide an interactive approach for purchasing, bidding, or bartering of items. FIG. 51 illustrates an example of such an application. For example, a traditional kiosk solution, as shown in FIG. 50, may be built with a specialized hardware platform as used in retail stores. A kiosk may present a hardware expense and may possess a large retail real estate presence. Further, ongoing maintenance and upgrading of kiosks may present major difficulties to most retailers. In some embodiments, a solution to the foregoing problems in the current state of the art may be to utilize a positioning engine (e.g., “PixiEngine”) on a user device, which may not require a significant real estate presence and minimal maintenance. For example, as shown in FIG. 51, a positioning engine, such as a PixieEngine (ID 1) can be integrated into a kiosk or other device that may allow a user an interface to interact with, such as a store menu (ID 2). The PixieEngine may provide the menu information (ID 4) to the user (ID 3) for illustration on the user display. The user may interact with the menu to the extent allowed by the permissions that may be set by owner of the menu object; interaction may include browsing the menu and purchasing from the menu.

C. Targeted Information and Advertising Delivery

In some embodiments, the positioning engine (e.g., “PixieEngine”) may be integrated within a user device and allow the user to interact with objects within his/her area. In some embodiments, the positioning engine may be embedded within information displays that may recognize other objects in their area and allow for display interactivity based on nearby objects. FIG. 49 illustrates an exemplary static positioning engine (e.g., a “Spotcast”) attached to a movie poster inside a movie theater and providing streaming service (e.g., movie advertisement) to a mobile handset in accordance with the present invention. The streaming service may be initiated when the user device is detected by the static position engine as being within proximity.

In some embodiments, the positioning engine of the user device may acquire unique objects that are visible in its area based on security settings. This information may be further analyzed to provide the motion of objects as it relates to each other. The positioning engine of the user device may ascertain the direction of movement of other objects such as when an object is moving towards, away, or just passing in front. Additionally, objects may be able to share information with each other that may be used to target information that is of interest to said object. An example of a commercial application may be a person with a positioning engine (e.g., “PixieEngine”) walking in front of an active displayed advertisement. Through a positioning engine coupled to or near the static positioning engine attached to a display (e.g., movie poster), the vector of movement may be determined and analyzed (e.g., user of user device is walking in front of the advertisement rather than towards it). For example, when the user of the user device is turned towards the static positioning engine attached to the display, information regarding the user may be shared (e.g., location of residence). As the user faces towards the display, the information presented to the user of the user device may be targeted accordingly based on the user's vector of movement and available information (e.g., location of residence, interests, other shared information).

Resource Sharing

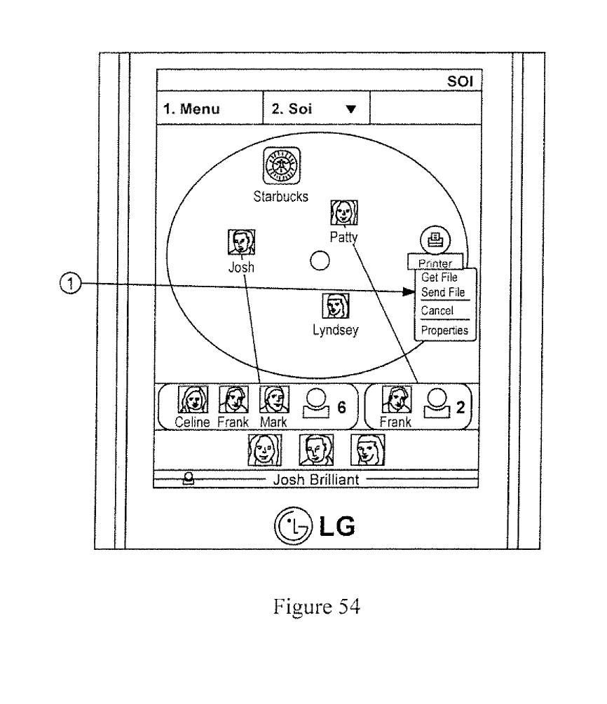

In some embodiments, static positioning engines (e.g., “Spotcasts”) may be attached to objects and provide resource sharing to other objects. Example of device objects may include objects that provide a resource such as, for example, printing, projection, a media player, or other resource. FIG. 54 illustrates an exemplary user display of a mobile device showing local resources that may be utilized within an area of interest (“AOI”) in accordance with the present invention. As illustrated in FIG. 54, a printer resource may be available within the AOI of the user of the device and the other objects displayed on the screen of the device. Resource sharing services may allow objects to share commonly used facilities such as, for example, printers, overhead projectors, imaging devices, etc. configured with a static positioning engine (e.g., “Spotcast”). In some embodiments, there may be interaction based on the services each object provides. Services may include, for example, activating and controlling devices as resources (discussed above). For example, a user may submit files to these devices to receive corresponding printing and displaying services. Objects may support a range of general services on whatever data type they support. Examples of these data types may include:
Office Documents;
PDF;
Video media;
Audio media; and
Remotely controlling a Device (e.g., start, pause, forward, or reverse).

Local and Wide Area Network

In some embodiments, a positioning engine (e.g., a “PixieEngine”) may operate via local or wide area networks. Information may reside locally at each object, or each object may access information via wide area networks. For example, a wide area network may be accessed via Wi-Fi, a mobile device service provider, or other communication technology that operates independently of the positioning engine. Objects with an integrated static positioning engine may request access to information locally or via an accessible wide area network. Different methods of communications using a static positioning engine (e.g., “Spotcast”) are shown in FIGS. 2-7; these external networks may link to services by content/data providers such as, for example, localized information, maps, directions, purchasing processes, item information, and nearby individuals, that may not be available locally. A static positioning engine may initiate a wide area network request within the object requesting the data. For example, FIG. 55 illustrates a static positioning engine that does not inherently have access to any wide area network (ID 1). The user may interact with the static positioning engine, which may provide the requested information (ID 2) in the form of web page. The user may interact with the web page locally on the user device, which may in turn create a request to access the Internet (e.g., via the static positioning engine). The user device (ID 3) may then, for example, access a wide area network of a mobile service provider and the Internet (ID 5); through the web page, the user may be able to request an appointment as shown (ID 6).

Privacy

All information linking and routing operations are executed under security protocol discussed as discussed above with regard to embedded solutions. In some embodiments, each object can set up its own privacy policy, under which security of information is correspondingly protected. As illustrated in FIG. 32, for example, in “Sara's” social profile, the visibility of her photo, name, address, city, state and country may be open to the public; her phone and email may be disabled from external visualization; and, her zip code may be subject to a “matching” protocol. These visibility options may be additionally customized to adapt to different networks, of which only selected groups may achieve accessibility. Objects may support public access or key encryption. Further, public access may allow objects to openly communicate and become visible to each other. To provide privacy, objects may be encrypted so that only users with a public key can decode the data or the location of the device. This may allow users to create separate channels of information that may be accessible by those with the correct key. FIG. 32 illustrates as an example of an object utilizing a “PixieEngine” tag (e.g., Jennifer's information may be viewable only by people within the network called “JenTag”; the commonly shared key for access, for example, may be “A0C1BBD2”).

Information Overlay

Some embodiments of the invention relate to input, information overlay and a visualization architecture that overlays information within an area that is further provided within the user display. This method may enable the placement of information in or around a location of an object. Information may be any data set that is acceptable and viewable by any object in the area. The location of the information in the physical area may be placed via manual input or through programmatic reference to an existing object.

Information Sources and User Input Methods

Information which sources may include any type that may be graphically displayed or which a graphical representation may be created. Examples are text, vector graphics, bitmap graphics, video, self-contained applications that can represent a visible graphic representation of themselves, or non-graphical data such as audio that can represent itself via a graphical reference. Location information may be created as a reference to an object in the area. This location may be programmatically identified, for example, by indications such as 5 meters, 45 degrees from a particular object or by an object moving to the location for which the reference position is to be made.

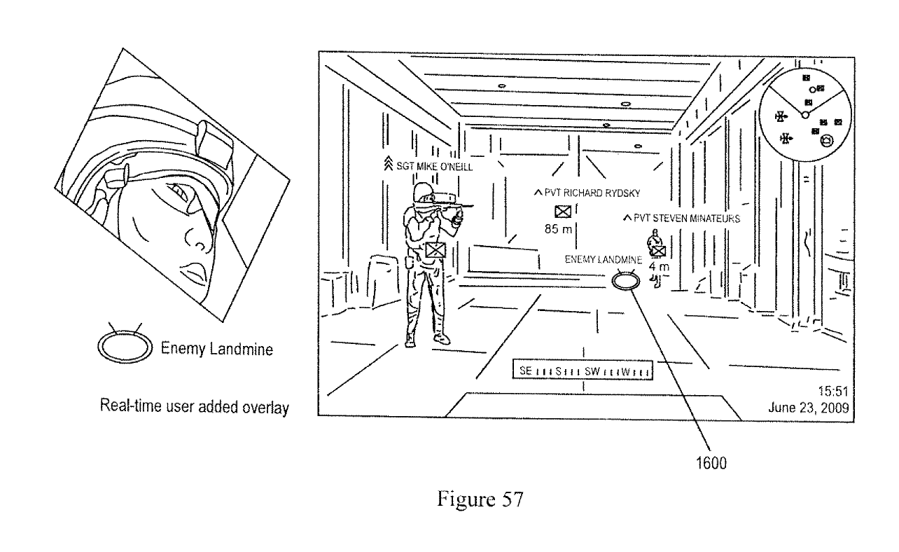

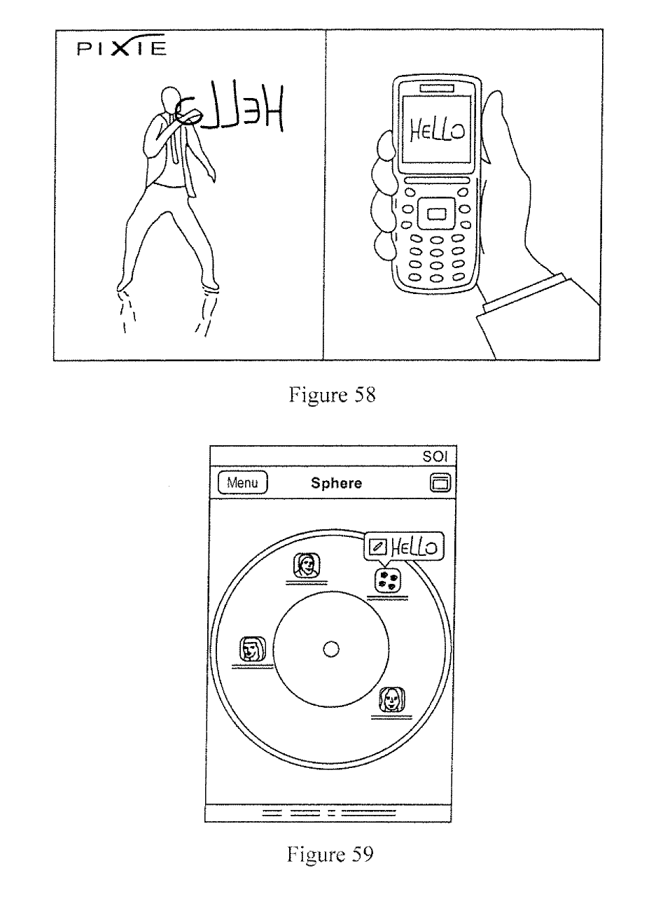

FIG. 57 illustrates an exemplary embodiment of a headset display of a user-generated icon overlaying an existing display in accordance with the present invention. FIG. 58 illustrates an exemplary embodiment of a user gesturing “Hello” in the air and viewing a visualization on-screen in accordance with the present invention. FIG. 57 and FIG. 58 show two different examples of input methods. For example, as shown in the military urban warfare scenario in FIG. 57, an icon 1600 is chosen from selections to indicate existence of enemy landmine. In FIG. 58, for example, the end user gestures “Hello” in the air to input the recorded message.

Existing Information Source

The information selected is one from an existing source such as text, vector graphics, bitmap graphics, video, self-contain applications which can represent a visible graphic representation of themselves or non-graphical data such as audio which can represent itself via a graphical reference. The given data set may be selected for placement at a specified location.

1. Historical Trail

In some embodiments, an object location relative to another object may be recorded, leaving a historical path of positions.

2. Gesture Input

In some embodiments, movements may be captured into gesture trails through the use of motion sensors detecting a series of device movements. The gestures may be converted into a vector that may be displayed at a given location.

3. Information Repeaters

In some embodiments, due to the nature of the limited communication ranges through wireless channels (e.g., 2.4 GHz frequency), a positioning system may be susceptible to signal reflections and full obscurity by objects within or around the building. This may create possible areas in which the signal may not reach a given area at all or the signal may be evaluated incorrectly, giving an incorrect location of objects or overlaid information. FIG. 74 illustrates an exemplary embodiment of objects obscuring the view of an installed static positioning engine (e.g., a “Spotcast”) in accordance with the present invention. In the exemplary embodiment, a positioning engine, such as a “Spotcast” (1650) may be installed within a building (1650.) The building may have objects that provide full obscurity to the signal (1655, 1660). The area of obscurity is shown by dark areas (1670, 1675).

Some embodiments may be designed under a cooperative network topology and additional objects in a given area may improve area coverage, although the objects in the area may have no access to each other's information due to security settings. In some embodiments, an area may not have additional objects, in which case repeaters need to be installed to cover the full area.

FIG. 75 illustrates an exemplary embodiment of objects obscuring two installed static positioning engines (e.g., a “Spotcast”) in accordance with the present invention. FIG. 75 illustrates the cooperation between two static positioning engines (1650, 1651). As shown in FIG. 74, the static positioning engine on the right (1650) may be susceptible to an area (1655) of large obscurity, which may be covered by the static positioning engine on the left (1651). According to this configuration, both static positioning engines may cooperate to provide full coverage to the area.

FIG. 56 illustrates both the object-managed local/remote information and mobile device managed local/remote information according to some embodiments. The mobile devices in FIG. 56 operate as a peer-to-peer local network to transmit position information and other information from one device to another. Moreover, as shown in FIG. 56, one mobile device may access content and service via another mobile device connected to a network.

Display Information

After information is selected or created, the information may be shared with other objects in the area that may then overlay the information within their device display and visualization architecture, according to some embodiments.

1. Display Effects

In some embodiments, information may be visualized by the user display with static or dynamic effects controlled by end users.

2. Accessibility

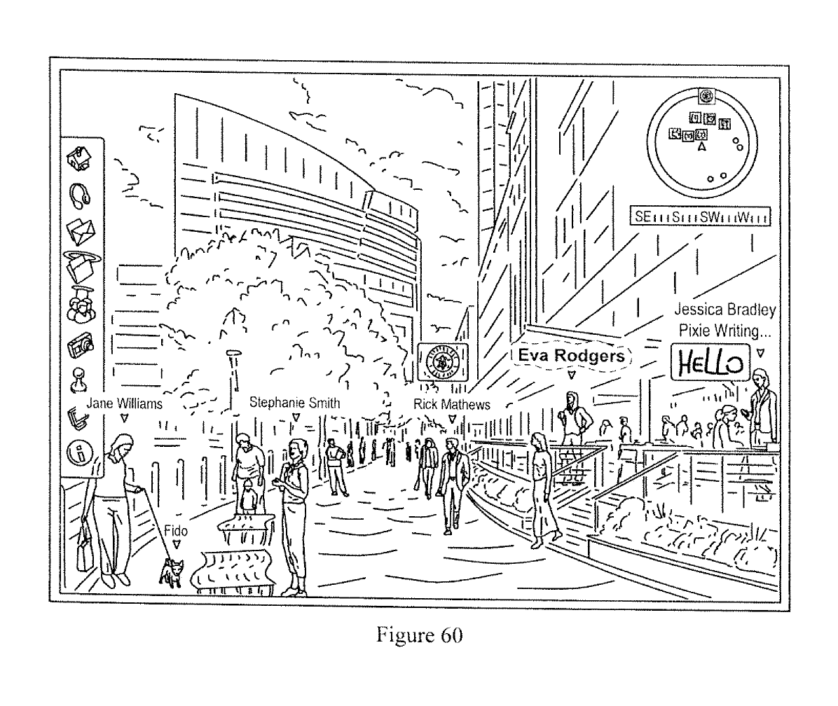

In some embodiments, end users may have the ability to create information for viewing by a selected group or individual. FIG. 59 illustrates an exemplary embodiment of a user display of a device showing a “Hello” gesture in accordance with the present invention. FIG. 60 illustrates an exemplary embodiment of a headset display with an attached “Hello” gesture in accordance with the present invention. For example, a positioning engine may be equipped with a feature for generating gesture icons, but visualization of these icons may not be limited to said version, such as illustrated in FIGS. 59 and 60. In addition, end users may control the termination of the display, including time and fading effects.

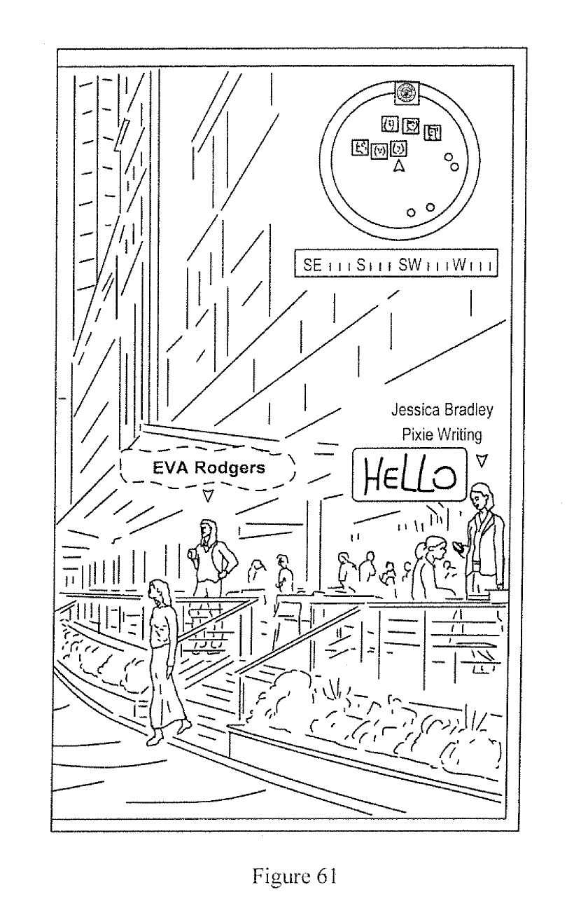

FIG. 61 illustrates an exemplary embodiment of a highlighted view of a gestured “Hello” overlaying an existing display in accordance with the present invention.

3. Information Position Options

In some embodiments, information may be localized relative to existing objects in the area and may have one of the following attributes: static, relative, or programmed. Relative attributes may refer to location information associated with a fixed reference location from a given object. Static attributes may refer to location information associated with a static location. Programmed attributes may allow the location to be changed. In some embodiments, a static attribute may be used when information is to be placed at a fixed location, independent of the position of the object that may have set the static attribute or that may have been used as a reference. For objects that are mobile in nature this method may allow for the information to be fixed at the static location even if the mobile object moves. For a mobile object, a relative attribute in information would allow the information to move at a given relative position of the object as the object moves. This allows the information to follow the movement of the object. A programmed attribute may allow the location of the information to change dynamically based on some external positioning algorithm. In the exemplary embodiment of FIG. 57, the icon representing an enemy landmine 1600 is attached to a certain location as displayed. In the exemplary embodiment of FIGS. 59-61, an attached gestured “Hello” may be shown in the vicinity of the gesturer.

Information Behavior

In some embodiments, information may be placed within the area and attached to behaviors. The behaviors may be used to trigger events based on particular situations. For example, information may be placed at a given location that generates an event whenever other objects come within a given range of that location. Information may be represented as a line vector in space or a geometric shape that may indicate areas that would similarly create events based on the locations of objects within the geometric shapes. For example, an event may be generated when information contains a geometric line of which another object may cross. Information behaviors may be attached by any object that can visibly see the information. Behaviors may be created by those objects that are not the original owners or creators of the information.

1. An Object Entering or Leaving the AOI Activation Event

FIG. 71 illustrates an exemplary embodiment of a user display of a device showing graphically the objects and events within an area of interest (“AOI”) while traversing in accordance with the present invention. In some embodiments, as the user traverses a path, objects may come into view within the AOI. These objects may be linked to actual physical objects or to other people. FIG. 71 illustrates a user walking from the initial point (1700) to the second point (1710). The SOI displayed is shown to the right, indicating the position of the user's object (1715) (e.g., “me”); the AOI has been filtered to cover a 5 meter area (1720). This allows events that come into view within the 5 meter area to be processed as within the SOI. An object (1725) within Starbucks® has been hyperlinked as shown. In the initial position (1700), the Starbucks® object is farther than the 5 meter filter and no events are generated. In the second position (1710) the Starbuck's object comes into view of the SOI and an event may be generated. Event behaviors may be triggered when objects enter or leave the AOI.

2. A Path Activation Event

In some embodiments, Information overlay can include a path activation event which indicates the deviation from an object trajectory compared with the intended path. Event activation can trigger events based on the object trajectory deviation compared to the intended path. As the object deviation increases beyond the registered parameter events are created at a programmed periodic rate.

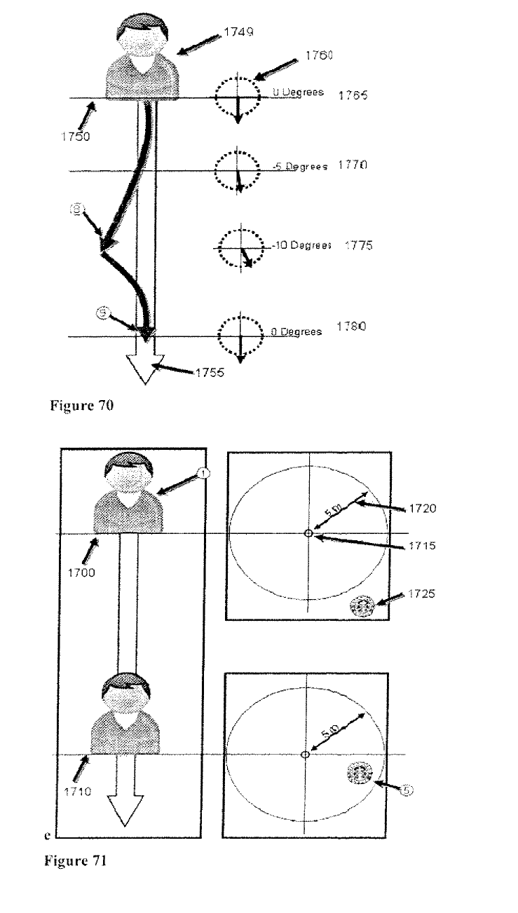

FIG. 70 illustrates an exemplary embodiment of a user display of a device showing graphically the deviation in degree from the current position to the intended path while traversing in accordance with the present invention. In the exemplary embodiment, a graphical display of an object (1749) traversing a given path (1755) is shown. The compass (1760) may indicate the deviation from the intended direction by the object (1749). The diagram shows the position of the object at four (4) different locations (1765, 1770, 1775, 1780). As the object (1749) moves forward to its first position (1770), the object deviates by 5 degrees from its intended path. In the next position (1775), the object deviates by 10 degrees from its intended path. The analysis of this information creates events indicating the trajectory error to the object (1749). The object can then implement a corrective signaling operation and present it to the user. The user may then have the ability to correct his/her position, as shown in the last position (1780).

3. Path Activation Event Behavior

In some embodiments, there may be a feature for emitting a periodic tone whose frequency or phase shift may be synchronized to the error of the heading direction. An exemplary application of this feature may be that shown in FIG. 70. Based on the object's behavior there may be emitted a tone (e.g., at 440 Hz) when the user traverses the path correctly. As the user error increases, the frequency of the tone may change. For example, for the object's second position (1770), the error of −5 degrees may trigger a tone of 420 Hz, and an error of −10 degrees may trigger a tone of 400 Hz. If the object's direction changes to a positive direction, then the tone may increase to 460 Hz for 5 degrees and 480 Hz for 10 degrees. A mapping of the corresponding error degree to frequency may vary based on various implementations. Some embodiments may provide feedback based on a deviation from a given path. In some embodiments, other events types may be triggered by other examples that may provide other approaches to providing sensory input.

4. Fence Overlay and Programmable Behavior

In some embodiments, there may be a feature implemented for creating fence areas via geometries, such as polygons and circles, which can link to specific behavior to indicate when an object is within an area that may be labeled as an allowed or excluded zone. The behavior that may be attached to the fence overlay may trigger local or remote events. Such a feature may allow complex shapes to represent areas in which objects are allowed or not allowed to be located.

An overlay (e.g., a fence overlay) may be a user-created virtual boundary (e.g., virtual fence) for use in such examples as pet containment (e.g., see “Containment” section below). In some embodiments, the creation of a fence boundary may require a handheld mobile node and a static reference node, which may record the fence boundary location and overlays in the environment. A fence overlay may be detected by other nodes in communication with the static reference node.

An excluded zone may be an area defined by a fence overlay and determined by the user to trigger a certain event(s) when a node, for example, is detected within the excluded zone.

A. Fence Overlay Relay

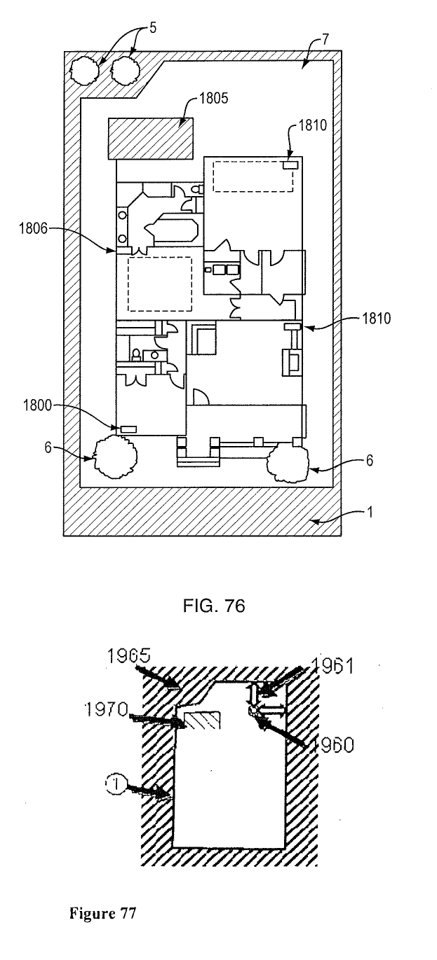

In some embodiments, the fence creating feature may copy a given overlay geometry to a nearby static positioning engine (e.g., “Spotcast”) to cover an area where wireless signal may not be reach another static positioning engine (e.g., a master “Spotcast”). FIG. 76 illustrates an exemplary embodiment of a display of a configuration of static positioning engines (1800) (e.g., a master “Spotcast”) in order to provide reliable coverage around a building in accordance with the present invention. For example, the master Spotcast (1800) may copies the overlay to Spotcasts nearby (1810) in order to provide reliable coverage around the building.

B. Zone Overlay Types

FIG. 78 illustrates an exemplary embodiment of a rectangular overlay encompassing a safe area inside in accordance with the present invention. In some embodiments, fence overlay geometry may create user-defined polygons or circles, which may contain an inside and an outside area that may trigger events. These areas may be assigned to specific behavior based on desired outcomes. For example, FIG. 78 shows a simple rectangle overlay with an allowed area inside marked as 1850.

FIG. 79 illustrates an exemplary embodiment of a circular overlay encompassing a safe area inside in accordance with the present invention. The example illustrates a circular version of an allowed area inside 1850. As long as the tracked object is within the safe area inside 1850, no events are created. When the tracked object moves or remains in the area marked by 1851, then a specific alarm event may be triggered. In this example, the containment area may be fixed against the position of a master Spotcast (as shown in FIG. 76) that may create an object containment area around a building.

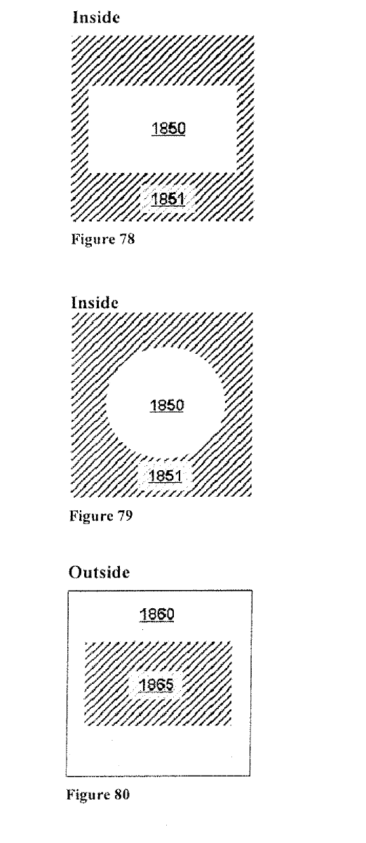

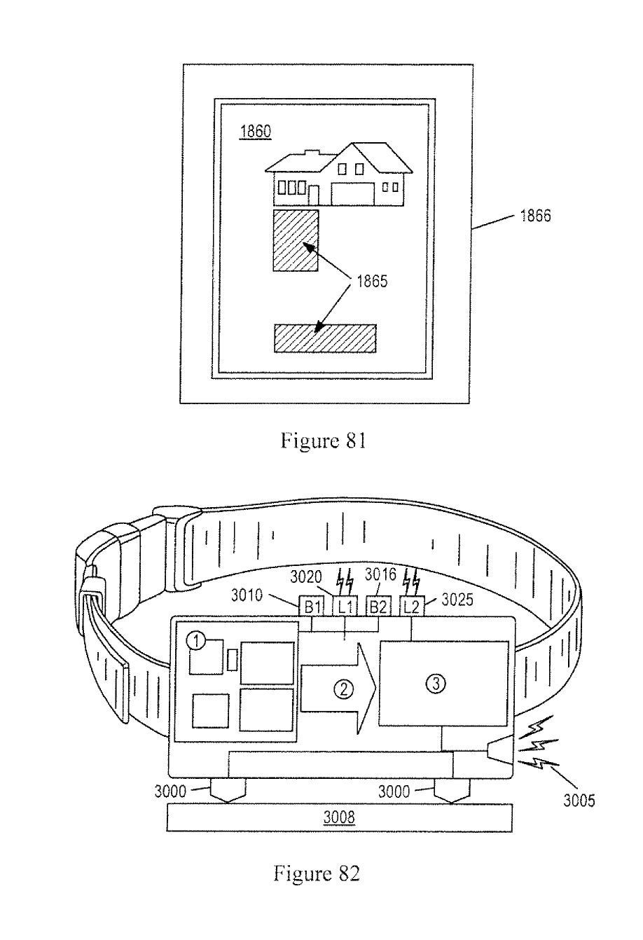

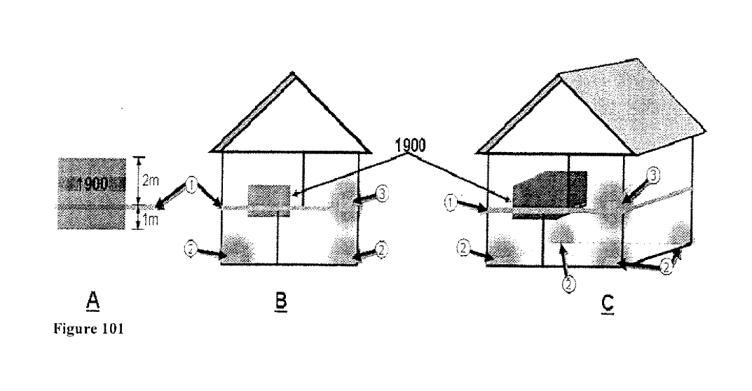

FIG. 81 illustrates an exemplary embodiment of a multi-zone environment with unsafe zones (e.g., “excluded”) within a safe zone (e.g., “allowed”) in accordance with the present invention. In this scenario, the outermost excluded zone is considered excluded Zone 1 (1860) because it relates to the final boundary area. Each excluded zone within the allowed area is marked as excluded Zone 2 (1865). A third type of excluded zone may involve the ability to integrate a height to the zone, as illustrated in FIG. 101. These may then become a volume of space that objected detection may establish. The third type of excluded zone may be defined using height acquisition (as discussed above) and 3D geometrical positioning based on movement. Excluded zones 1 or 2 may be attributed automatically to the same functioning height that the signal may reach (as illustrated in FIG. 100), while the third zone may be individually customized by user input subject to 3D configuration.

FIG. 101 illustrates an exemplary view of an indoor static positioning engine (e.g., a “Spotcast”) configuration for excluded zone 3 and its functional height in accordance with the present invention. In the exemplary embodiment, on the second floor, a plane above the initial four Spotcasts, an additional Spotcast may be placed to secure coverage of signaling susceptible to interior blockages. The Spotcast may automatically estimate its height or be programmed to store and broadcast its estimated height by the end user. The same mechanism may enable end users to further input a height range of distinguishable value, such as the estimated distances between two floors. A detected fence overlay geometry that has the same height range with preprogrammed Spotcasts may then be set up to function within this height range. As shown in section A, the Zone 3 (1900) height may be the height of the volume throughout its 2D geometry. In this example, the height may be configured to be a total of 3 meters. To make sure that the Zone may act properly in most applications, 1 meter of Zone 3 may start at the ground level of the second floor (1), so that 1 meter may be shifted to be under the floor, as shown in section A. This may be done to provide adequate coverage and account for imperfections when the user defines the Zone.

In the exemplary embodiment illustrated in FIG. 101, section B may show the house as viewed from the front, while section C may shows a perspective view of the house demonstrating the volume that Zone 3 (1900) occupies. In this example, on the second floor, one additional Spotcast (3) above the initial four Spotcasts (2) may be placed to secure coverage of signaling that may be susceptible to interior blockages. The additional Spotcast may automatically estimate its height via a 3D positioning algorithm using the first floor base Spotcast as a reference plane or be pre-programmed to store and broadcast its estimated height by the end user. Containment may also be triggered based on an object entering an excluded area surrounded by an allowed area. In the exemplary embodiment, the outside area may be considered allowed, and the specified area should not be entered by the object. For example, in FIG. 84, the swimming pool 1805 is an area within the yard area that should not be entered by an assigned object (e.g., a young lady).

C. Creating a Fence Overlay

In some embodiments, numerous methods may be available to create the fence overlay geometry. Fence geometry may be designed to be static on a given location, dynamic around a given object, or programmed according to a method that may dynamically update or change the geometry.

D. Activating Fence Overlay Behavior

In some embodiments, the distance from a fence to an assigned tracked object (1960) may be computed. A feature of the embodiment may enable event behavior associated with the object reaching the fence line or event behavior that relates to the fence geometry. The fence geometry overlay may include irregular areas (1965) as well as inner areas that are marked as excluded (1970).

E. Static Event Activation

In some embodiments, position and proximity of the track object (1960) from fence overlay geometry, as shown in FIG. 77, may have an associated behavior. The behavior triggered may be a simple alarm indicating that the object is inside or outside an allowed zone. In addition, the behavior may provide increased levels as an object approaches a fence overlay. This multi-level event may be associated with local or remote signaling.

F. Allowed Zone Behavioral Feedback Event Activation

In some embodiments, an alarm triggering zone may be programmed to utilize the track object behavioral feedback that may apply when the object is within a given zone. The events triggered may be based on a particular activity level or movement of the track object. Certain embodiments may be able to appropriately determine the movement type, velocity and proximity of the object to the fence and trigger the appropriate response.

G. Excluded Zone 1 Behavioral Feedback Event Activation

In some embodiments, an alarm triggering zone may need to meet unique objectives when the object is already inside the zone that represents the outer boundary (1866), as shown in FIG. 81. Specific object characteristics may be programmed to provide the desired results. In some embodiments, circumstances inside or outside the zones may also be programmed.

H. Excluded Zone 2 Behavioral Feedback Event Activation

In some embodiments, alarm triggering zone may need to meet unique objectives when the object is already inside an excluded zone located or surrounded by an allowed zone (1865), as shown in FIG. 80-81. Specific object characteristics may be programmed to provide the desired results. In some embodiments, circumstances inside or outside the excluded zones may also be programmed.

I. Fence Overlay Geometry Modifications

FIG. 90 illustrates an exemplary embodiment of the creation and editing of a fence overlay geometry with a device such as a computer in accordance with the present invention. In some embodiments, fence overlay geometry may be created or edited manually or programmatically. FIG. 90 provides an example of how to create or edit the fence overlay geometry with a device such as a computer (2000) or another user device connected to a static positioning engine (e.g., “Spotcast”) (2007), which may then access the memory area for the geometry information. The data may be created or edited via a software application (2005) that provides a visual representation of the geometry or programmatically.

Rating Service

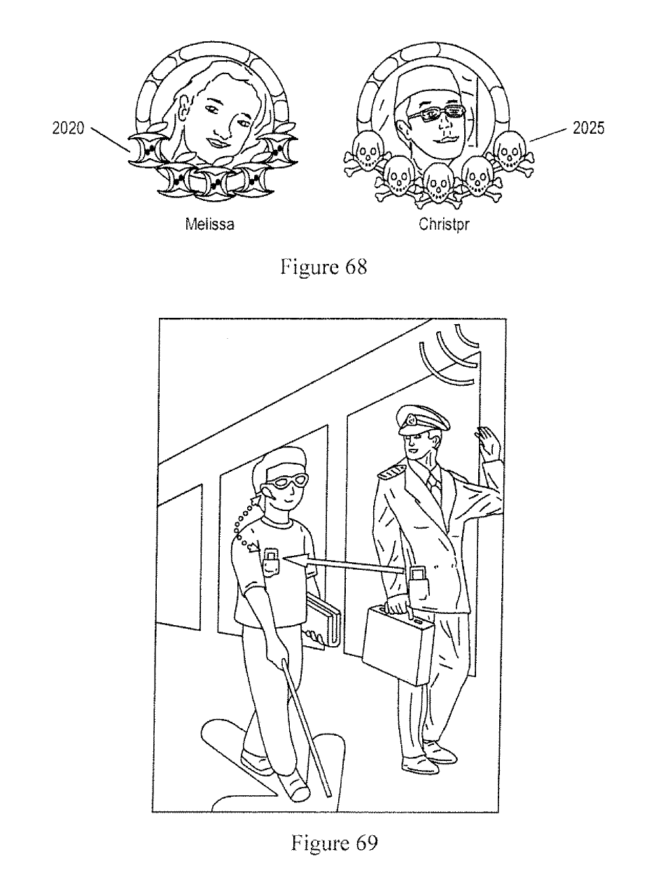

FIG. 68 illustrates an exemplary embodiment of a rating display with different icons chosen by users in accordance with the present invention. In some embodiments, users may rate other objects such as, for example, users or service providers, and overlay that information into the profile stored in their own device. Users may select to display the rating information of other users and objects in their display. When rating objects publicly, the rated object may be able to accept a rating request. Each object that has been rated publicly may have the capacity to select a rating icon that others may view and rate, providing an icon representation of the rating. Some examples of icons may be apples, bananas, knives, pirates, etc. FIG. 68 shows an example of the rating display and icons shown as apples (2020) and skulls (2025). The methodology supports a rating system that may be anonymous or may provide the rater's identification information based on the rated object configuration. A rating points system may be cumulative and may show the average rate given to that object. Users may be able to only rate other users or objects once per rating icon-type. In some embodiments, object rating results may be further categorized and filtered for computation based on known sources such as, for example, friends rather than sources that are not known to the end user. This provides a rating based on sources to which end user may attribute trust to the information. The rating may be automatically computed based on end users' activities with the corresponding sources, specified friends on a profile, or people with which the end user often communicates or that may be manually selected on an individual basis. This methodology may provide the ability for an end user to see the rating of an object (e.g., restaurant or person) based on an average of all users' ratings, as well as ratings based on a trusted social network (e.g., friends).

Comment Service

In some embodiments, there may be a feature for adding comments on particular objects privately or publicly. When rating public objects, the commented object may be able to accept comment requests. The feature may support comments that may be anonymous or provide the user with comment identification information based on a comment object configuration. Object comments may be further categorized and filtered based on known sources such as friends rather than on those sources that are not known to the end user. This provides comments based on sources that the end users may attribute trust. In some embodiments, the feature for adding comments may provide the ability for an end user to see the comments of an object (e.g., restaurant) or person based on all users' ratings as well as ratings based on his trusted social network (e.g., friends).

Temporal Calendar

In some embodiments, there may be a temporal calendar feature for recording events and information that are visible within the environment of the end user device. The events and information may be recorded into a temporal database that may include the time and date of which they occurred. These events may be searched or displayed at any time, recreating the environment that occurred at the given time. Further the temporal database may include tags that provide the means to identify specific events of interest. For a user device, the temporal database may provide an integral feature that records the events and information visible, thus becoming, for example, a diary of the users' daily activities. The user may select to add tags to these events to highlight a specific event of interest. The user may select to play back the temporal database by selecting a particular date and time or search for information such as a contact name and identify when that contact has come within the AOI.

1. Display and Search

The temporal database may be available in SOI mode, as illustrated in FIG. 63.

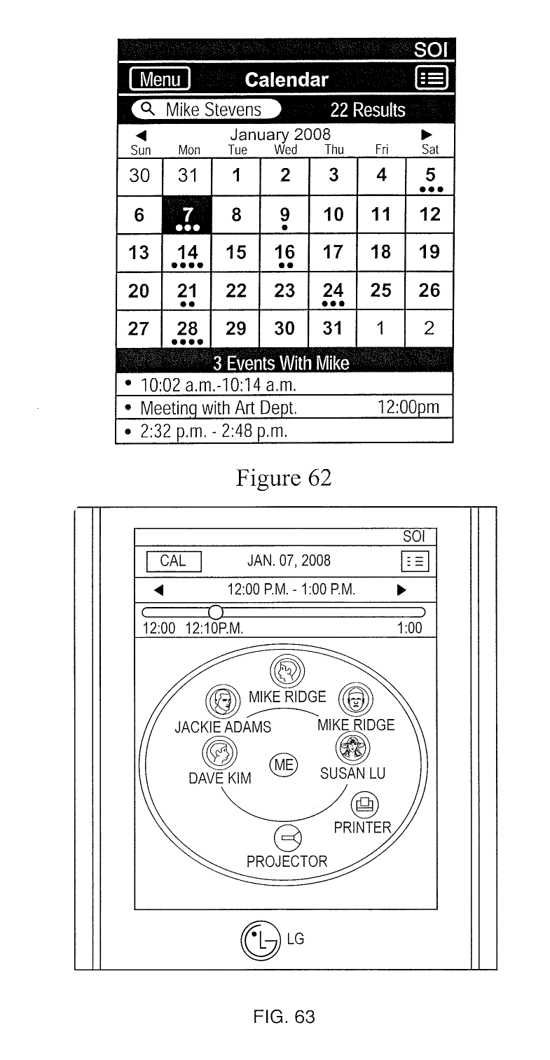

FIG. 63 illustrates an exemplary user display of a device with a sphere of influence (“SOI”) temporal calendar mode in accordance with the present invention. In some embodiments, there may be an objects date/time mode (FIG. 62), a search engine mode or a third party application.

FIG. 62 illustrates an exemplary user display of a device with a date/time temporal calendar mode in accordance with the present invention. FIG. 62 illustrates the results on a calendar when the device was in the same AOI as an object, “Mike Stevens.” Furthermore, events that “Mike Stevens” had in common with the device are presented on the bottom of the display in FIG. 62.

FIG. 63 shows a SOI mode display of a temporal calendar that displays all the objects in the same AOI as the device in a particular date and time range. The SOI display provides a way to recreate the scene at the given time recorded. For example, a particular business meeting from 12 pm to 1 pm, Jan. 7, 2008 may be recorded into the corresponding date in the temporal calendar. When clicking on that date, the exact display (including who were attending and where they were relative to user) may be available for viewing. A reconstructed display may record the relationship and the original information linked, rather than a static representation of the scene. For example, in a business encounter, activating the icon representing “Mike Stevens” may provide information linked by the icon (e.g., Mike's profile).

A search engine feature may provide the ability to search any categories that may be accessible to the object (e.g., contact name, event, locations, etc.) In the meeting example (above), by searching for the contact name “Mike Stevens” in the temporal database, all encounters matching the contact name “Mike Stevens” may be highlighted for the user on the display.

2. Remote Aggregated Storage

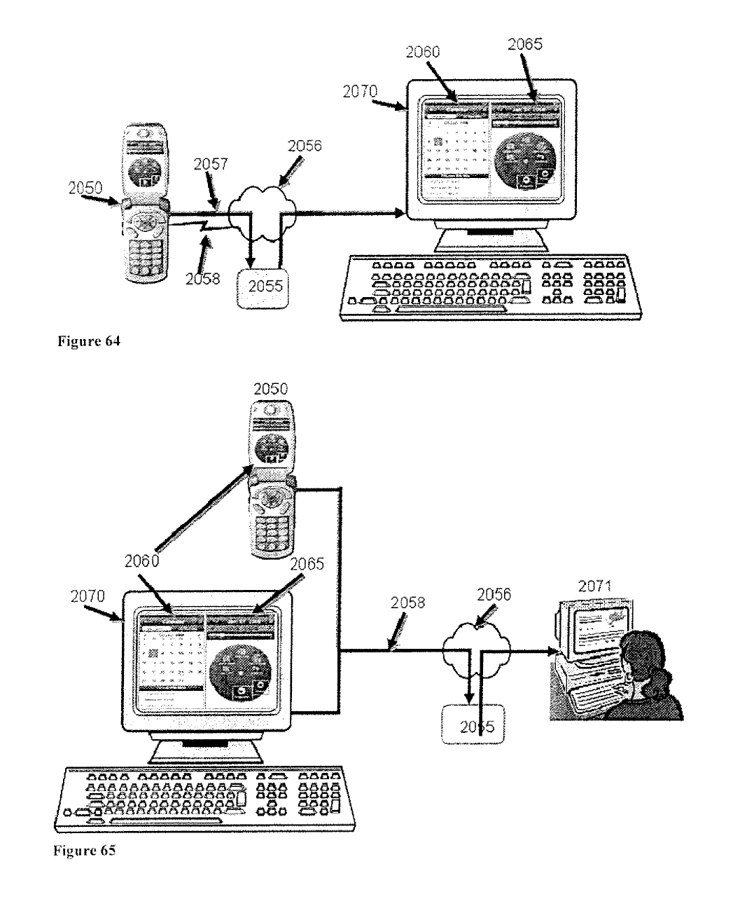

FIG. 64 illustrates an exemplary embodiment of uploading a temporal calendar from a device to a server for additional storage in accordance with the present invention. In some embodiments, the temporal calendar may be uploaded to a server that allows for additional storage, services, and connectivity with other resources, including Internet and intranet. The most current events may be stored in the temporal calendar found on a positioning engine object, such as a PixieEngine object user device (2050). The database may be uploaded to a server (2055) via a wired or wireless connection (2057, 2058) to a WAN or Internet. The temporal calendar may be aggregated into the user's existing calendar. The aggregated calendar (2060, 2065) may be accessed via a user device (2070) web site. The aggregated calendar may further provide integration features to other Internet or intranet sources.

3. Delayed Interaction

FIG. 65 illustrates an exemplary embodiment of a delayed interaction through the temporal calendar in accordance with the present invention. In some embodiments, there may be a delayed interaction feature that may allow an end user to interact, contact, communicate or send information to other objects via a delayed interaction (e.g., a later time) via a data stored in the temporal calendar. The feature may allow for end users to send information or activate an object by accessing the object in its temporal calendar database. The feature may require the object to access a server that acts as a gateway between the object. FIG. 65 provides an overview. The end user may utilize a device (2050, 2070) to access data in the temporal calendar database (2060, 2055). The device may be further connected (2058) through a WAN or Internet (2056) to a server that may act as a gateway (2055). The gateway may converts the user ID's in the temporal data base (2060) with the registered information (2071) in the server contact database. This may be done without providing the contact data to the requesting user (2050, 2070) and the message may be sent without exposing the contact information of the receiving user (2071).

Hierarchical Visualization

### 1. Visualization

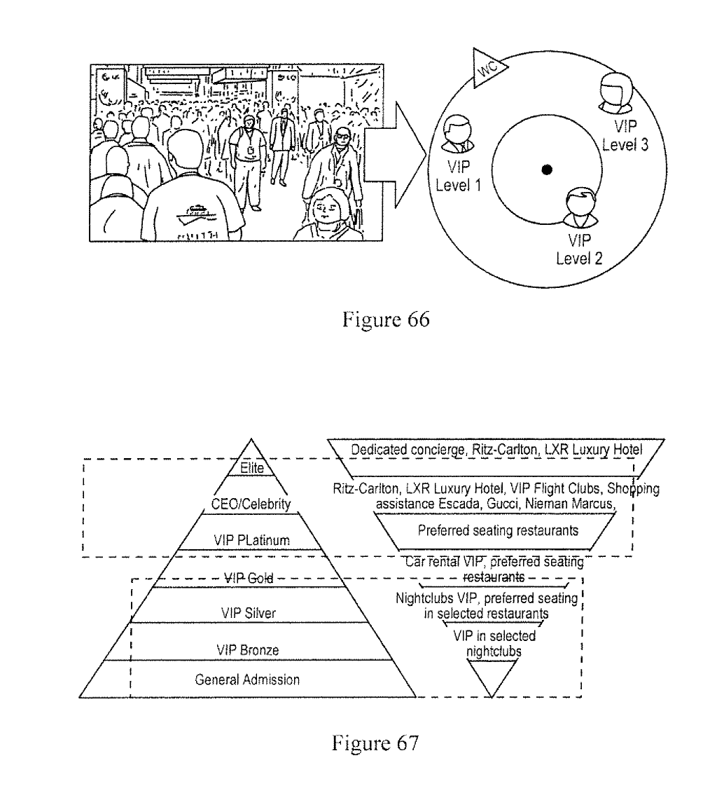

FIG. 66 illustrates an exemplary embodiment of hierarchical visualization as applied in a crowded area in accordance with the present invention. In some embodiments, there may be a feature for implementing a hierarchical enhanced visualization architecture for displaying people or objects on the user device. The feature may enable an end user, which includes both individuals and service providers, to view and filter other people or objects within their respective SOI (e.g., profiles and relationships), where filtering may be done based on criteria such as, for example, a hierarchy status/level (e.g., equal or lower). Further, this feature may be used to provide user privileges offered by service providers at selected hierarchy levels. FIG. 66 illustrates an example of a crowded area. Here, the hierarchical status may be shown in the SOI display as “VIP Level X.” The SOI display may show an end user or retailer with a Level 1 hierarchy filtering users of its own level (e.g., level 1) or those of lower levels (e.g., levels 2 and 3). This type of filtering may provide a way to subcategorize or pre-qualify and filter other objects in the AOI. In some embodiments, the hierarchy level may be based on a number of factors and there may be different hierarchy levels for specific categories. Some hierarchy levels may be based on an annual fee or social/business position and may provide the ability for an end user hierarchical status to be visualized and acted upon when the end user is within close proximity, and allow for discreet sharing of hierarchical status and customer pre-qualification. Service providers may be use such information to offer privileges or offers that are exclusive to a given hierarchical level (e.g., a jump-in-queue or a reserved setting).

FIG. 67 illustrates an exemplary embodiment of hierarchical levels of a specific privileges package in accordance with the present invention. In the example of FIG. 67, specific privileges may be incorporated with hierarchy level. Specifically, FIG. 67 illustrates an example of specific privileges package (e.g., Elite, CEO/Celebrity, VIP, General Admission) associated with the particular benefits for that level.

### 2. Specific Use Examples

A. Disabilities

In some embodiments, the user device with positioning engine may implement features that may be used to provide situational awareness to the visually impaired, combined with interactive audio via a headset, speech recognition, and a text-to-speech interface. Such feature may be used in an airport setting. The following functions are essential components of the features:
Audio instructions may be used to query information or other commands;
Speech recognition may converting spoken words to machine-readable input;
Positions and relationships may be output into a text description;
A text-to-speech interface may display speech instructions;
A Spotcast may link physical object location to information;
A Spotcast may provide directional information to other known locations.

The user device with positioning engine may be able to use the architecture of objects and information overlay to provide directions and interim steps for the disabled end user.

B. Audio Guidance

FIG. 69 illustrates an exemplary embodiment of a visually impaired person navigating through an airport facility in accordance with the present invention. The exemplary scenario may be implemented in any language in which the appropriate text-to-speech and speech recognition is available. The device may continuously provide information to the user, assisting him in gaining situational awareness. The following are two exemplary audio guidance instructions implemented in the English language:
Directions:
User: “Directions Gate A1”
Device: “Turn right 90 degrees, proceed straight 10 meters.”

Based on a directional request, the device with positioning engine may create an information overlay geometry path for the end user to traverse based on the instruction for the user to turn 90 degrees and proceed forward. For example, as the user traverses the path, the device may provide a periodic “beep” tone with a frequency synchronized to the heading direction. For example, if the user walks in the correct heading the beep would be output using a 440 Hz tone. As the user turns away from the direction, the beep tone may increase or decrease based on the difference between the user direction of travel and the intended path. As the user traverses the path, objects may come into view. These objects may be actual physical objects or to other people. FIG. 71 illustrates the user walking from the initial point (1700) and the second point (1710). The SOI displayed is shown to the right, indicating the position of the object “me” as shown (1715). The AOI has been filtered to cover a 5 meter area (1720). This allows events which come into view within the 5 meter area to be processed by the SOI. An object within Starbucks® has been hyperlinked as shown (1725). In the initial position (1700) the Starbucks® object is farther than the 5 meter filter, and no events are generated. In the second position (1710) the Starbucks® object comes into view of the SOI and an event audio event may be generated to indicate the relative position of the object to the user. This feature may examine the information of the object and provide relevant information to the user.

In a social awareness example, the user device with positioning engine may provide the following feedback:

Device: “Immediately on your left is Abdul, copilot at United Airlines. 5 meters ahead is Stephen, VP at CISCO. You first met him last Tuesday.” This feature may also allow guide other users around a visually impaired person. Additionally, it shows the use of the temporal database to search and find relationships between two objects (e.g., “You first met him last Tuesday”).

C. Asset Tracking and Protecting

In some embodiments, there may be a feature for asset tracking, where one object may track the position of another object. The object doing the tracking may setup events or alarms that are triggered based on particular behavior of the object being tracked. Typical tracking applications include use with a child, pet, laptop, keys, wallet, bag and other valuables. The feature may also be combined with a fence overlay in order to implement containment or for allowed/excluded zones (e.g., for children, pets, the elderly, the mentally impaired, and criminals, etc.) as, for example, a way to protect concerning objects/animals/individuals.

D. Proximity Alert

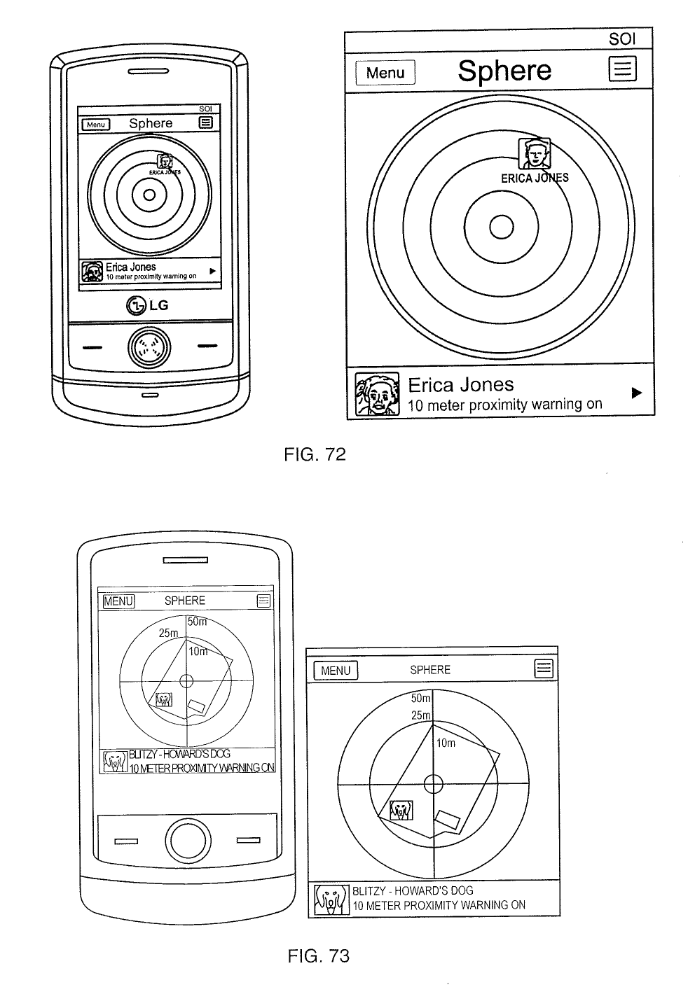

In some embodiments, proximity may be defined as a relative nearness of an object, animal, or person to a designated area or location, or to the location of another object or person. Proximity acquisition may be done via positioning, with or without static positioning engines, (e.g., “Spotcasts”). Using fence overlay geometry (discussed above), a user may create a zone to which specific behavior may be triggered based on the location and proximity of tracked objects/animals/persons to said zone boundary. An area of such application may be asset tracking and child tracking. As illustrated in FIG. 72, a tag has been placed on the child named “Erica Jones.” Additionally a radial fence perimeter was drawn at a 10 meter range from the user of the device. In this example, Erica's trail has been enabled and overlaid to show her past location relative to the device holder. In the event that a child moves beyond a perimeter fence, the user device may set a behavior to provide an alarm of the situation. This scenario shows a fence perimeter implemented via a circular fence overlay on the display, which is relative to the device holder, as shown in FIG. 79. The vector may move with and according to the device holder's location. Similar operations may be applied in criminal areas (e.g., restraining abusers/harassers from approaching a victim or keeping unwanted pets from trespassing).

Containment

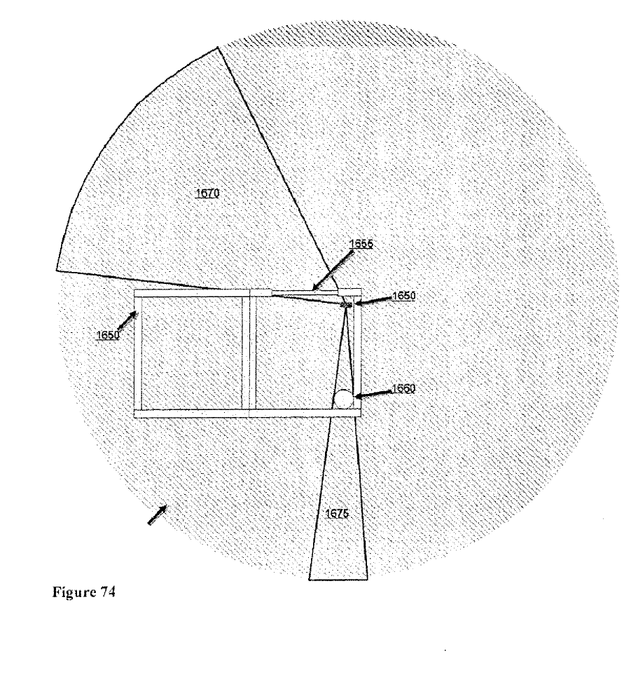

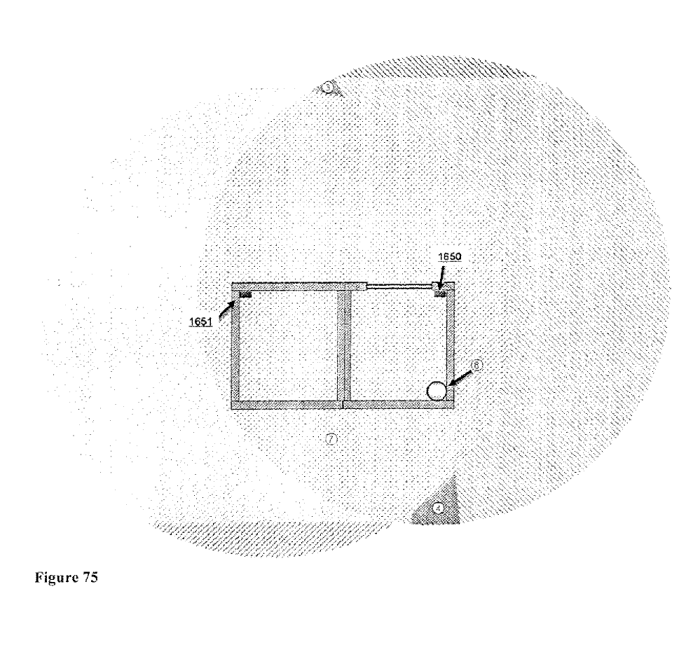

In some embodiments, a containment feature may allow the user to create fence areas that can be linked to specific behavior to indicate when the tracked object/animal/person is within an allowed or excluded zone. Some embodiments of the invention may provide the ability to visualize the target's location and the actual geometry of the specified fence and zone areas. The behavior that is attached to the overlay may trigger sensors in a target carried device, such as a pet collar, that may be linked to the specific behavior thus encouraging the target to remain within specific allowed zones, or notify concerned individuals when target enters excluded zones. An application of the containment feature may be in the development of complex shapes that may be used to provide animal containment without structural changes to the property shown in FIG. 73. FIG. 73 illustrates an example of a containment structure, such as a fence overlay, and the position of a dog equipped with a tag in relation to that containment structure.

1. Pet Sensory Feedback

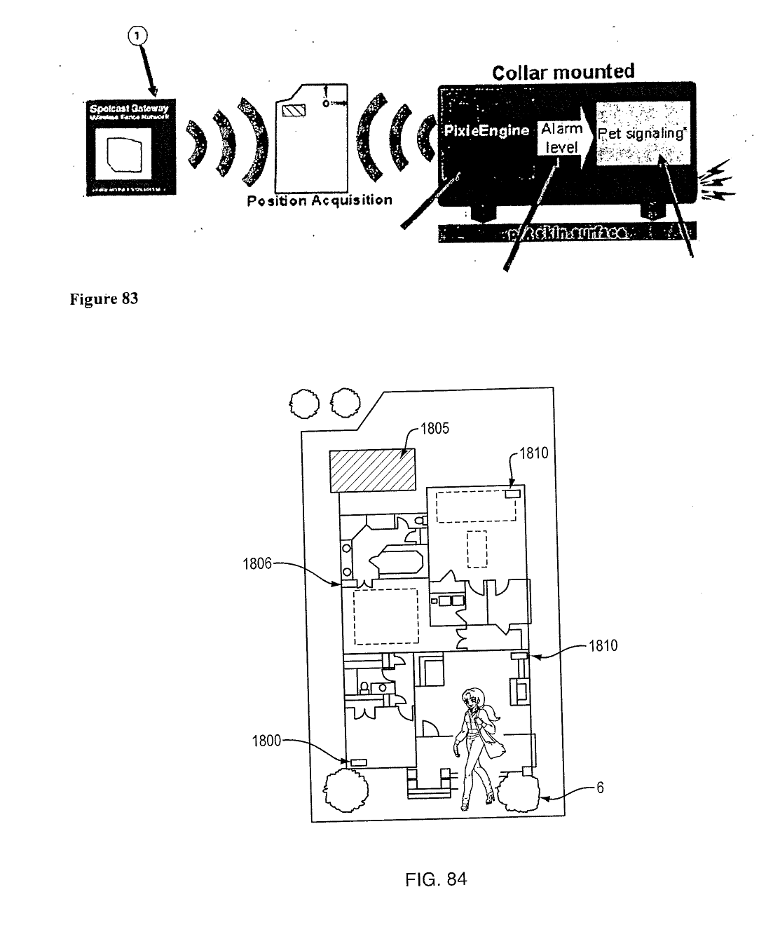

FIG. 73 illustrates an exemplary embodiment of a user display of a device showing a tracked pet within a predefined perimeter in accordance with the present invention. In this example, a pet collar (FIG. 82) may integrate an embodiment of a positioning engine to provide a translation between the triggered events and a pet sensory feedback mechanism (3000 and 3005) that can be associated with a particular pet behavior. These pet collars have been used for pet containment in the past and certain embodiments provide an innovative method to provide reliable wireless fence containment information. A pet collar may utilize vibration, audio (3005) and electric impulses (3000) to the skin (3008) to associate with specific responses. User feedback for programming, battery status and other indicators may be accomplished via buttons (3010, 3015) and lights (3020, 3025). FIG. 83 shows communication between a fence with a static positioning engine (e.g., “Spotcast”) and a positioning engine (e.g., PixieEngine) on a pet collar—and process flow for event behavior activation—for an embodiment that invokes a pet behavior of staying within a boundary.

2. Fence Overlay Behavior

As shown in FIG. 76, static positioning engines (e.g., “Spotcasts”) (1810, 1800) may be set up to indicate a static reference position for the fence overlay. Due to the nature of wireless links, such as a 2.4 GHz frequency used by embodiments of the system, may be susceptible to signal reflections and full obscurity by objects within or around the building. This may create possible areas in which the signal may not reach or may be evaluated incorrectly, giving an incorrect location of the fence in relation to the object being tracked. Given that the fence overlay geometry is static around a specific static positioning enginge (e.g., “Spotcast”), this may create areas where the fence would not be visible or activated, or have an improper geometric shape. In implementations where higher reliability may be needed, the innovation allows for a static positioning engine to act as a master (1800) and additional static positioning engines may as repeaters (1806) and overcome the inherent problems that may be associated with reflections and obscurity due to objects inside a building. The master static positioning engine (1800) may carry a copy of the fence geometry overlay of, for cxample, FIG. 77. The fence overlay geometry may be copied to each static positioning engine acting as a repeater, to maintain full coverage around the building.

A. Creating and Edit User Defined Fence Overlay

In some embodiments, numerous methods may be available to create fence overlay geometry. Because fence geometry is static with respect to a given location, the master static positioning engine (e.g., “Spotcast”) and associated static positioning engines acting as repeaters may be located at their respective location, as shown in FIG. 76 (1800, 1806).

In the example shown in FIG. 74, the user may create a fence overlay geometry by first enabling a fence geometry programming mode in the pet collar or other device, including a positioning engine. Then, while holding the pet collar, the user may walk the line corresponding to the fence geometry to be set around the building.

As discussed above, allowed/excluded zones that are defined may contain multiple segments, allowing for a complex shape. An example is shown in FIG. 81, where excluded zones are within an allowed zone area. In addition, allowed/excluded zones may also have a functioning height that enables applications engaging this positional attribute. As illustrated in FIG. 100, outdoor excluded zones may be attributed to a functioning height that the signal may reach. In FIG. 101, an indoor excluded zone may function within a preset height range controlled by the end users. In a pet containment application, such excluded zone may represent a bedroom or baby nursery where pet entry is not desired.

For better coverage where height acquisition may be invoked (discussed above), a fifth static positioning engine (e.g., “Spotcast”) may be placed on a second floor whose height (such as 3.5m above ground) may be automatically computed or manually input by the end user (relative 3D position to the initial 4 static positioning engines). According to the 3D positioning algorithm, user-created fence overlay geometries may be computed in the 3D structured network composed by 5 static positioning engines. An end user may be able to assign excluded zone types to said detected geometries, where each has an attached height attribute.

Excluded zones 1 and 2 may be programmed to function from to the fullest vertical height range. Due to signal absorption, by ground and earth objects in certain embodiments, the lowest height may be set as the ground level (0 m in height) to the maximum vertical reach of signals. Zone 3 (1900) type height may be programmed by a factory or user-defined height range. For example, the Zone 3 (1900) height may be set to 3 meters to adequately cover a pet zone within a single floor. By providing a 1 meter area below the floor marked as 1, adequate coverage may be created with an anticipated error associated with the user creating a fence geometry. The user may create a fence geometry when he walks the collar at about 1 m in height around the perimeter area. Other methods such as setting up a radius encircling a fenced area may be applied to the child tracking features (discussed above). FIG. 79 illustrates an example of such a defined, circular safe area (1850).

Modification function discussed above allows end user to visualize and edit the returned fence overlay geometry, either manually or programmatically. Said function enables end users to confirm their customized fence geometry and eliminate multi-path or sensor error undetected otherwise

B. Activating Fence Overlay Behavior

In the pet containment example, the pet is wearing a collar similar to the one shown in FIG. 82, which may be activated based on events associated with the fence overlay geometry created, as shown in FIG. 77. The pet may be shown in the location marked by 1960. Some embodiments compute the distances from the fence 1961 and enable the associated event behavior. The fence geometry overlay may include irregular areas 1965 as well as inner areas that may be marked as unsafe 1970.

C. Static Event Activation

Some embodiments involving a pet collar may establish position and proximity from a fence overlay geometry, as shown in FIG. 77, and by which an associated behavior may be established. A simple alarm indicating that the pet may be inside or outside a safe zone may be triggered, with increased alarm levels being triggered as the pet approaches the fence overlay. This multi-level alarm may be associated to audio signaling, vibration and multi-level electric stimulation. This association may provide a static response based on a given distance. For example:

| Object Distance to Event | Generated Fence Overlay Line |
|---|---|
| 5 meters | audio signal is generated |
| 4 meters | audio signal + collar vibration |
| 3 meters | audio signal + light electric stimulation |
| 2 meters | audio signal + medium electric stimulation |
| 1 meters | audio signal + strong electric stimulation |
| unsafe zone | audio signal + strong electric stimulation |

When an event is activated, an object may be configured to send an alert or message to a remote device. For example in FIG. 89, a Spotcast (1300) may be installed in a building room (1301) that is connected to a computer or Internet gateway (1305) that provides connectivity to the Internet (1310). If a pet crosses the allowed boundary, a message may be sent from the Spotcast to a gateway server (1315) that transmits the message over a communications link (60) to the appropriate remote party (1320) or parties utilizing the programmed communication protocols.

In another exemplary embodiment, restrained criminals may be monitored, as well as the elderly or mentally impaired (e.g., at their residences), whose entry into an excluded zone may automatically invoke alert messages that may be sent to the police or care providers. Similarly, amusement parks equipped with these features may notify a parent or guardian when their monitored children wanders away from the allowed area.

D. Behavioral Feedback Event Activation

Pet containment is a practical example where the pet activity level directly affects the events triggered as described in certain embodiments. When a pet is within the allowed zone and different types of excluded zones, an alarm triggering zone may be programmed to utilize the behavioral feedback provided by the pet worn collar. Behavioral feedback may be appropriately determined based on the movement type, location and velocity of the pet that triggers the appropriate response

E. Allowed Zone Event Activation

FIG. 86 displays four scenarios of a dog in the allowed zone:
Scenario 1: 4001, resting dog away from the excluded zone (4010)
Scenario 2: 4005, dog walking towards the excluded zone marked by line (4012)
Scenario 3: 4006, dog running towards the excluded zone marked by line (4012)
Scenario 4: 4008, dog sprinting towards the excluded zone marked by line (4012)

Each of these scenarios trigger a different response that may appropriately provide the right signal timing for the pet in order to keep the pet within the allowed zone. In this example, FIG. 86 shows 4 alarm levels: “A” indicates audio and three electric stimulation levels from low to high marked as L1 through L3, respectively. A relative distance mark is shown for each scenario marked by 4030. In this example, these represent programmable distances where each segment may represent 5 meter or 2 meter distances. Based on each scenario, a specific behavior may be programmed and activated such as:
Scenario 1: unit enters battery saving mode;
Scenario 2: alarm trigger is set to normal range mode and events will only be triggered within the last distance segment closest to the excluded zone marked by line (4012);
Scenario 3: alarm trigger is set to medium range mode where the triggering range is increased to twice the original size; and
Scenario 4: alarm trigger is set to long range mode where the triggering range is increased to three times the original size.

Utilizing this behavioral feedback technique the appropriate feedback may be given to the pet with enough time to reinforce the expected behavior which in this case is not to enter the excluded zone.

Some embodiments may monitor the balance and mobility disordered group, such as the elderly population, with whom incidence of falls are associated with serious health problems. Detection of “falls” may be accomplished either through the motion sensor or positioning, which may trigger an alarm or notification to care providers so as to secure availability of immediate health aid.

F. Excluded Zone 1 Event Activation

In some embodiments, when an object is already inside the excluded zone that represents the outer boundary (1866), such as in FIG. 81, an alarm triggering zone may need to meet unique objectives such as helping a dog navigate back to allowed zone. In this case, specific object characteristics may be programmed to provide the desired results. Certain embodiments may provide the ability to program circumstances inside or outside the excluded zones.

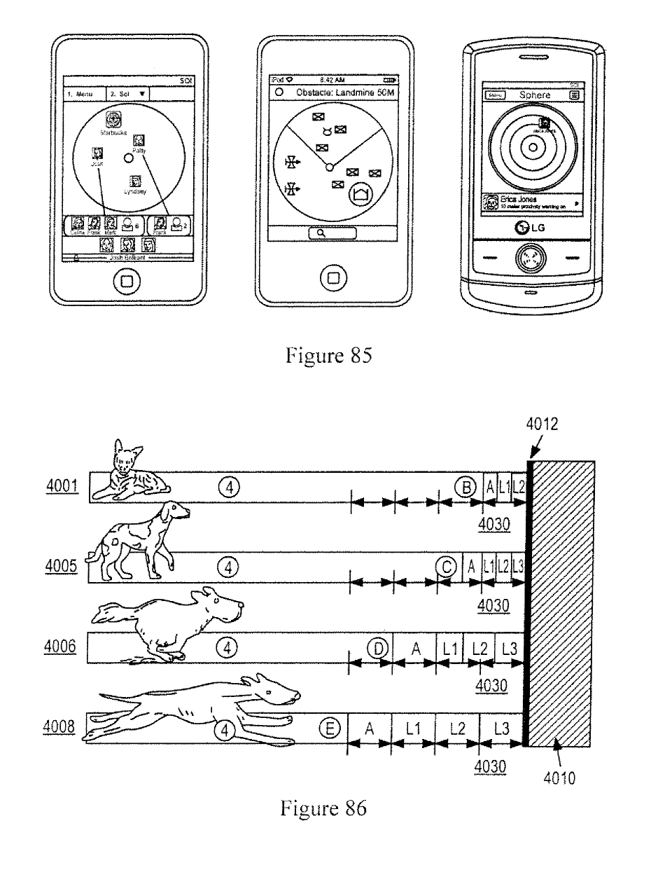

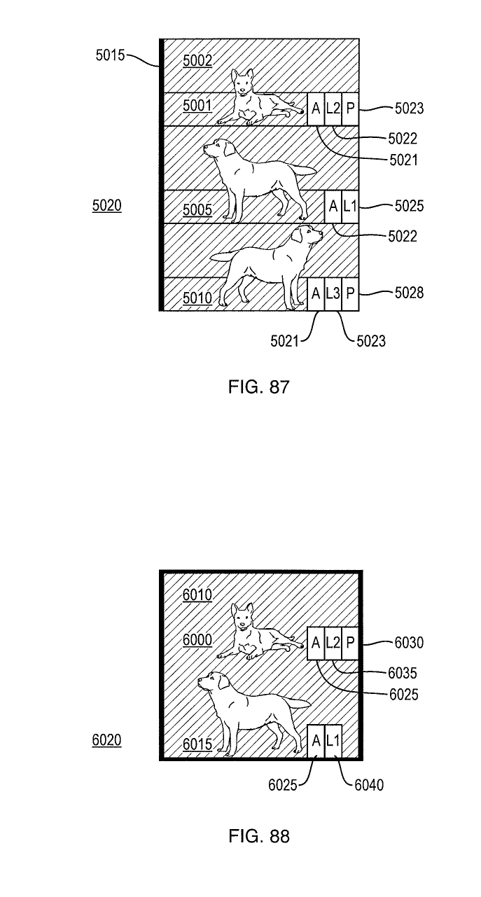

FIG. 87 displays three scenarios of a dog in the excluded zone:
Scenario 1: 5001, resting dog in the excluded zone (5002)
Scenario 2: 5005, dog moving in the excluded zone towards the allowed zone marked by line (ID 3)

Scenario 3: 5010, dog moving in the excluded zone away from the allowed zone marked by line (5015)

Each of these scenarios triggers a different response that may provide the proper signal to the pet in order to encourage the pet back to the allowed zone (5020). For this example, FIG. 87 shows 4 alarm levels: “A” indicates audio (5021) and three electric stimulation levels from low to high marked as L1 through L3 respectively. In addition, the events may pause for a period of time to allow a resting period for the pet as indicated by the “P” in 5023. Because the pet may already be inside the excluded zone, the relative distance to the allowed zone is not considered in this particular behavioral feedback event activation. However, if appropriate, other factors including distance may be integrated into the process.

Based on each scenario, a specific behavior may be programmed and activated such as:
Scenario 1: audio alarm (5021)+medium level electric stimulation level (5022)
Scenario 2: audio alarm (5021)+low level electric stimulation level (5025)
Scenario 3: audio alarm (5021)+high level electric stimulation level (5028)

This process may be applied through periodic intervals that may pause for a period of time “P” to allow the pet to rest while not attaining the desired behavior.

G. Excluded Zone 2 and 3 Event Activation

When the pet is already inside an excluded zone surrounded by an allowed zone as represented by ID 3 in FIGS. 80-81 or indicated as in FIG. 101, different events from the previous section may be implemented to achieve the same/similar results, which may encourage the pet to navigate back to the allowed zone surrounding it.

FIG. 88 displays two scenarios of a pet in the excluded zone:
Scenario 1: 6000, resting pet in the excluded zone (6010)
Scenario 2: 6015, pet moving in the excluded zone towards the allowed zone (6020)

Each of these scenarios may trigger a different response that may appropriately provide the right signal to the pet in order to encourage the pet back to the allowed zone (ID 1).

In this example, FIG. 88 shows 3 alarm levels: “A” indicates audio (6025) and two electric stimulation levels from low to high marked as L1, L2 respectively. In addition, the events may pause for a period of time to allow a rest period for the pet as indicated by the “P” in 6030. As discussed above, the relative distance to the allowed zone does not considered the pet may already be in the excluded zone, but such factor will be taken into account when appropriate.

Based on each scenario, a specific behavior may be programmed and activated such as:
Scenario 1: audio alarm (6025)+medium level electric stimulation level (6035)
Scenario 2: audio alarm (6025)+low level electric stimulation level (6040)
A pause for a period of time “P” may be set for the same reason as discussed previous section.

H. Fence Overlay Geometry Modifications

In some embodiments, there may be a feature for creating, manually editing, or programming, fence overlay geometry. FIG. 90 illustrates an example of how to create or edit the fence overlay geometry with a device such as a computer (2000) or another user device connected to a static positioning engine (2007) (e.g., “Spotcast”), which may then access the memory area for the geometry information. The data may be created or edited via a software application (2005) that may implement a visual representation of the geometry.

Some embodiments of the invention may provides a method to create complex geometric fences using an all wireless solution, visualizing the fence and tracking a pet, and a remedy for false positives, by creating an architecture that minimizes multi-path reflections, obscured areas and measurement error. The may be easy to set up and reprogram allow for use in portable situations when a containment area needs to be created at a different location that may bring increased user convenience.

Summary: The Benefits of Using Some Exemplary Embodiments

Multiple transmitters may be auto configured in and around a building area to eliminate signal errors from building objects. Sensors within a pet collar may provide movement indications that may help to improve battery life and remove the error caused by multi-path effect, reflections or erroneous data. Event alarms that may be set with pet activity feedback may provide a consistent message to the pet of the fence boundaries. Even alarms associated with pet activity feedback within excluded zones may encourages the pet to return to the designated allowed zone. The ability to provide messages to the user via text messaging or email may provide an assurance that a pet is within a confined area. The ability to visualize zone areas may provide the user with a positive way to confirm the fence overlay geometry's allowed zones and the ability to edit to meet current and future needs. A simple set up process may enable users to easily access and upgrade their containment area. Portability may allow users to carry the system and recreate the fencing service when they travel, for example, to a vacation home.

Active Information Display

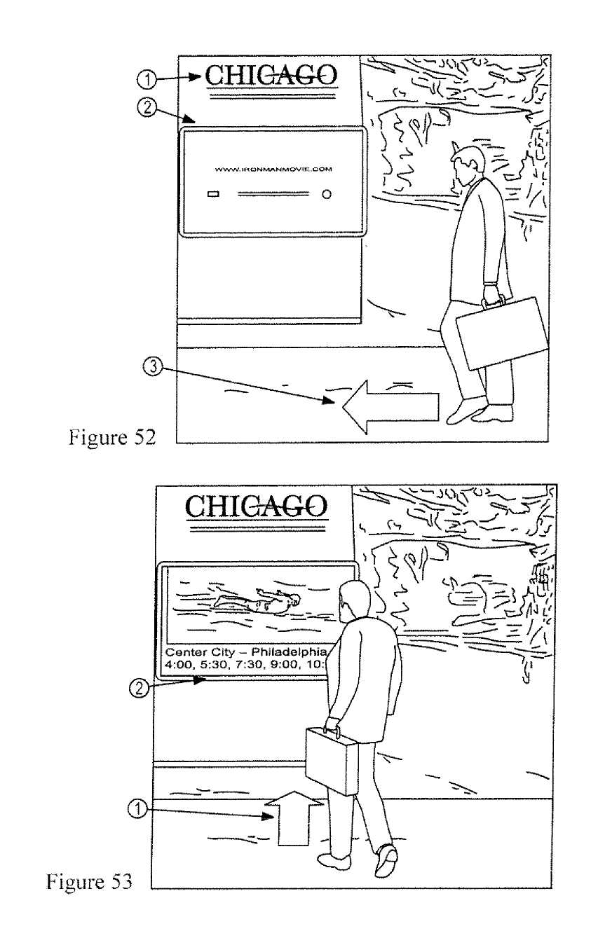

The example illustrated in FIG. 52 shows an active display changing its contents as it senses another object approaching. In the example, the person walking is using certain embodiments that have integrated social profile information. The display object may access the information the user has selected to provide publicly, or specifically accessible to the display object. The display object may use this information to create a custom view of the information provided to the user. Initially the person walking may not be moving towards the particular active display. However, FIG. 53 illustrates the person's attention being directed towards the display. The positioning engine (e.g., “PixieEngine”) in the active display may detect direction and orientation of the incoming object to determine the field of attention from the user. The active display may then show the targeted information at that time. In this example, the display may provides movie time information for the end user's home location (e.g., Philadelphia)

When multiple users are present, the display may utilize a queue and sorting algorithm to provide the information utilizing a priority algorithm. Such an algorithm may be first come, first served, or may be connected to the hierarchical or social profile information embedded in the user's positioning engine. The active display may access the following data items, for example:
User unique ID
User approaching
Direction of attention
Public profile information
User opt-in applications

User opt-in applications are applications that may provide additional information above the social profile. In this particular example, an opt-in example would be the user having a movie preference database within his/her positioning engine (e.g., “PixieEngine”) of which the active display may access the information. By doing so, the active display may further provide information that is of direct interest to the user.

1. A positioning system, comprising:
a plurality of sensors for determining location, including at least one of a range sensor, an orientation sensor, and a movement sensor, in a first device;
a second plurality of sensors for determining location, including at least one of a range sensor, an orientation sensor, and a movement sensor, in a second device configured to detect the first device by sensing a wireless signal transmitted by the first device, the second device being in direct two-way communication with the first device;
a memory in at least one of the first device or the second device configured to store data received from said first or second plurality of sensors for determining location; and
a processor in at least one of the first device or the second device configured to analyze the data received from the first or second plurality of sensors for determining location to localize one of the first device or the second device.

2. The system of claim 1, wherein the processor executes one or more instructions, the instructions comprising:
calculating a relative position characteristic based upon the data received from the first or second plurality of sensors for determining location, the relative position characteristic including:
a) a range between the first device and the second device,
b) a vector of motion and a tilt angle, and
c) an orientation defined by a local earth magnetic field or a heading.

3. The system of claim 1, wherein the processor executes one or more instructions, the instructions comprising:
determining a relationship between the first device and the second device.

4. The system of claim 2, wherein the processor executes one or more instructions, the instructions comprising:
indicating graphically the relationship between the first device and the second device.

5. The system of claim 1, wherein the processor executes one or more instructions, the instructions comprising:
filtering according to criteria, one or more other devices that are in range of the first device or the second device.

6. The system of claim 1, wherein the processor executes one or more instructions, the instructions comprising:
receiving data related to an object, a tag, or a beacon within a range of the first device or the second device.

7. The system of claim 6, wherein the received data related to the object, the tag, or the beacon is comprised of: an identity, a relationship, a group attachment, a personal information profile, and a tag information profile.

8. The system of claim 6, wherein the received data related to the object, the tag, or the beacon is graphically displayed on the first device or the second device.

9. The system of claim 7, wherein the processor executes one or more instructions, the instructions comprising:
filtering according to the identity or the relationship.

10. The system of claim 9, wherein results of the filtering are graphically displayed on the first device or the second device.

11. The system of claim 1, wherein the processor executes one or more instructions, the instructions comprising:
calculating a relative height.

12. A method, comprising:
receiving at a first device, a plurality of sensor data for at least a second device;
calculating a relative position characteristic of the second device based upon the plurality of sensor data, the relative position characteristic including:
a) a range between the first device and the second device,
b) a vector of motion and a tilt angle, and
c) an orientation defined by a local earth magnetic field or a heading;
receiving at the first device, data from the second device; and
associating the received data with the relative position characteristic of the second device.

13. The method of claim 12, further comprising the step of determining at the first device or the second device a relationship between the first device and the second device.

14. The method of claim 13, further comprising the step of indicating graphically on the first device or the second device the relationship between the first device and the second device.

15. The method of claim 12, further comprising the step of filtering at the first device or the second device according to criteria, one or more other devices within range.

16. The method of claim 12, further comprising the step of receiving at the first device or the second device data related to an object, a tag, or a beacon within range.

17. The method of claim 16, wherein the received data related to the object, the tag, or the beacon is comprised of: an identity, a relationship, a group attachment, a personal information profile, and a tag information profile.

18. The method of claim 16, wherein the received data related to the object, the tag, or the beacon is graphically displayed on the first device or the second device.

19. The method of claim 17, further comprising the step of filtering at the first device or the second device according to the identity or the relationship.

20. The method of claim 19, wherein results of the filtering are graphically displayed on the first device or the second device.

21. The method of claim 12, further comprising the step of calculating a relative height.

22. A positioning system, comprising:
in a first device:
a processor;
a plurality of sensors; and
a memory configured to store one or more instructions for execution, the instructions comprising:
receiving data from the plurality of sensors;
storing the received data, wherein the data comprises location information of a second device configured to detect the first device by sensing a wireless signal transmitted by the first device, the second device being in direct two-way communication with the first device; and
analyzing the received data to localize the second device.

23. The system of claim 22, wherein the plurality of sensors comprise a range sensor, an orientation sensor, and a movement sensor.

24. The system of claim 1, wherein localization data of one of the first device or the second device is stored in a file shared between at least the first and second device.

25. The system of claim 24, wherein the localization data is used for localizing the first or the second device with respect to a plurality of other devices.
